(19) United States
(12) Patent Application Publication
(10) Pub. No.: US 2007/0250784 A1
(43) Pub. Date: Oct. 25, 2007

(54) METHODS AND APPARATUS TO COMBINE DATA FROM MULTIPLE COMPUTER SYSTEMS FOR DISPLAY IN A COMPUTERIZED ORGANIZER

(75) Inventors: Clark N. Riley, Chicago, IL (US); Clark A. Riley, Chicago, IL (US)

Correspondence Address: BELL, BOYD & LLOYD, LLP, P.O. Box 1135, CHICAGO, IL, 60690, US

(73) Assignee: Workstone LLC, Glencoe, IL (US)

(21) Appl. No.: 11/686,201

(22) Filed: Mar. 14, 2007

Related U.S. Application Data
(60) Provisional application No. 60/782,249, filed on Mar. 14, 2006.

(51) Int. Cl. G06F 3/048

(52) U.S. Cl. 715/764

(57) ABSTRACT

Methods and apparatus to combine data from multiple computer systems for display in a computerized organizer are disclosed. The system disclosed combines personal and business data from a plurality of different systems such as local systems, enterprise systems, and web services. In this manner, information workers can use a single consistent interface to access, organize, and modify business information such as contacts, tasks, files, etc. In addition, changes to information in one system are automatically reflected by the computerized organizer. As a result, information workers can collaborate in an ad hoc manner.

### PRIORITY CLAIM

This application claims the benefit of U.S. Provisional Patent Application No. 60/782,249, filed Mar. 14, 2006, entitled “Methods And Apparatus For Managing Professional Services Information,” the entire contents of which are hereby incorporated by reference.

### TECHNICAL FIELD

The present system relates in general to computerized organizers, and, more specially to methods and apparatus to combine data from multiple computer systems for display in a computerized organizer.

### BACKGROUND

Personal information managers-computer-based systems commonly known as “personal organizers”-are used widely by business and home users. A typical personal information manager provides the user with a calendar, a contact list, and an e-mail client. Some personal information managers also offer features such as “to-do” lists (also known as “task lists”), journaling features, and “sticky-note” features. Some personal information managers offer messaging features in addition to e-mail, such as instant messaging capabilities and integrated access to threaded discussion boards. Additionally, some personal information managers include collaboration-management features, such as calendar sharing and routed meeting invitations. In addition to such organizer features, some personal information managers also provide a degree of integration with other types of applications; for instance, a personal organizer may allow the user to click on a contact record to find out if that person is online and available for “chatting” in a separate instant messaging application.

Despite the range of available features, personal information managers are currently limited with respect to: the types of information they manage; their ability to manage and display relationships among the different types of information they manage; the range and sophistication of their collaboration features; their ability to interact dynamically with other types of systems, such as enterprise systems and web services; and other areas. Currently, personal information managers possess relatively limited features for: synchronizing multiple types of information with remote data sources; consolidating information from multiple sources and presenting the consolidated information in simple and convenient views; managing private and shared data in the same lists; controlling access to shared data according to user roles, user relationships, and configurable rules; tracking the types of activities being scheduled and performed by the user; and generally providing more robust features for management, productivity, and communication in business environments. Also, personal information managers are currently limited in terms of their ability to support customization and extension; their architectures (including their data models, processing methods, system interfaces, navigation structures, user-interface designs, and other architectural features) do not readily support the alteration of their existing user features or the addition of new user features; also, the architectures of current personal information managers generally do not readily accommodate integration and/or communication with many different types of systems.

Of particular significance for many business users, personal information managers are currently severely limited in terms of their ability to share information with enterprise software systems. (Commonly-used enterprise systems include: project management systems, collaboration systems, document management systems, business intelligence systems, business process management systems, customer relationship management systems, time-billing systems, accounting systems, human resource management systems, enterprise resource planning systems, corporate intranets, corporate extranets, and various other kinds of specialized business applications that perform “enterprise services”.) Many types of “information workers” require information from enterprise systems to perform their work but tend to lack truly efficient and effective ways to access and manage that information. Such workers include: professionals and support staff in professional services firms; executives, managers, and sales personnel in corporate environments; workers in other information-intensive and/or project-oriented fields such as scientific research, financial services, construction, real estate, medicine, and publishing; and information workers in other fields. Such workers would benefit from a personal organizer that could be configured and used in such a way as to (a) provide the user with quick and easy access to information from enterprise systems and (b) allow the user to organize that enterprise information in terms of the user's own activities. Currently, personal information managers are poorly-suited for such use.

Also of particular significance to many business users, personal information managers are currently limited in their ability to organize activities and information in terms of projects. Many businesses use enterprise systems for managing projects, but the features offered by those systems generally do not support the needs of individual users regarding the scheduling of activities, the management of documents, the management other types of project-related information, and communication with team members in integrated, personalized views.

Given the limitations of current personal information managers, users would benefit from a more efficient way to access and manage personally-relevant information, including both enterprise business information and private personal information. Users would also benefit from tools that would enable them to use their information more effectively; such tools would lead to improved communication and improved decision-making.

Regarding the general constitution of enterprise systems themselves, enterprise systems currently tend to be relatively isolated and rigid; they are oriented toward serving the enterprise as a whole and typically offer no personal workspace for people to store personal and/or private data or to organize enterprise information in terms of the individual's needs and preferences. Furthermore, enterprise systems tend to offer complicated interfaces and the use of enterprise systems is generally regulated according to strict policies and/or procedures. An enterprise system is generally designed for a department or designed to support a business process for the enterprise as a whole; they are generally not designed around the needs and preferences and work-styles of individual users. Furthermore, current enterprise applications are generally limited in terms of their ability to integrate and/or communicate with personal information managers.

### SUMMARY

The present system overcomes the described deficiencies of the prior art by providing a computer system as follows: (a) the system includes a personal information manager; (b) the system also includes a set of other applications and components, optioanlly including a collection of enterprise applications, as well as other types of data-management, productivity, collaboration, and messaging applications; (c) the personal information manager and the other “native” applications function together by design as a fully-integrated whole, communicating seamlessly and providing complimentary feature sets; (d) the system is also designed to support dynamic connections to external systems, including but not limited to enterprise systems and web services; (e) the system is designed to gracefully accommodate information from virtually any kind of external system; (f) the system is designed to be highly-extensible and includes an application programming interface and related developer tools that support the development of additional related applications that will function as fully-integrated parts of the system.

Additional features and advantages are described herein, and will be apparent from, the following Detailed Description and the figures.

### BRIEF DESCRIPTION OF THE FIGURES

FIG. 1 is a block diagram showing an example of the system's data model.

FIG. 2 is a block diagram showing another example of the system's data model.

FIG. 3 is a block diagram showing another example of the system's data model.

FIG. 4 is a block diagram showing another example of the system's data model.

FIG. 5 is a block diagram showing another example of the system's data model.

FIG. 6 is a block diagram showing another example of the system's data model.

FIG. 7 is a block diagram showing another example of the system's data model.

FIG. 8 is a block diagram showing another example of the system's data model.

FIG. 9 is a block diagram showing another example of the system's data model.

FIG. 10 is a block diagram showing an example of the conceptual roots of the system's data model.

FIG. 11 is a block diagram showing another example of the system's data model.

FIG. 12 is a block diagram showing another example of the system's data model.

FIG. 13 is a block diagram showing another example of the system's data model.

FIG. 14 is a block diagram showing another example of the system's data model.

FIG. 15 is a block diagram showing another example of the system's data model.

FIG. 16 is a block diagram showing another example of the system's data model.

FIG. 17 is a block diagram showing another example of the system's data model.

FIG. 18 is a block diagram showing another example of the system's data model.

FIG. 19 is a block diagram showing another example of the system's data model.

FIG. 20 is a block diagram showing a example deployment of a example implementation of the system's design.

FIG. 21 is a screen shot showing an example of the system's graphical user interface.

FIG. 22 is a screen shot showing another example of the system's graphical user interface.

FIG. 23 is a screen shot showing another example of the system's graphical user interface.

FIG. 24 is a screen shot showing another example of the system's graphical user interface.

FIG. 25 is a block diagram showing another example of the system's data model.

FIG. 26 is a block diagram showing another example of the system's data model.

FIG. 27 is a block diagram showing an example of the system's use cases.

FIG. 28 is a screen shot showing another example of the system's graphical user interface.

FIG. 29 is a screen shot showing another example of the system's graphical user interface.

FIG. 30 is a screen shot showing another example of the system's graphical user interface.

FIG. 31 is a screen shot showing another example of the system's graphical user interface.

FIG. 32 is a screen shot showing another example of the system's graphical user interface.

FIG. 33 is a screen shot showing another example of the system's graphical user interface.

FIG. 34 is a screen shot showing another example of the system's graphical user interface.

FIG. 35 is a screen shot showing another example of the system's graphical user interface.

FIG. 36 is a screen shot showing another example of the system's graphical user interface.

FIG. 37 is a screen shot showing another example of the system's graphical user interface.

FIG. 38 is a block diagram showing another example of the system's data model.

FIG. 39 is a block diagram showing another example of the system's data model.

FIG. 40 is a block diagram showing an example of the system's use cases.

FIG. 41 is a screen shot showing another example of the system's graphical user interface.

FIG. 42 is a screen shot showing another example of the system's graphical user interface.

FIG. 43 is a screen shot showing another example of the system's graphical user interface.

FIG. 44 is a screen shot showing another example of the system's graphical user interface.

FIG. 45 is a screen shot showing another example of the system's graphical user interface.

FIG. 46 is a screen shot showing another example of the system's graphical user interface.

FIG. 47 is a screen shot showing another example of the system's graphical user interface.

FIG. 48 is a screen shot showing another example of the system's graphical user interface.

FIG. 49 is a block diagram showing another example of the system's data model.

FIG. 50 is a screen shot showing another example of the system's graphical user interface.

FIG. 51 is a block diagram showing an example of the system's use cases.

FIG. 52 is a screen shot showing another example of the system's graphical user interface.

FIG. 53 is a screen shot showing another example of the system's graphical user interface.

FIG. 54 is a screen shot showing another example of the system's graphical user interface.

FIG. 55 is a screen shot showing another example of the system's graphical user interface.

FIG. 56 is a screen shot showing another example of the system's graphical user interface.

FIG. 57 is a screen shot showing another example of the system's graphical user interface.

FIG. 58 is a screen shot showing another example of the system's graphical user interface.

FIG. 59 is a block diagram showing another example of the system's data model.

FIG. 60 is a screen shot showing another example of the system's graphical user interface.

FIG. 61 is a screen shot showing another example of the system's graphical user interface.

FIG. 62 is a screen shot showing another example of the system's graphical user interface.

FIG. 63 is a block diagram showing another example of the system's data model.

FIG. 64 is a block diagram showing another example of the system's data model.

FIG. 65 is a block diagram showing another example of the system's data model.

FIG. 66 is a block diagram showing another example of the system's data model.

FIG. 67 is a block diagram showing another example of the system's data model.

FIG. 68 is a block diagram showing an example of the system's use cases.

FIG. 69 is a screen shot showing another example of the system's graphical user interface.

FIG. 70 is a screen shot showing another example of the system's graphical user interface.

FIG. 71 is a screen shot showing another example of the system's graphical user interface.

FIG. 72 is a screen shot showing another example of the system's graphical user interface.

FIG. 73 is a screen shot showing another example of the system's graphical user interface.

FIG. 74 is a screen shot showing another example of the system's graphical user interface.

FIG. 75 is a screen shot showing another example of the system's graphical user interface.

FIG. 76 is a screen shot showing another example of the system's graphical user interface.

FIG. 77 is a screen shot showing another example of the system's graphical user interface.

FIG. 78 is a screen shot showing another example of the system's graphical user interface.

FIG. 79 is a screen shot showing another example of the system's graphical user interface.

FIG. 80 is a screen shot showing another example of the system's graphical user interface.

FIG. 81 is a screen shot showing another example of the system's graphical user interface.

FIG. 82 is a screen shot showing another example of the system's graphical user interface.

FIG. 83 is a screen shot showing another example of the system's graphical user interface.

FIG. 84 is a screen shot showing another example of the system's graphical user interface.

FIG. 85 is a screen shot showing another example of the system's graphical user interface.

FIG. 86 is a screen shot showing another example of the system's graphical user interface.

FIG. 87 is a screen shot showing another example of the system's graphical user interface.

FIG. 88 is a screen shot showing another example of the system's graphical user interface.

FIG. 89 is a screen shot showing another example of the system's graphical user interface.

FIG. 90 is a block diagram showing another example of the system's data model.

FIG. 91 is a block diagram showing an example of the system's use cases.

FIG. 92 is a screen shot showing another example of the system's graphical user interface.

FIG. 93 is a screen shot showing another example of the system's graphical user interface.

FIG. 94 is a screen shot showing another example of the system's graphical user interface.

FIG. 95 is a screen shot showing another example of the system's graphical user interface.

FIG. 96 is a screen shot showing another example of the system's graphical user interface.

FIG. 97 is a screen shot showing another example of the system's graphical user interface.

FIG. 98 is a screen shot showing another example of the system's graphical user interface.

FIG. 99 is a block diagram showing another example of the system's data model.

FIG. 100 is a block diagram showing another example of the system's data model.

FIG. 101 is a block diagram showing an example of the system's use cases.

FIG. 102 is a screen shot showing another example of the system's graphical user interface.

FIG. 103 is a screen shot showing another example of the system's graphical user interface.

FIG. 104 is a screen shot showing another example of the system's graphical user interface.

FIG. 105 is a block diagram showing another example of the system's data model.

FIG. 106 is a block diagram showing another example of the system's data model.

FIG. 107 is a block diagram showing another example of the system's data model.

FIG. 108 is a block diagram showing another example of the system's data model.

FIG. 109 is a screen shot showing another example of the system's graphical user interface.

FIG. 110 is a block diagram showing another example of the system's data model.

FIG. 111 is a screen shot showing another example of the system's graphical user interface.

FIG. 112 is a block diagram showing another example of the system's data model.

FIG. 113 is a screen shot showing another example of the system's graphical user interface.

FIG. 114 is a block diagram showing another example of the system's data model.

FIG. 115 is a block diagram showing an example of the system's use cases.

FIG. 116 is a block diagram showing another example of the system's data model.

FIG. 117 is a block diagram showing an example of the system's use cases.

FIG. 118 is a block diagram showing another example of the system's data model.

FIG. 119 is a screen shot showing another example of the system's graphical user interface.

FIG. 120 is a screen shot showing another example of the system's graphical user interface.

FIG. 121 is a screen shot showing another example of the system's graphical user interface.

FIG. 122 is a screen shot showing another example of the system's graphical user interface.

FIG. 123 is a screen shot showing another example of the system's graphical user interface.

FIG. 124 is a screen shot showing another example of the system's graphical user interface.

FIG. 125 is a block diagram showing another example of the system's data model.

### DETAILED DESCRIPTION

Terminology

The following terms may be used throughout this document to describe the system and its various parts.

The system as a whole will generally be referred to as the system. In a preferred embodiment, the system includes: a personal information manager; a set of enterprise server applications that provide security features, manage data, distribute data throughout the system, and perform other “core services”; a set of “native” enterprise applications that offer feature sets comparable to typical enterprise software systems; a set of system connectors that support connections to external systems; a set of developer tools that support the alteration and extension of the system; and all other parts of the system that are expressly described as being part of the system. In this document, the system does not include “third-party” systems that have not been designed as parts of the system; such systems will be described as external systems. External systems will include external enterprise applications and external web-based resources such as external websites and external web services.

The personal information manager may alternately be referred to as the personal organizer, as the organizer application, or as the organizer.

System Overview

The system is the expression of an underlying prescriptive solution called the Tekton Solution. The Tekton Solution consists of a number of interrelated design elements. The Tekton Solution's design elements include, but are not limited to: data model elements (including data objects and associations between those objects); graphical user interface (GUI) elements; automatic and user-initiated functions; and various system interfaces.

The solution can provide value in a number of different contexts and its design can be implemented through a variety of supporting technology platforms. The solution describes a set of core elements and structures that can be extended and configured to suit a wide range of user environments.

The solution describes a collection of software applications and related elements that collectively combine the functionality of a personal organizer with communication and management features for large enterprises. Through a variety of integrated features, the implemented system provides functionality in a number of areas, including: personal organization of business and personal matters, such as projects, tasks, folders, documents, media files, e-mail, e-mail attachments, information about companies & people, other information related to business and personal activities; project management & team management; human resource management; business process management; time-billing and accounting practices; client relationship management & business development practices; learning management & professional development practices; document management & knowledge management; and others.

The solution is based upon a conceptual design that may be implemented in one or more ways. The solution also describes a set of preferred methods for implementing the solution. The solution describes a set of related design elements.

The design elements include the articulation of a specific set of previously unrecognized user needs that can be met through a new kind of software solution. The user needs translate into a specific set of general design requirements and a specific set of novel strategies and techniques for meeting those needs.

The design elements include the Tekton Data Model, also called the Universal Data Model-a conceptual data model that makes it possible to meet the identified user needs in a very broad range of user environments. The conceptual data model is novel and powerful, both in the data-management sense and in the broader business sense. The conceptual data model describes a comprehensive ‘solution domain’that is comprised of two ‘zones’of data and functionality-the Enterprise Zone and the Personal Organizer Zone (a.k.a. the Organizer Zone). The conceptual data model also describes certain aspects of the relationships between the two zones.

The conceptual data model describes communication between the two zones in terms of a novel architectural device referred to as the Tekton Dyad. The conceptual data model also describes a five-part structural domain model that works across the two zones. The five-part domain model supports the development of a graphical user interface that can handle all useful types of enterprise data and personal organizer data and that can present all of that data within a navigation structure that is both compact and intuitive.

The design elements include a more specific data model that describes specific user features for managing projects, tasks, folders, files, etc. The Tekton Data Model and related design elements explicitly support a single code base that may be configured and extended to meet the exact needs of disparate user groups.

The design elements include a set of novel user processes and programmatic processes that support real-world business processes in unique and valuable ways

The design elements include a set of graphical user interface (GUI) elements that offer unique and valuable user features. The GUI elements provide intuitive and accommodating tools for performing personal organization, for viewing enterprise data, for managing links to enterprise systems, for managing other aspects of the system itself, and for performing specific business-related activities, such as managing projects, delegating tasks, communicating with coworkers, organizing research, working with documents, reporting time-billing information, etc.

The design elements include a set of standardized system interfaces to support configuration-time integration with external enterprise systems, external web services, and other external data sources.

The system is designed to function as a ‘universal hub’ for working with integrated views of data from multiple enterprise systems. The personal organizer application provides the individual user with an intuitive and accommodating tool for viewing enterprise data within the context of his or her own activities. In doing so, the system can make existing enterprise systems more valuable by making the information in those systems more accessible and more useful.

The personal organizer is both (a) a thoroughly relational database solution and (b) capable of communicating dynamically with other systems, such as enterprise systems and web services. The combined effect is that the user gains the ability to interact with the enterprise suite as though it is a single relational database solution that can be managed in terms of the user's own concerns and activities. The system provides the organizer user with a “personal front end” for the enterprise suite.

The system also serves as a useful tool for monitoring and managing work-in-progress (WIP), especially in “information-worker environments”. In such environments, much of the work performed consists of “tacit interactions”—subtle, distributed, loosely-structured activities such as communication, project management, and decision-making that do not lend themselves well to “assembly-line” techniques of business process engineering and management. “Tacit interactions” cannot be effectively managed in a top-down fashion using centralized “command-and-control” methods. Rather, in such environments, decisions are made in a decentralized fashion. Monitoring and managing WIP in such environments requires similarly decentralized systems-systems that are flexible and accommodating that support tacit interactions. The system described in this document is just such a system.

The design elements include a set of standardized system interfaces to support the development of additional internal components and related external applications that address specialized business needs. As a tool for productivity, communication and management in project-based environments, the organizer-server combination provides considerable value as a standalone system. However, the system is designed to integrate with centralized enterprise systems in ways that significantly increase its usefulness and appeal. The system is more than an internally coherent solution that addresses and solves discrete set of business problems. The system also provides an architectural and programmatic context-a ‘platform’-for the development and deployment of additional valuable applications. In this respect, the Tekton Solution establishes a new class of solution.

The system was originally designed to address a number of specific challenges found in the operation of large professional services firms. In such an environment, individual practitioners have specialized needs for personal organization. For instance, at any given time, a lawyer may be working on a dozen different client matters (projects) and have 30 or more due dates (tasks) associated with various aspects of that work. The lawyer needs to keep track of those projects and tasks in a convenient and reliable way. The lawyer also needs to record and submit time-billing information on client projects; manage current workload and upcoming availability; schedule professional development activities such as seminars and workshops; schedule meeting dates with career advisors; record and pursue specific career goals; and track progress toward those goals according to specific benchmarks. Each lawyer not only needs to keep track of the dates and times associated with the various projects and tasks at hand; a lawyer also needs to communicate important facts about those activities with other people in the organization. For example, an associate in a law firm needs to communicate details about his or her activities with team leaders, with practice group leaders, with business development coordinators, with professional development coordinators, with career advisors, with assignment coordinators, and with other associates. Each of those people needs to communicate with the associate in a different way. For instance, a team leader on a project needs to know about the associate's progress on tasks within that particular project; a professional development coordinator needs to know about the associate's recent activities as those activities relate to professional development goals and standardized professional development benchmarks. Moreover, professionals must organize and communicate all of this complex information in a time-deprived, high-stress environment. The system provides an intuitive, accommodating, and efficient framework for managing and sharing all of these kinds of work-related information. Furthermore, the system allows the user to manage personal information (i.e. non-work-related information) on the same lists as work-related information. In so doing, the system provides the user with a single place for managing all such work-related and personal information.

The system provides value on two levels at once: on an individual-user level, the system provides the target user with a superior personal tool for the organization of activities and for the management of activity-related information; on an enterprise level, the system provides a rich set of collaboration features that provide real-time visibility throughout an organization with regard to people's activities.

The personal organizer offers database-oriented features that allow the system to intelligently manage useful information about the specific nature of each recorded activity. For instance, the organizer allows the user to group related tasks together into labeled projects. This allows users to view and manage tasks by project.

The system also allows the user to specify a date type for each task. For instance, the user can designate the date for any given task as a ‘Due Date’. This allows the user-with a single click-to filter the entire calendar to show only critical due dates for tasks on important projects.

The organizer allows the user to assign categories to tasks. Categories allow users to track their activities according to standardized category lists. The categorized data can be shared with advisors and professional development coordinators to help the user manage his or her career development. Also, category labels provide shortcuts for data-entry; when creating a new task record, instead of typing a label, the user can select a category and use the category label for the task label.

The organizer allows a user to reuse task data for more efficient time-reporting for billable activities. For users that bill units of time to client projects, the organizer provides a simple and efficient interface for capturing and sharing time-billing information with assistants and/or with a centralized time-entry system.

The organizer supports user proxies, which allow executive assistants to manage organizer data on behalf of busy professionals.

The system allows the user to create record-links between personal organizer records and corresponding records in centralized enterprise systems. Using the established links, the organizer can display related data from the external systems. The links thus allow personal organizer records to function as aliases for (or extensions of) records in the centralized systems. The use of links is entirely optional, however. If a given record does not relate to centralized enterprise data-for instance, if a personal organizer record corresponds to a personal project or task-, the record is simply left unlinked. As a result, Tekton allows the user to manage all of his or her personal and professional activities in a single place.

Each organizer record can serve as an alias for one or more records in one or more connected systems (in addition to performing ‘basic organizer services’).

The system will generally provide features that allow the user of the organizer to control what, if any, organizer data is made visible to other users and/or to the enterprise generally.

Because the organizer can display link-related data from enterprise systems, the organizer can serve as a ‘personal remote viewer’ for all information in all centralized systems that relate to the user's own activities. The organizer gives the user the ability to control what data from enterprise systems is displayed in the user's personal organizer. The organizer displays all such data within the context of the user's own activities. For instance, if a user creates a link from a project record in the personal organizer to a project record in a centralized project management system, the link is based upon a centralized index value from the project management system. That value can be used to automatically retrieve and display a list of related documents from a centralized document management system. In another example of creating links to enterprise systems, a user can create a task record that is linked to an event on an enterprise calendar. On the enterprise calendar, the event record may contain a link to an event-related document. The system can display the document link as part of the task record in the personal organizer. Furthermore, if the date or other information about the event changes on the enterprise calendar, the user can be automatically notified of the change.

The system can support organizer-based interaction with activity-driven, content-based programs by returning information to external systems that provide dynamically linked records. For instance, a particular content-based program may offer support for business development activities by automatically ‘feeding’ the personal organizer with tasks according to a standardized program for cultivating new business. The external system can initially prompt the organizer to create a task record labeled ‘Identify a New Prospect by Name and Phone Number’. When the user retires the first task record, the organizer can ask the user to indicate whether the user succeeded in the task, and if so, to enter the name and phone number of the new prospect in a pair of text boxes. The system can return the name and phone number of the new prospect to the external system. The external system can then prompt the organizer to create the next task in the program, perhaps labeled ‘Call <prospect_name> at <prospect_phone_number> to request a meeting’.

The system can allow users to share feedback about the performance of specific activities. For instance, when an associate in a law firm completes a task for a given client project, the system can send the associate's supervisor a short questionnaire about the associate's performance of that task. The results can be returned confidentially, or the results can be shared with one or more other people, such as the associate's professional development coordinator and the associate's career advisor.

As a collaboration tool, the system offers a variety of communication and management features that enable multiple users to share activity-related information in real-time. Access to information can be controlled through configurable user roles and through rules pertaining to indicated relationships between users. For instance, access based on user role may allow a professional development coordinator to see activity histories for all associates in a law firm. In an example of relationship-based access, a partner may be able to see the same kind of activity-history information about a single associate only because the partner is indicated as being the official career-development advisor for that associate.

The collaboration features of the system address a number of areas. For instance, the organizer allows the user to access team views for projects that include information about the project-related activities of each team member. Also, the system allows team leaders to delegate tasks to team members. When a task is delegated to a user, the user is notified of the delegated task and is asked to accept or decline the task. (The individual user generally has final control over what data appears in his or her personal organizer.) Furthermore, the system allows the user to communicate with other team members about project-related tasks in real-time. With a single click, a team manager can request a progress-update from a team member about a specific task. The team member can respond with a single click (or, optionally add a text message) to indicate current progress on the given task.

Just as the system can allow an individual to interact with activity-driven, content-based programs, the system can also enable organizations to implement management initiatives in a more efficient and more effective manner. The system can provide a convenient and engaging platform for coordinating such efforts.

In addition to project-based views, the organizer provides person-centric views and organization-centric views that allow the user to view activity-related information about specific individuals and specific clients. Person-centric views can be used to help better manage individual people within the organization. For instance, an assignment coordinator can use a person-centric view to see information about an associate's prior experiences and current workload. Organization-centric views can be used to help better manage client relationships. For instance, a senior partner can use an organization-centric view to see real-time information about (a) what projects are underway for a given client, (b) who is responsible for each project, (c) who is working on each project, and (d) how each project is progressing. Such information can allow the senior partner to respond to client requests and complaints more quickly and in a more informed manner.

As a whole, the system's capabilities make it a powerful, database-oriented solution both for personal organization and for enterprise-wide collaboration. Despite its sophisticated features, however, the organizer provides an intuitive and ‘lightweight’ user experience. The organizer is designed to be highly flexible and accommodating.

The system is highly accommodating in terms of placing few use restrictions upon the user. In the organizer, data-entry fields are generally optional, and the system handles partial information intelligently. For instance, with a task record, the user can do any of the following in any order, with each step being optional: add a label, add a task-date, add a task-date type, add an activity type, add a start time, add a stop time, and/or indicate a category.

Despite its number of innovative features, the organizer's user interface is similar to those in other organizer applications. For instance, the personal organizer's calendar display is visually similar to familiar ‘flat calendar’ solutions. In fact, the underlying Tekton Solution can be integrated into almost any standard calendaring solution seamlessly, without changing the appearance or behavior of basic features. For instance, in any typical configuration of the Tekton Solution-no matter how complex-the user can still simply click on a date and type a short label to schedule an event in the personal organizer. If the user wishes to add more complex data to the record or to use the record to establish dynamic links to external systems, the user can do so using straightforward GUI elements that expand as needed. Furthermore, the relatively more complex features of the solution are often handled automatically by the system.

System Architecture

The Tekton Data Model describes extremely generic data objects (Project, Task, etc.) that can be extended by type definitions to accommodate useful specialized data and that can be related to one another to provide integrated views of related data, even including data from systems that are not directly integrated with one another. The generic objects support accommodating workflows, intuitive navigation, and consolidated views of data from many disparate sources.

The data model supports many useful features, including the consolidated management of private data and shared data on the same lists, as well as the consolidated management of local and remote data on the same lists.

The data model supports the integrated management of e-mail, allowing e-mail messages and attachments to be linked to company records, people records, project records, task/event/activity records and/or other organizer records, which supports enhanced search features and enhanced archiving features.

The data model allows the organizer to accommodate connections to virtually all types of enterprise systems and web services while maintaining a compact, consistent, and intuitive navigation structure.

The data model supports the extension of the organizer via a plug-in registry, in conjunction with the system's application programming interface.

The data model allows the organizer to serve as a standard, automated platform for Web services delivery.

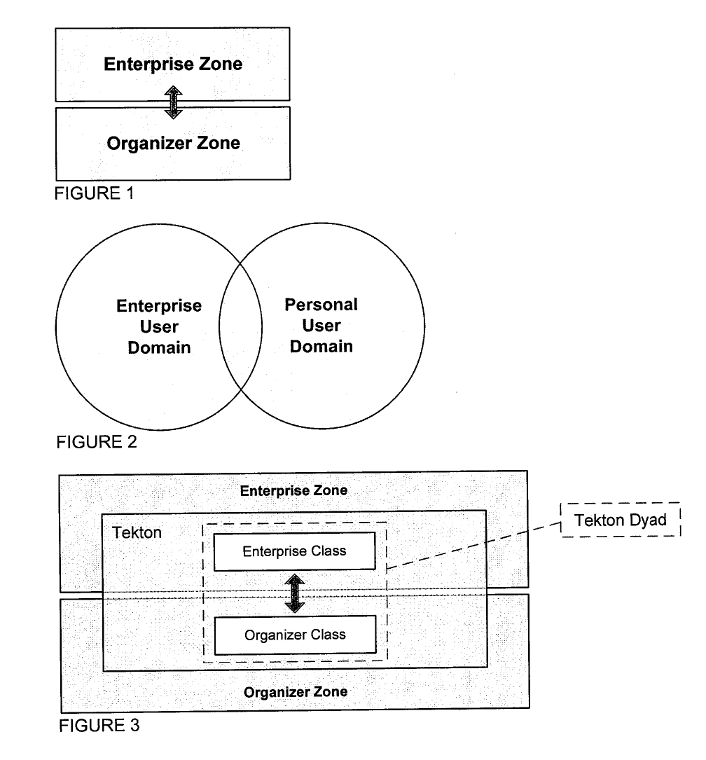

Conceptually, the Tekton model is comprised of two ‘zones’ of data and functionality: an Enterprise Zone and an Organizer Zone. The term ‘Organizer Zone’ is short for ‘Personal Organizer Zone’. As illustrated in FIG. 1, the Enterprise Zone and the Organizer Zone are distinct entities, yet they are dynamically related.

The Enterprise Zone contains enterprise data and performs enterprise services.

In general, enterprise data is: defined in terms of the enterprise; organized in centralized databases that are explicitly designed to support coordinated business processes; managed by individuals (such as administrative staff) on behalf of the enterprise; created and updated according to established policies and procedures that are implemented uniformly throughout the enterprise; shared by members of the enterprise within the context and course of enterprise activities. Enterprise data generally resides in centralized enterprise systems such as: centralized project management systems, centralized document management systems, centralized time-billing and accounting systems, centralized customer relationship management systems, centralized business process management systems, and other types of centralized enterprise systems.

In general, enterprise services are provided by, or are provided in conjunction with, enterprise systems. Enterprise services support the business functions of the enterprise as a whole.

The Organizer Zone contains personal organizer data and performs personal organizer services.

In general, personal organizer data is: defined in terms of the individual user; consolidated and organized in terms of the user's own activities (i.e. organized from the perspective of the individual user); managed by the individual user, sometimes with the aid of one or more assistants; created and updated by individual users for personal use according to personal preferences, personal tendencies, and personal habits, with few or no externally-imposed use restrictions (i.e. users are generally free to use their personal organizers in whatever ways are most convenient and most useful for them personally, with little or no regard to enterprise policies and procedures); shared with other members of the enterprise only in subsets and/or indirectly.

Personal organizer data generally resides in personal organizer systems such as: personal calendaring systems, personal ‘to-do’ lists and personal goal lists, personal filing systems for managing desktop folders, documents and other files, personal documents, personal e-mail systems, personal spreadsheets and personal finance applications, and personal contact management systems (‘address books’).

In general, personal organizer services are provided by, or are provided in conjunction with, personal organizer systems. Personal organizer systems support the personal management and personal productivity of individuals that may work within enterprises.

In a broader sense, the Enterprise Zone and the Organizer Zone can be said to exist apart from computer systems altogether. For instance, let us assume that a team leader is managing nine projects on behalf of an enterprise. The team leader is given a tenth project to run, and the team leader composes a handwritten list of team members for the new project. In addition to the name of each team member, the list includes the responsibilities of each team member for the project. Each team member is assigned one task, and each task has one specific due date. The information contained in the list is enterprise data that can be said to exist in the Enterprise Zone.

Next, let us assume that the team leader calls a project kick-off meeting that is attended by the entire team. The team leader reads the list to the group, giving each team member their assigned task and due date. Each team member writes a note as a personal reminder about his or her assigned task. Some team members put their given task on a ‘to-do’ list and write the due date next to the task. Some team members write a description of their given task in a personal calendar under the task's due date. Some team members record the task information on a legal pad and will copy the information into a personal calendar at a later time. The information contained in each note is personal organizer data that can be said to exist in the Organizer Zone.

An important distinction can be made by considering whether or not the team leader's list might actually exist in the Organizer Zone (a.k.a. Personal Organizer Zone) for the team leader himself, since the team leader is in charge of the entire project and is therefore ultimately responsible for the completion of each task on the list. The distinction can be made by considering the uses and usefulness of the list itself. For the team leader, the list may be a useful management tool, but it is not a particularly useful tool for personal organization.

Such a team list is not a useful tool for personal organization because the team leader has ten projects altogether, and using ten separate lists (by, say, tacking them on a wall or collecting them in a binder) is a poor strategy for personal organization. This is especially true if we assume that the team leader has many other activities to keep track of as well, including activities that are purely personal, such as family events, planned vacations, doctor appointments, and the like. In order to achieve truly effective personal organization, the team leader must consolidate all such information into a single place. That is, to achieve effective personal organization, the team leader must take the tasks and dates that are important to him personally from all of the relevant sources and consolidate them-ideally into a single calendar. (A point of clarification: The collection of ten team lists may indeed be a useful tool for the team leader for organizing activities, but they only serve well in terms of the team leader's function as a team leader. If the team leader were to tack the ten lists on the wall and use them as his only tool for personal organization, then the team leader would be choosing a severely limited tool for personal organization.)

To further consider the relationship between the team list and the personal calendar, let us assume that the team leader posts the team list for each project in the hall outside of his office. The team leader does this to help ensure that each person knows what they are expected to do and when they are expected to do it. Furthermore, making such lists available to the group can help team members coordinate related activities with one another. The team lists are enterprise tools for communication and management.

To make sure that the lists are useful, the team leader: types each list on a typewriter to ensure legibility; arranges each list in a similar fashion, using the same format each time, using the same column order and underlined column headings for maximum clarity; types out the full name of each team member to avoid potentially confusing abbreviations; types out a brief description of each task on the list, using full sentences where necessary to ensure that each team member understands exactly what is required; and types out the due date for each task, using the same format each time.

Now let us assume that, out of ten team leaders in the enterprise, our list-typing-and-posting team leader has the best on-time completion record for projects. As a result, the CEO makes it a company policy that each team leader must type such a list for each project and that each list must use the format developed by our top performer. The structure and use of the team list is now part of official enterprise policies and procedures.

In contrast to the formality and uniformity of the typed-and-posted team lists, our team leader's personal calendar is filled with cryptically abbreviated handwritten notes that are illegible to anyone other than the team leader. Also, the team leader's personal calendar excludes a number of project-related dates (because he only includes the most critical dates in his own calendar), and it includes a number of tasks and dates that have nothing to do with the enterprise at all (including a wedding anniversary and a colonoscopy appointment). The team leader's personal calendar is clearly not useful as an enterprise tool for communication and management, and we can expect that the team leader would in fact prefer not to post his personal calendar in the hallway. Nevertheless, the team leader's personal calendar is a very useful tool for personal organization.

In the course of making effective use of his personal calendar, the team leader: writes entries by hand, making free use of idiosyncratic abbreviations and not worrying about legibility; consolidates information from many sources, taking from each source only the information that is personally relevant and useful; makes graphical marks to group the entries visually by project makes graphical marks to highlight the most important entries and to highlight conflicts that need resolution; makes additional personal notations to explain complex tasks and to remember important task-related information.

The differences between the Enterprise Zone and the Organizer Zone are illustrated by comparing the team list to the personal calendar and considering the content, format, use and usefulness of each tool. The team list is a tool for team management and group communication that is formatted and composed to support specific business processes. The team list contains enterprise data and performs an enterprise service. As such, its contents belong to the Enterprise Zone. The personal calendar is a tool for personal management that may contain pieces of enterprise-related information as well as personal information that does not pertain to the enterprise. The personal calendar contains personal organizer data and performs a personal organizer service. As such, its contents belong to the Organizer Zone.

FIG. 2 illustrates the relationship between the contents of the Enterprise Zone and the contents of the Organizer Zone. The Enterprise Zone contains information about the enterprise user domain-i.e. about the structure and the activities of the enterprise. That is, the enterprise user domain is ‘the life of the enterprise’. The Organizer Zone contains information about the personal user domain-i.e. about the structures and activities related to an individual person that may work within the enterprise. The personal user domain is ‘the life of the person’.

As suggested in FIG. 2, the enterprise user domain and the personal user domain overlap, but only partially. That is, for any individual person, the enterprise domain may contain part but not all of the information that an individual person wants to organize. The enterprise is only one part of an individual's life. For instance, if an employee is planning a birthday party for her daughter, the employee will likely want to mark the event on a personal calendar. The date may be marked on the same calendar that the employee uses to track work-related due date, but the birthday event is not properly part of the enterprise domain. Similarly, of all the business-critical information managed by the enterprise, only a small part of that information will pertain directly to and be useful for any given individual. The system manages information about both the enterprise and the personal user domains, and it provides useful tools that address the ‘overlap’ between the two domains.

The Tekton Solution is based in part upon the explicit differentiation and integration of the Enterprise Zone and the Organizer Zone. The Tekton Data Model: regards the Enterprise Zone and the Organizer Zone as distinct entities; supports user features that are appropriate to each zone; and enables dynamic communication and record-linking between the two zones.

The personal organizer performs enterprise services and personal organizer services, and it actively manages the relationship between the Enterprise Zone and the Organizer Zone.

The Tekton solution is based in part upon the use of a design element called the Tekton Dyad.

As illustrated in FIG. 3, the Tekton Dyad consists of two comparable domain classes that are associated in such a way that they support optional links between their respective objects. The dyad-member classes are ‘comparable’ in that they generally refer to the same kind of real-world entity. For instance, both classes may refer to projects or both classes may refer to documents. The dyad-member classes differ in that one class is an Enterprise Zone class and one class is an Organizer Zone class. That is, one class is used to manage enterprise data and to provide enterprise services, and the other class is used to manage personal organizer data and to provide personal organizer services.

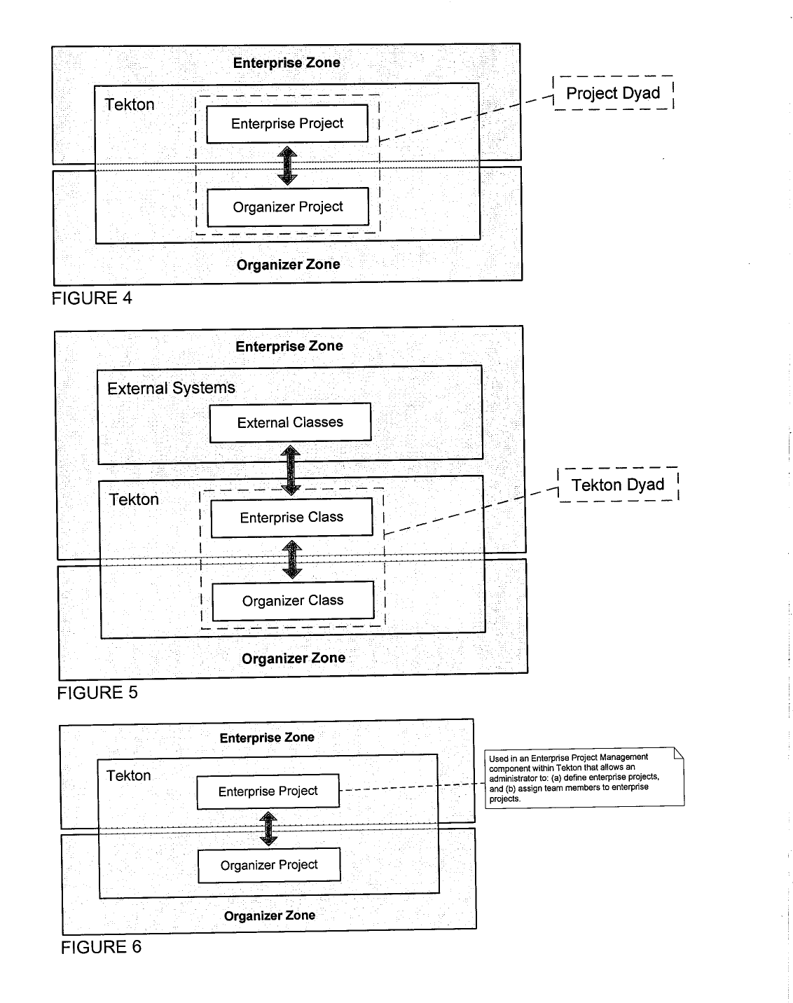

In a Tekton Dyad, the dyad-member class in the Enterprise Zone is referred to in a general sense either as the Enterprise Zone Domain Class or simply as the Enterprise Class. The dyad-member class in the Organizer Zone is referred to in a general sense either as the Organizer Zone Domain Class or simply as the Organizer Class. In a specific design or implementation, the dyad and the member classes assume more specific corresponding names. For instance, as illustrated in FIG. 4, if a Tekton Dyad is used to manage information about projects, the dyad will be called a Project Dyad, and the Project Dyad will consist of two associated classes: an Enterprise Project class and an Organizer Project class. As indicated above, the Enterprise Project class and the Organizer Project class will be associated in such a way that the classes will support optional links between enterprise project records and organizer project records.

In a typical implementation of the Tekton Dyad, the Organizer Class is used to provide user features for managing personal organizer data, for accessing personal organizer services, and for managing links to records containing corresponding enterprise data. For instance, in a Project Dyad, the Organizer Project class will typically be used to provide a list of projects for the user to manage in the user's personal organizer. Typically, the Organizer Project class will also support links from organizer project records to enterprise project records.

The organizer supports both intra-application record-linking and inter-application record-linking. In the organizer, intra-application record-linking refers to a situation in which two organizer records are linked through the creation of a stored reference that indicates the relationship between the two records. The reference may be stored in a designated field within one or both of the records, or the reference may be stored elsewhere, such as in a third “join” table that stores a pair of references that indicate the relationship between the two linked records. In the organizer, intra-application record-linking is primarily used for relating items from different modules. In the organizer, intra-application record-linking can also be used within a single module to create record-nesting. Inter-application record-linking refers to a situation in which an organizer record is linked to a record outside of the organizer (i.e. in a component, application or system other than the organizer application) through the creation of a stored reference that indicates the relationship between the two records. The reference may be stored in a designated field within one or both of the records (in its own system), or the reference may be stored elsewhere, such as in a third “join” table that stores a pair of references that indicate the relationship between the two linked records. Inter-application record-linking is primarily used to link organizer records to records in enterprise data sources (such as system-internal enterprise components, system-internal enterprise applications, and external enterprise systems) and to records and other data-sets available from web services. When creating references between records in the organizer and records in enterprise data sources, inter-application linking is frequently used in accordance with the enterprise-organizer dyad—i.e. it is used to link similar types of records in different systems. In other such cases, the linked records may be of dissimilar types. When creating references from the organizer to web services, the linked records may be of similar or dissimilar types.

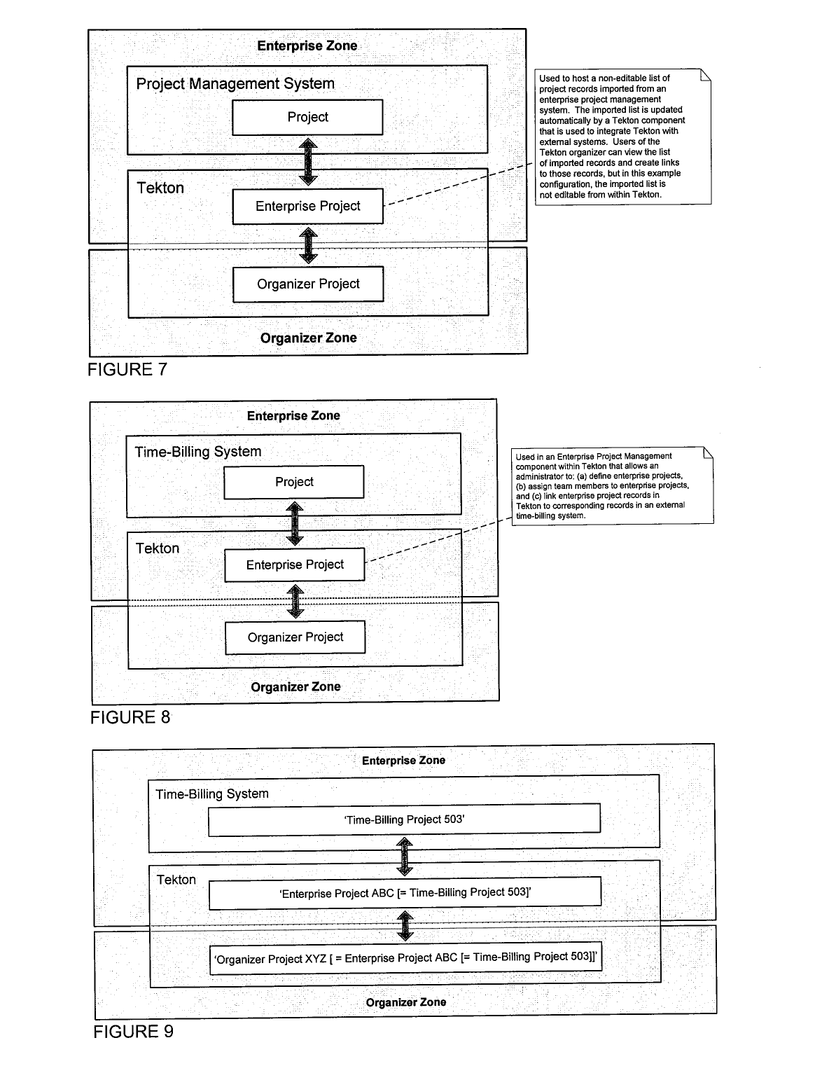

In an implementation of the Tekton Dyad, the Enterprise Class may be used to allow users to manage enterprise data with Tekton (see FIG. 6), or the Enterprise Class may be used to host proxy records (‘aliases’) for objects belonging to corresponding classes in one or more external systems (see FIG. 7), or both (see FIG. 8). For instance, using a Project Dyad, the Enterprise Project class may be used to provide features that allow an administrator to create and manage a list of enterprise project records within the Tekton solution-based application. Alternatively, the Enterprise Project class may be used to host a list of project records imported from one or more external systems; the list of imported records may not be editable within the Tekton solution-based application, but the list would allow users to link personal organizer records to records in external systems. Also, both approaches may be combined. For instance, the Enterprise Project class may be used to provide an administrator with an editable list of enterprise projects, and the administrator may also be able to link the records in that editable list to records in external systems.

FIG. 5 illustrates the general relationship between the Enterprise Class of a Tekton Dyad and corresponding classes in external systems, when the Enterprise Class is used to connect the system to external systems.

Note: In some cases, in the same way that the Enterprise Class may be used to host proxy records (‘aliases’) for corresponding objects in external systems, the Organizer Class may likewise be used to host proxy records (‘aliases’) for corresponding objects in external systems.

FIG. 6 illustrates a possible implementation of a Project Dyad, in which the Enterprise Project class is used by an Enterprise Project Management component within the system to allow users to manage enterprise project records from within the organizer.

In the example illustrated in FIG. 6, the Enterprise Project Management component allows an administrator to: (a) define enterprise projects and (b) assign team members to enterprise projects. When the administrator assigns a team member to an enterprise project, the system can automatically populate the team member's personal organizer with a corresponding linked organizer project record. Note that in this example implementation, the Enterprise Project class is not associated with a corresponding class in any external system; this example does not involve integration between the system and an external system. In this case, enterprise project records are created and managed within the system itself.

FIG. 7 illustrates a possible implementation of a Project Dyad, in which the Enterprise Project class is associated with a project class in an external project management system to allow users to create effective links between personal organizer project records and external enterprise project records.

In the example illustrated in FIG. 7, Tekton has been integrated with an external project management system such that the Enterprise Project class within Tekton is used to automatically import enterprise project records from the external system. Here, the Enterprise Project class within the system is used to support a list of project records that are imported from the external project management system. The imported records serve as proxy records or ‘aliases’ for records in the project management system. The imported records allow users to create links between (a) personal organizer records that are created and managed within the organizer and (b) enterprise project records that are created and managed in an enterprise project management system. In this example, the organizer allows users to view the list of imported enterprise project records and create links to those records from personal organizer records, but the individual imported records are not editable within the organizer. In this example, enterprise project records are created and managed in the enterprise application, not within the organizer itself.

FIG. 8 illustrates a possible implementation of a Project Dyad, in which (a) the Enterprise Project class is used by an Enterprise Project Management application within the system to allow users to manage enterprise project records within the system, and in which (b) the Enterprise Project class is associated with a project class in an external project management system to allow users to create effective links between organizer project records and external enterprise project records.

In the example illustrated in FIG. 8, the external system is an enterprise time-billing system that manages a complete list of client projects for the enterprise. The list of projects in the time-billing system provides official index numbers that must be used for billing work toward client projects. The Enterprise Project class within the system is used by an Enterprise Project Management component that allows an administrator to create enterprise project records within the system and assign team members to the defined enterprise projects. The Enterprise Project Management component also allows the administrator to create links between enterprise project records created in the system and corresponding project records in the external time-billing system. When the administrator uses the Project Management component to assign a user to an enterprise project, the system can automatically populate the user's personal organizer with a corresponding linked organizer project record. In this example, if a personal organizer project record is linked to an enterprise project record within the system, and the enterprise project record within the system is linked to an external project record in the time-billing system, then the system will be able to display the official index number from the time-billing system in the user's personal organizer. Such an arrangement is illustrated in FIG. 9.

The Tekton Solution describes a number of features related to the Tekton Dyad that (a) facilitate the creation and management of links between enterprise records and personal organizer records and (b) facilitate the creation and management of linked enterprise records and personal organizer records.

For instance, the Tekton Solution describes: graphical user interface elements that allow users to create and modify links between existing records; methods whereby (a) a new record is created and (b) the method establishes a link between the new record and an existing record—upon creating the new record, the method may also copy selected data from the pre-existing record to the new record; and features that allow the properties of linked records to affect the behavior and/or properties of one another.

The Tekton Solution is designed to accommodate the importation of data from virtually any external system. The Tekton Data Model is intended to be comprehensive enough to effectively ‘mirror’ the combined models found in any set of enterprise systems and also to support any desired personal organizer functionality.

The Tekton Data Model allows for a stable structural design that (a) supports integration with almost any type of external system and that (b) allows all available data to be accessed through a standardized navigation structure that is both intuitive and relatively compact.

The Tekton Dyad is repeated as many times as necessary to support the desired functionality.

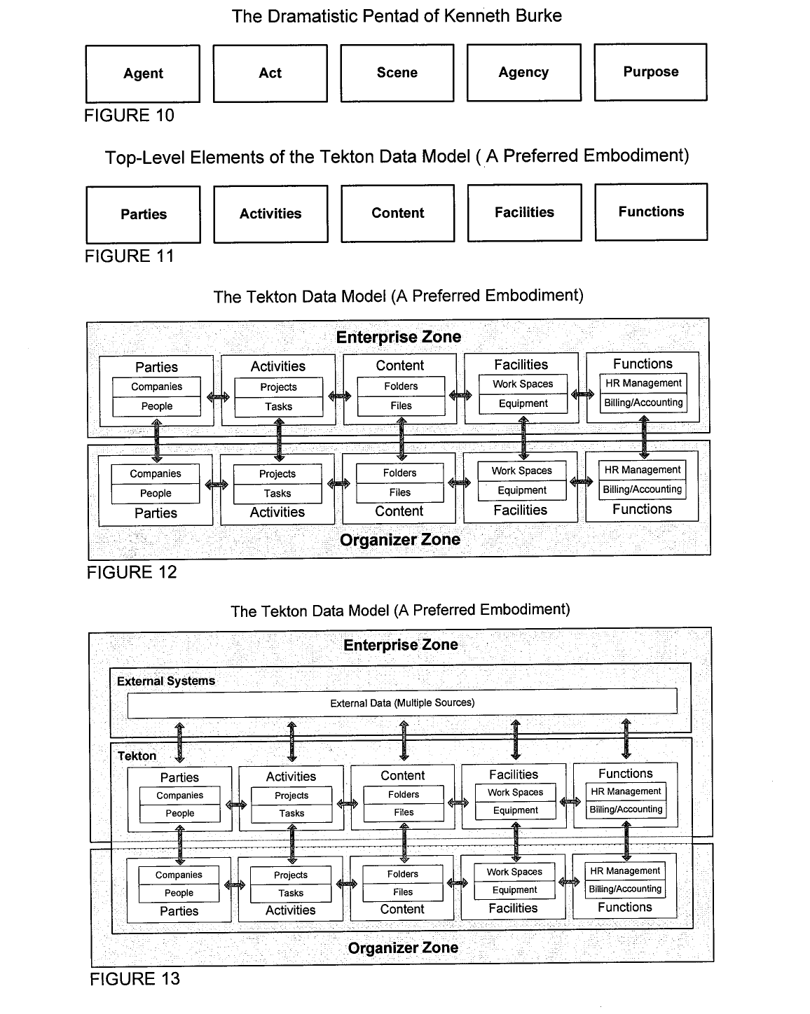

In a preferred embodiment, the Dyad is implemented according to a five-part data model. The model is based on an adaptation of the Dramatistic Pentad developed by Kenneth Burke, which is illustrated in FIG. 10.

The Dramatistic Pentad provides a framework for completely describing any human action or event. In the Tekton Solution, the Dramatistic Pentad is converted to the five-part model illustrated in FIG. 11.

In the Tekton Data Model, Content generally refers to non-physical containers and non-physical pieces of contained property-i.e. intellectual property-e.g. computer-based folders and files. The Content element is also referred to as Non-Physical Assets.

In the Tekton Data Model, Facilities generally refers to physical containers and physical pieces of contained property-e.g. locations, buildings, rooms, equipment, and stock. The Facilities element is also referred to as Physical Assets.

In the Tekton Data Model, the Functions element is generally implemented in such a way as to provide the user with views and other features that integrate personal organizer data with data from centralized business-process-based systems. For instance, by combining data from the Activities element and the Functions element, the system can allow a user to click on the name of a project (an activity), and see details related to that project, including data from the time-billing system (an ‘enterprise function’), such as the total number of hours-to-date the client has been billed for that particular project.

The Activities element generally accommodates data about the specific actions of individuals, whereas the Functions element generally accommodates data that is created and used by ongoing business processes. Stated another way, the Activities element is used to support the organization of people's activities; the Functions element is used to organize activity-related data, including data imported from external systems that support ongoing business processes.

Generally, the Tekton Dyad is implemented using each top-level element of the data model. A preferred embodiment of the Tekton solution includes the arrangement of elements illustrated in FIG. 12.

In a typical implementation, the system will be integrated with multiple enterprise systems such that associations are created between multiple Enterprise Classes and multiple external-system classes. Each of the five element-pairs (Parties, Activities, etc.) potentially represents multiple dyads.

FIG. 13 illustrates the same arrangement of elements shown in FIG. 12, plus the relationships between the system and external enterprise systems.

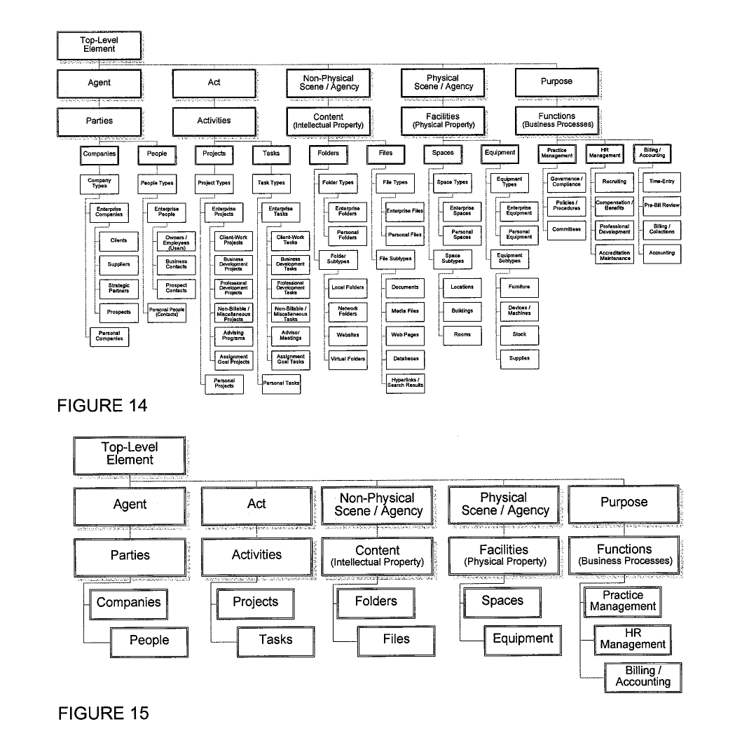

FIG. 14 illustrates a typical implementation of the Tekton Data Model from a conceptual perspective.

FIG. 15 shows a detailed view of the top four levels of the diagram shown in FIG. 14.

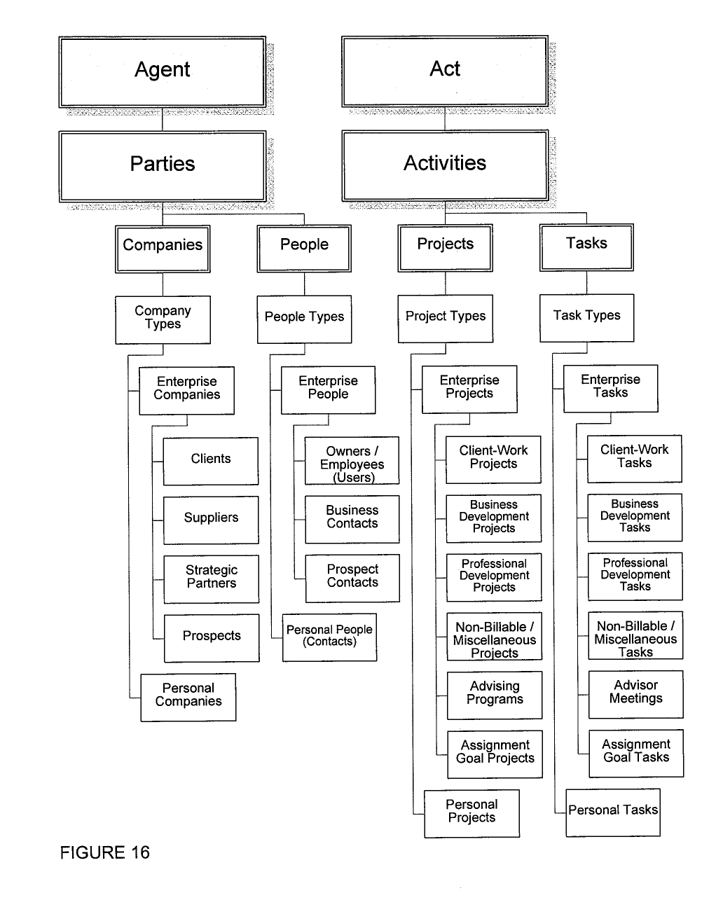

FIG. 16 shows a detailed view of the Parties section and Activities section of the diagram shown in FIG. 14.

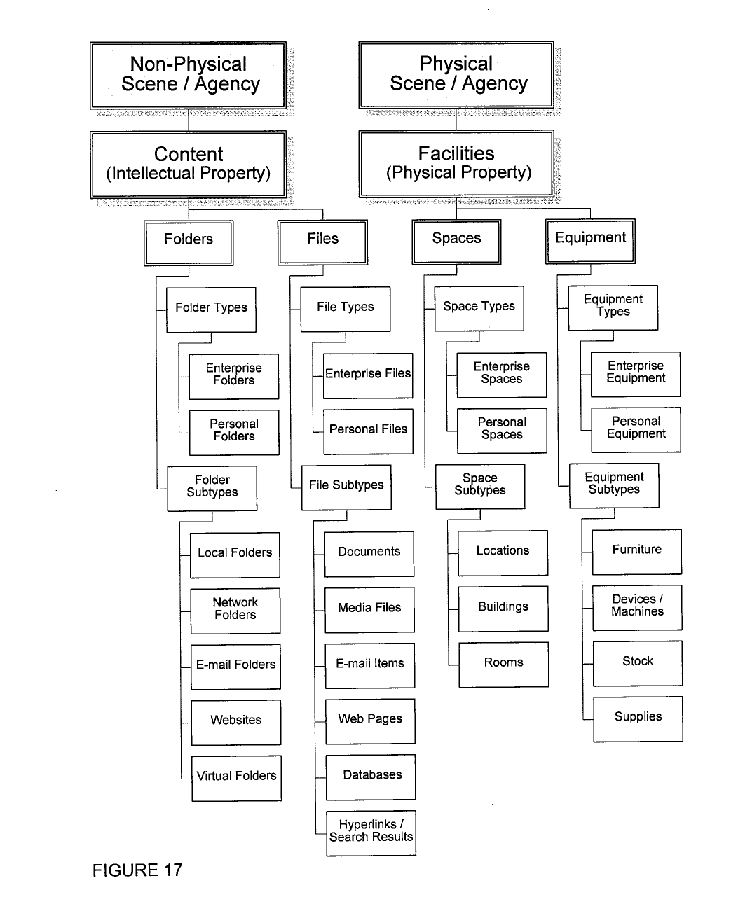

FIG. 17 shows a detail of the Content section and Facilities section of the diagram shown in FIG. 14.

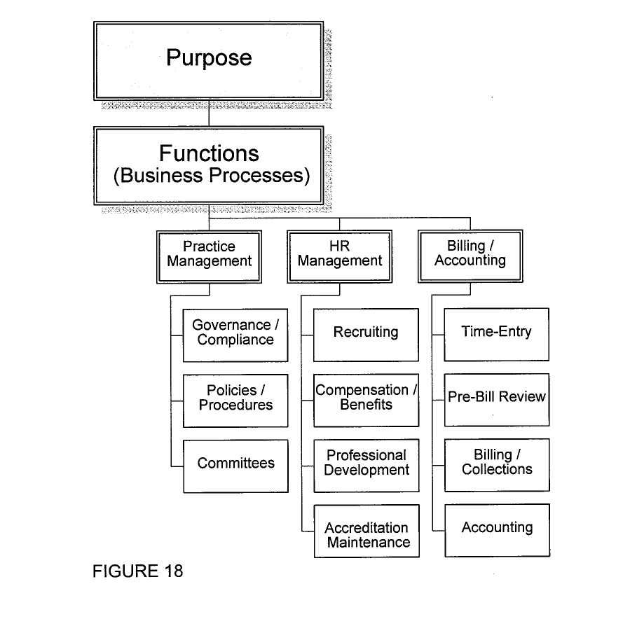

FIG. 18 shows a detailed view of the Functions section of the diagram shown in FIG. 14.

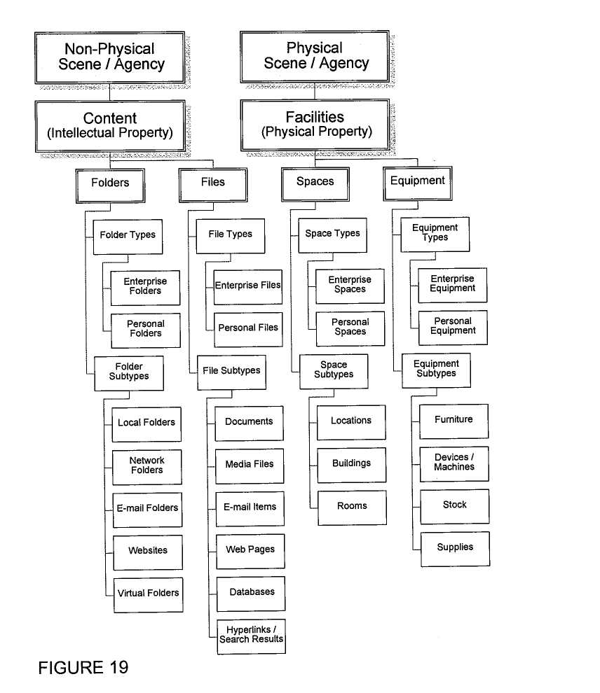

In a preferred implementation of the Tekton Data Model, the Content section will include E-mail folders and E-mail, as shown in FIG. 19.

In the fully-implemented system, the navigation structure of the organizer will be closely related to the structure of the conceptual data model, but they will not necessarily be identical, even among the higher levels of the structures. For instance, in an implementation based on the conceptual data model shown in FIG. 14-FIG. 18, the top levels of the navigation structure may include: Home (a summary panel with notifications & reminders), Companies, People, Projects, Tasks, Folders, Files, E-mail, Internet (Web-based resources), Facilities, Equipment, and Billing Data.

Each section will generally present the user with a set of lists, including lists of enterprise data, lists of personal-organizer data, and lists that cross-reference data from multiple levels/systems. In an implementation of the Tekton solution, each element of the Tekton Data Model may be associated with a number of other elements to produce useful views of cross-referenced data.

For instance, a Project Details form may present a view of project-related data that includes: a list of people working on the project; a list of tasks associated with the project; a list of folders & documents associated with the project; a list of e-mail items associated with the project; a list of search results with links to research services used for the project; a list of team meetings related to the project, including participants, locations, agendas, and links to related materials; a summary of to-date billing information related to the project.

Similarly, a Person Details form may present a view of data related to a selected individual that includes: a list of projects the person is currently working on; a list of projects the person has worked on in the past; a list of people the person has worked for and worked with; a list of tasks the person has performed; a list of professional development goals (assignment goals) the person has recorded; the person's availability for upcoming weeks and months; a list of documents related to the individual; a list of e-mail items received from the individual.

The Tekton Data Model may be extended and implemented in different ways to support different types of useful functionality. For instance, in an implementation for engineers, a project details form may include a list of material resources required for the project, as well as a list of potential suppliers and quotes for procuring such resources.

For each kind of information managed, the organizer will support Item Types. For instance, People may be divided into multiple types, including: Employees, Customer Contacts, Vendor Contacts, and Personal Contacts. Similarly, Projects may be divided into: Generic Projects, Client Projects, Internal Projects, and Personal Projects.

The use of Item Types: simplifies the user interface; streamlines external-record linking; supports enhanced interactions in project-based/knowledge-intensive environments; supports extensibility through API/SDK plug-in development; allows for the extension of system while preserving the consistency of user experience.

Note: In a desktop-client-application implementation, the Organizer Zone may include local and remote lists that are synchronized as with automatic e-mail retrieval features. That is, in order to support the sharing of data between zones, a desktop-client organizer may have its lists mirrored on a remote server that allows data to be viewed by other people, even if the individual client is disconnected from the network.

The Tekton Solution is realized through a collection of design elements-including data structures, processing functions, and GUI elements-that can be implemented using any suitable means. That is, the solution does not depend upon a specific method or specific technology platform for implementation. The system may be implemented and deployed in a variety of ways.

The following sections describe the implemented system in terms of applications, components, packages, module groups, modules, and classes.

The system consists of a number of integrated applications. A component is an encapsulated collection of design elements that work together to perform a collective service. A package is a collection of closely related design elements. A package is a descriptive device only-a purely conceptual entity that does not objectively manifest at runtime. In this document, the term module refers to a ‘section’ of the organizer from the perspective of the user-i.e. an ‘area’ of the organizer that manages a particular kind of information. The modules will generally fall into module groups according to the underlying top-level elements of the data model-i.e. the module groups will typically include Parties, Activities, Content, Facilities, and Functions, and may include additional groups. The organizer will generally have a module that corresponds to each major section of the implemented data model that is included in the top-level navigation structure. For example, the organizer will typically have modules for Companies, People, Projects, Tasks, Folders, Files, E-mail, etc. A class is a collection of runtime objects that share similar properties and behaviors. A class can also be a superclass that consists of a collection of subclasses, where the related subclasses are derived from the same superclass and share a common set of inherited properties and behaviors.

The system will typically include applications in the following categories: core applications, server applications, and enterprise applications.

The core applications will include the personal organizer, the enterprise server application, and the enterprise project manager application.

From the user's perspective, the organizer application is the central application of the system. The organizer application provides the personal organizer features of the system. The organizer application contains the lists of projects, tasks, documents, and other information that the user manages for personal organization. The organizer application also performs a number of user-initiated functions and automatic functions. The organizer application provides a variety of GUI elements that allow the user to manage the user's personal data in the system.

The enterprise server application will provide the basic infrastructural and data-sharing services, such as: providing system security features; collecting information from and delivering information to each instance of the organizer application; collecting information from and delivering information to internal and external enterprise applications; managing the sharing of data among users according to established user roles and relationships; and others.

The enterprise project manager application will provide features related to managing and collaborating with teams in project-based environments.

The server applications will provide specialized server-based functionality, including: e-mail services; other types of messaging services; mobile and web access to the system; and enterprise intranets and extranets; among others.

The enterprise applications will provide “native” alternatives to many commonly-used types of enterprise applications.

In addition to the applications, the system will include a set of “connector utilities” that will allow the system to communicate with external enterprise systems, external web services, and other external data sources. The system will also provide an application programming interface (API) and a corresponding software development kit (SDK) to enable software developers to extend the system and expand it by developing additional specialized applications.

The system may also include some or all of the following components.

The Updater Component manages lists of data that allow the user to create links from records in the personal organizer to corresponding records in other “remote” applications and/or systems. The Updater Component imports data from the remote data sources and maintains synchronization between the remote data sources and the user's personal organizer. The Updater Component also supports the automatic creation of personal organizer records to streamline the user experience.

The Updater Component is partially responsible for implementing the boundary between the ‘personalized zone’ of the personal organizer and the ‘centralized zone’ of enterprise systems and other shared services. In the personalized zone, objects are defined in terms of the individual user and are controlled by the individual user. In the centralized zone, objects are defined in terms of the enterprise as a whole and are controlled by the enterprise. The personalized zone is one of the most important and novel aspects of the Tekton Solution. The personalized zone gives the individual a personal workspace that is removed from-yet dynamically connected to-the centralized zone. In the personalized zone, the data structures, system functions, and GUI elements are designed around the individual; they allow the user to organize information as it relates to the user's own activities, and they allow the user to organize that information in whatever way is most convenient and useful for the individual user. The personalized zone accommodates personal information, and it allows the user to see personalized views of information from centralized systems.

The Categories Component manages centralized lists of categories that the user can attach to task records. Categories allow the user to track and report personal activities according to a set of standards that is shared with other users. Category lists can also support useful data-entry features in the form of pull-down menus that can supply text labels and centralized codes for management and billing purposes. The Categories Component is similar to the External Lists Component in that both components provide centralized lists of reference values for personal organizer records.

The Benchmarks Component allows a professional development coordinator to define a list of ‘benchmark activities’ and to provide the list to users for planning and tracking work activities in terms of career development. The Benchmarks Component allows the user to view a standard list of activities that relate to important professional skills and knowledge and to use the list for creating and sharing professional development goals. The Benchmarks Component also allows the user to view summary reports of the user's own accomplished activities in terms of the defined benchmarks.

The benchmark definitions can be related to category selections that are available for task records in the personal organizer. That is, when the user creates a task record in the personal organizer, the user can link the task record to a particular benchmark definition. From the perspective of the organizer application, the Benchmarks Component is an external, centralized provider of category records.

The Availability Component contains design elements that provide users with a simple, shorthand method for communicating upcoming availability. The Availability Component includes a graphical timeline that allows users to indicate availability for an upcoming time period by changing a corresponding icon accordingly. The icons use a stoplight metaphor to indicate the ability and/or willingness of the user to take on more work. The data communicated by the timeline is not programmatically calculated from other data in the system. Rather, the user directly sets the appearance of each icon on the timeline.

The Reports Component provides the ability to view and print reports of system data and to export sets of system data to useful files, such as tab-delimited text files and formatted spreadsheets.

The Notifications Component sends automatic e-mails and other reminders to users according to configurable rules and user preferences.

The Security Component manages user accounts, user roles, and related functions. The Security Component supports configurable rules for controlling user-role-based and user-relationship-based access to different selections of system data. The Security Component also contains functionality for allowing users from outside of the enterprise (i.e. clients and business partners) to access controlled views of system data.

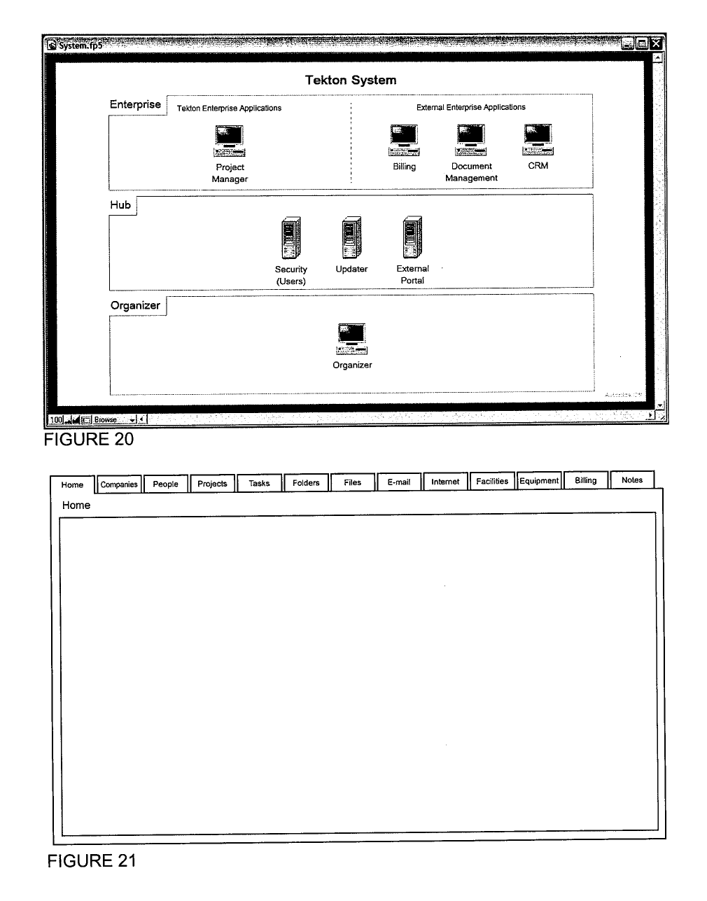

FIG. 20 illustrates an example of one possible deployment of one possible implementation of the system. In FIG. 20, the “core” server-based applications are collectively referred to as the Hub layer. In the example deployment illustrated in FIG. 20, the components of the Enterprise layer communicate and bi-directionally synchronize with the Organizer by means of components included in the Hub layers.

The Organizer Application

The user interface of the organizer application will include a tab-based navigation scheme for allowing the user to navigate among the modules of the application. FIG. 21 illustrates the tab-based navigation scheme for a typical configuration of the organizer.

Each module will generally present its data using one or more display panels. Panel types will include an options panel, a list panel, and a details panel. The options panel generally accompanies a list panel and provides options for viewing lists of information, such as: selecting among different item types that may be configured for the selected module; selecting among different lists that may be available for the selected item type (available lists often include a list of organizer records and a list of remote records); selecting the preferred layout for showing the selected list; and for selecting which records to display from the selected list by applying various filters. The options panel is also sometimes used to select formatting options for displaying the list items. The list panel displays a selected list of information from the selected module. The details panel usually displays the details of a selected record. In some cases, the details panel might instead display all or part of a document, an e-mail item, a media file, a web page, or other content.

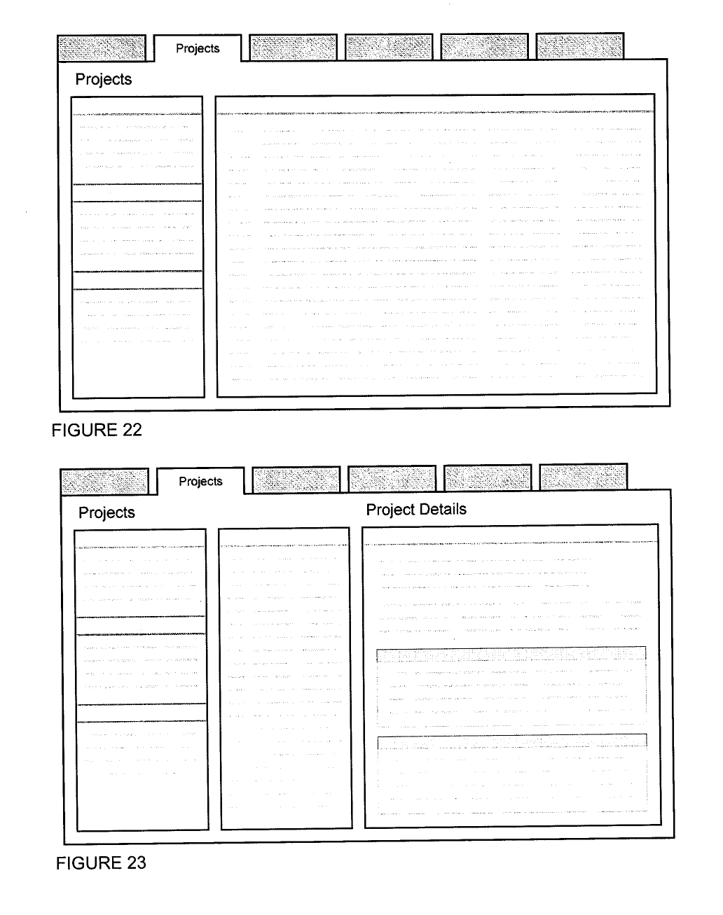

FIG. 22 illustrates the appearance of the Projects tab when the user is browsing a list of projects. The left-side panel is the options panel. The right-side panel is the list panel.

When the user selects an item in the list panel, the details panel appears and displays detailed information about the selected item, as illustrated in FIG. 23. The right-side panel is the details panel. The list panel has become narrower and is now in the middle. Depending upon the configuration of the system and the type of record selected, the user may be able to edit the record directly in the details panel, or the user may be required to open the record in a separate record-editing window to edit a given record.

Display panels will, where appropriate and useful, allow the user to perform one or more of the following actions: resize a panel; collapse/expand a panel; move a panel; “dock” a panel; change the layout of a panel; change the behavior of a panel; change the appearance of a panel.

In addition to standard table-and-text views of module data, the user will sometimes be able to view a list and/or a record detail in a “graphical” or “visual” way, such as in a “tree-view”. The graphical tree-view will show the relationships between related records in a hierarchical fashion, showing related records grouped in ‘folders’ that may be expanded or collapsed. The graphical view will provide contextual menus allowing the user to manage the data visually. The graphical view will also support dragging-and-dropping to: create links between record types that support linking; and merging and/or nesting of records of the same type. When an item is dropped on another item of the same type, and when the type supports such functionality, a dialog box or “wizard” may appear, asking the user whether the user would like to merge the items or nest the items or cancel the operation.

The organizer's user interface will provide a variety of features for creating and managing record-links (i.e. for establishing and modifying relationships between records).

Record-links may be created and/or modified directly by a user. Record-links may also be created and/or modified automatically in response to events elsewhere in the system. When a record-link is created and/or modified automatically, the system may notify the user of the change and may ask the user to approve the change before the change becomes active and/or fully-committed.

When linking a personal-organizer record to an enterprise record (or accepting such a link), the user may be provided with the opportunity to check a box labeled ‘Update This Record Automatically’ to allow automatic synchronization of organizer records and remote records without notifying the user or without requiring user acceptance of the changes. Also, the user may be provided with an interface element (e.g. a list of checkboxes) that allows the user to select: which, if any, record fields are updated automatically; which, if any, record fields are updated only with the user's confirmation (e.g. by clicking ‘Apply changes’ in a pop-up dialog box); how the system should notify the user of changes that have been made or changes that are currently pending.

The organizer's link-management features include the ability to create a linked record in one module from “within” a record of another module when the two kinds of records support record-linking. Examples include: navigating to a project record in the Projects module and clicking a button to create an automatically-linked task record in the Tasks module; navigating to a project record in the Projects module and clicking a button to create an automatically-linked document of a user-specifiable type and location in the Files module; navigating to a company record in the Companies module and clicking a button to create an automatically-linked contact record in the People module. In some cases, the user may be able to use such features to create related records in remote systems as well as in other organizer modules.

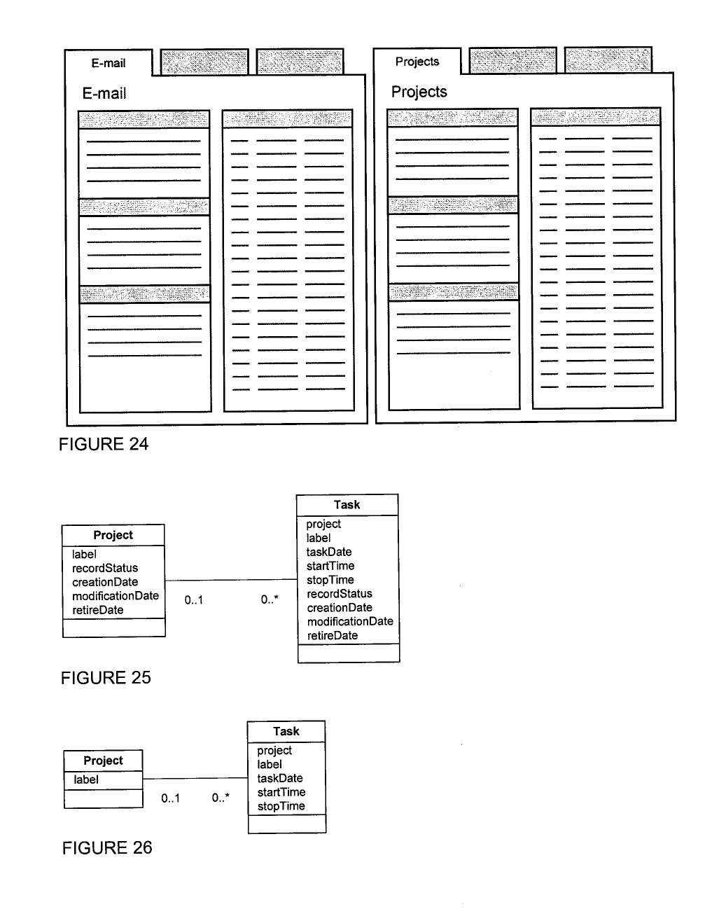

The organizer's user interface will sometimes present a split view, as illustrated in FIG. 24.

In a ‘split view’, the main area of the organizer's graphical interface is divided into two or more regions. Split views are generally used to view different types of information side-by-side, i.e. from different sources, lists, or modules. Split views are also generally used to view and manage links between organizer items.

Possible methods for opening a split view include: the user clicking a special place/button on a navigation tab; the user holding down a key or key-combination while clicking at tab; the user right-clicking a tab and selecting “Open in split view” from a contextual menu; the user dragging a tab to one side of the window; the user selecting a Split View option from a standard menu. Also, a split view may open automatically in response to certain user actions and/or system events. When a split view is open, the user can close the split view in one or more ways.

Split views allow a user to: see more than one list and/or record-detail at a time; and create record-links using a drag-and-drop method. In a split view, each side may contain a ‘full display layout’ or just one part of that layout, such as only the list panel. If only the list is displayed in a section of a split view, the list may automatically display according to the last options selected in the Options Panel for that list. Also, the options panel may offer an expand/collapse feature.

In general, the user will be able to create record-links using a drag-and-drop method in which one visual object is moved over another and released onto it. The moved item may be the entire visual object itself, or the user interface may provide visual “anchors” or “connection points” for pulling a connector (a visual line) from one visual object to another.

Where appropriate and useful, a drag-and-drop method can also be used to combine records (typically of the same kind) together. For instance, a user may wish to combine two projects together; dragging-and-dropping one project onto another project may cause a dialog box to open asking the user if the user wishes to combine the two records. If the user clicks “OK”, the organizer may merge the project records together by adding the details of one record (including references to scheduled tasks and related documents) to the other record. The system may prompt the user for additional instructions for how to merge the existing data. For instance, a “Merge records” “wizard” might appear, providing a series of options regarding the merging procedure. In addition to the drag-and-drop method of merging records, the system may provide other user interface features for merging records. Also, similar record-merging features may be available in other applications in the system. Merging records may in some cases result in the triggering of events elsewhere in the system (i.e. outside of the application where the record-merge is initiated and performed).

The organizer may provide features that allow a single record to be divided into multiple records of the same kind. For instance, a user may wish to divide a single project into two or more projects. Various interface features may be provided for dividing records, such as standard menu items and contextual menu items. The system may display dialog boxes and/or “wizards” that allow the user to provide specific instructions for performing the division of the record. For example, a “Divide record” “wizard” might enable the user to specify how references to related tasks and documents should be allocated (or perhaps duplicated) among the resulting records. Dividing a record may produce independent records, linked records, or nested records. Similar record-dividing features may be available in other applications in the system. Dividing records may in some cases result in the triggering of events elsewhere in the system (i.e. outside of the application where the record-division is initiated and performed).

The organizer's user interface may include a navigation map-a small panel or window that can be opened and closed that presents a grid of icons (buttons) that allow the user to navigate directly to a selected module, list, layout, and/or record. The user may be able to modify the contents and/or appearance of the navigation map. The navigation map provides the user with a quick and easy method of navigating through the interface.

The organizer's user interface may include a navigation history list showing the user's history of navigating through the organizer. The list provides the user with a convenient method for returning to recently-viewed lists, records, files, and other locations and items.

The organizer's user interface may include a modification history list that allows a user to review the history of changes that have been made to his or her data and to undo those changes when possible. The modification history panel shows a list of the changed items, the date and time when the changes were made, the type of change that was made for each item, the start and end values for each change, the name of the person who made the change, and whether or not the change is reversible. If the change is indeed reversible, a button allows the user to undo the corresponding change. The list can be sorted by date or by record. The modification history panel makes it easy to undo changes that might be difficult to find or to undo otherwise. For instance, a user may accidentally retire a project or task that should have been left active. Likewise, when retiring a task, a user may click the wrong button and indicate that a benchmark activity or an advisor meeting was not completed, when in fact the activity was completed. Without a chronological listing of modification events, undoing such mistakes could be very difficult-even finding the corresponding records might be impossible for many users. The modification history panel provides an intuitive and accommodating tool for making such corrections.

The organizer's user interface includes graphical date and time “choosers” for inputting date and time information where appropriate. The date and time choosers can be configured to suit the work procedures and personal preferences of the user. For instance, some law firms bill their clients in six minute increments, while other firms use intervals of other lengths. The time-chooser can be configured to function accordingly.

The system may include the ability for users to edit pull-down menus that can serve as shortcuts for entering text information. For example, pull-down text snippets for task labels & billing narratives could save time and increase accuracy for users when entering text information.

The organizer application will typically include the following module groups: an Overview module group, an Activities module group, a Parties module group, a Content module group (a.k.a. Non-Physical Assets module group), a Facilities module group (a.k.a. Physical Assets module group), and a Business Functions module group.

The Activities module group will typically include two modules: a Projects module and a Tasks module (a.k.a. Activities module). The Parties module group will typically consist of at least two modules: a Companies module and a People module. The Parties module group may also contain a Groups module that supports the grouping of People records into user-defined groups. The Content module group will typically consist of a Folders module, a Files module, an E-mail module, a Web-Resources module (a.k.a. Internet module). The Content module group may also contain additional modules, such as a Notes module, a Lists module, and other modules. The Facilities module group may include various modules for managing information about physical assets. The Business Functions module group (a.k.a. Functions module group) may contain a variety of modules depending upon the work environment and user needs.

The Overview Module Group

The Overview module group will provide a “Home” page which will show a summary of organizer data, provide important notifications and reminders, and provide access to application setup options. The Overview module group may also include additional modules.

The Activities Module Group

The Activities module group of the organizer application includes design elements that allow the user to organize the user's activities in terms of projects and tasks.

In the following description, the word task is used in a broad sense to describe any specific action or occurrence that a user may choose to associate with a particular date and/or time. Task records are used to keep track of what-in a more general sense-may be regarded as tasks, events, and goals. In the organizer application, tasks, events and goals are managed on a single list and are collectively called either ‘tasks’ or ‘activities’ for the sake of simplicity. Because tasks in the organizer can be either dated or undated, the Tasks List can serve as a calendar, as a ‘to-do list’, and as a list of goals. In the organizer application, projects are used to describe a group of tasks. Project records are given labels and are used to group task records together.

For the sake of clarity in the following descriptions, features are described in terms of numbered groups of design elements. The groups of design elements are broadly ordered from the simpler and more basic to the more complex and specialized. It should not be assumed, however, that any given design element necessarily depends upon another design element; the order in which the design elements are introduced and discussed does not necessarily indicate systemic dependencies.

Also, the following sections may differ from earlier section in their descriptions and illustrations of the organizer's user interface. Any apparent conflicts should merely be interpreted as representing different valid configurations of the user interface and related elements for the same application.

Group 1 design elements allow the user to define projects and tasks, to group tasks together by project, and to work with useful views of this data for the sake of personal planning and organization. Group 1 design elements include: a Project class and a Task class; the basic attributes of the Project and Task classes; the association between the Project and Task classes.

FIG. 25 presents a UML-style class diagram showing the static structure of the Group 1 design elements.

For the sake of clarity, the Group 1 elements are described in two subgroups-Group 1a and Group 1b.

Group 1a design elements support the management of activity labels, activity dates, and activity times. Group 1a design elements include: two classes, the Project class and the Task class; one attribute of the Project class, label; four attributes of the Task class, label, date, startTime, stopTime; the association between the Project and Task classes.

FIG. 26 presents a UML-style class diagram showing the static structure of the Group 1a design elements. FIG. 26 indicates that: a project may be given a label (a text label; a name or description); a task may be given a label, a date, a start time, and a stop time; a project may be associated with no tasks or with any number of tasks; a task may be associated with no project or with one project.

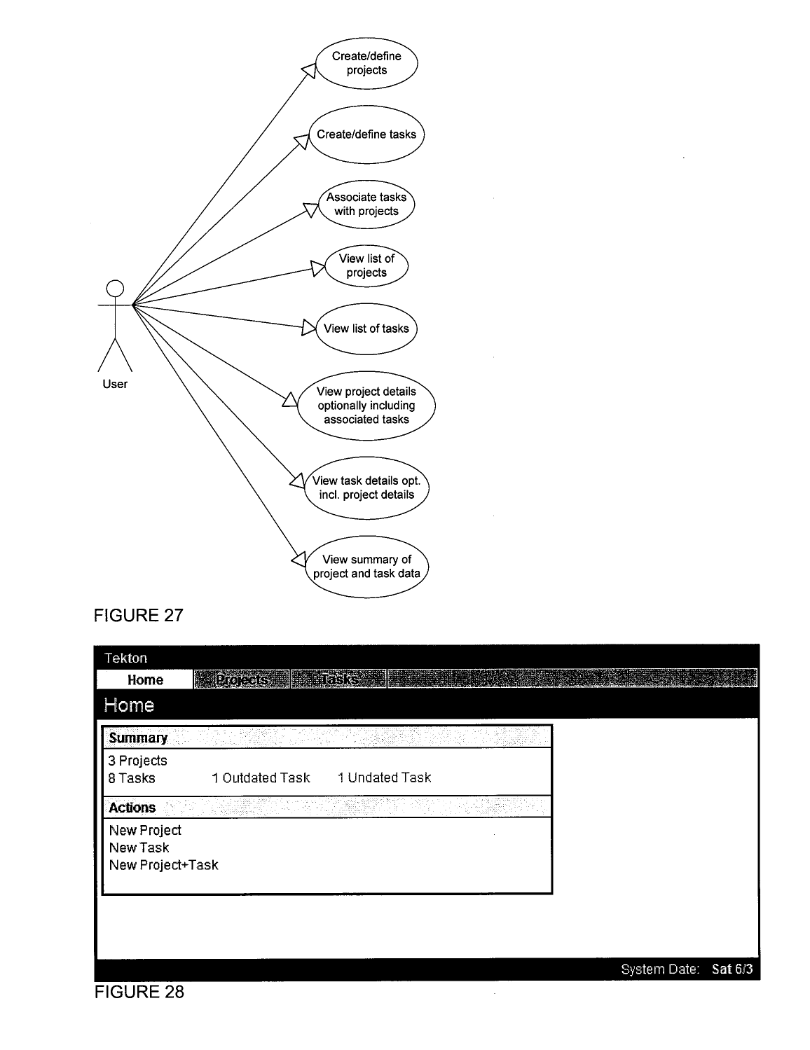

FIG. 27 presents a UML-style use case diagram showing the use cases supported by the Group 1a design elements.

The graphical user interface (GUI) elements associated with Group 1a design elements include: a Summary Panel; a Projects List; a Tasks List; a Project Details Form; a Task Details Form.

FIG. 28 shows a design for a Summary Panel based on Group 1 design elements. The Summary Panel indicates how many projects and how many tasks the user has defined in the system. In the illustration given, the user has three projects and eight tasks in the system. The Summary Panel also alerts the user to issues that might require the user's attention. In the illustration given, the user has one task that is outdated (i.e. past-dated or overdue relative to the system date) and one task that is undated. The user can click on any of the text displayed in the upper part of the panel (‘3 Projects’, ‘8 Tasks’, ‘1 Outdated Task’, or ‘1 Undated Task’) to see the associated list of items. For instance, if the user clicks ‘3 Projects’, the user will see the entire Projects List. If the user clicks ‘1 Outdated Task’, the user will see the Tasks List, and the list will automatically be filtered to show the only the associated task. The bottom part of the Summary Panel presents the user with ‘action’ options—i.e. options for creating new projects and tasks. If the user clicks ‘New Project’, the system will create a new project record and present the user with the Project Details Form. If the user clicks ‘New Task’, the system will create a new task record and present the user with the Task Details Form. If the user clicks ‘New Project+Task’, the system will: create both a new project record and a new task record; automatically establish a relationship between the new records (i.e. designate the new task as belonging to the new project); and present the user with the Task Details Form. The task details form will be automatically ‘extended’ to include showing the project details section. The last option (‘New Project+Task’) is one of the record-link management features of the organizer.

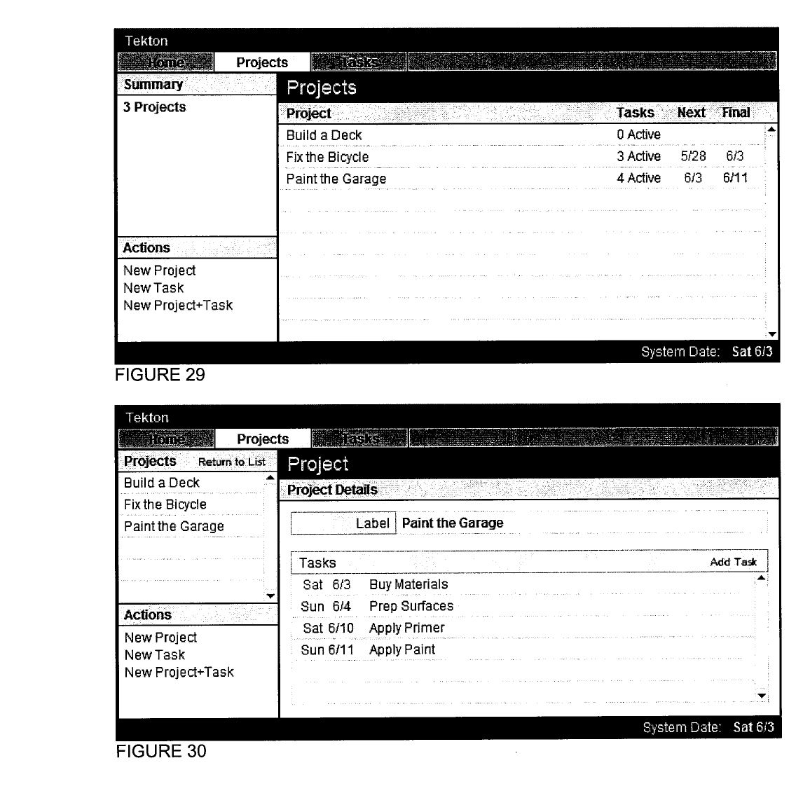

FIG. 29 shows a design for a Projects List based on Group 1 data elements. The Projects List displays a list of the projects that the user has defined in the system. The Projects List GUI element is divided vertically into two sections: the list panel presents the list itself, and on the left, there is a narrower options panel that performs a number of functions.

In the example given for the Projects List in FIG. 29, each line in the list shows the label of the project and a summary of the tasks associated with that project. The summary columns indicate: the number of tasks associated with each project; the earliest task-date associated with each project; the final task-date associated with each project; whether there are any undated tasks associated with each project. (In FIG. 29, the ‘Final’ date in the second line is conditionally formatted as purple text to indicate that-although ‘6/3’ is the final task-date associated with the project-there is at least one undated task associated with the project, as well; hence, the final date shown is understood to be provisional, since the currently-undated task may very well be given an even later date.)

In the Projects List, if the user clicks on the label of any project, the system will display the details of that project in the Project Details Form.

FIG. 29 shows a design for the options panel based on Group 1 design elements. The options panel is divided into two parts. The top part provides a summary of the data shown in the list, and the bottom part provides a list of actions that the user can perform.

FIG. 30 shows a design for a Project Details Form based on Group 1 design elements. The Project Details Form allows the user to manage the details associated with a single project record. The form also allows the user to perform additional functions related to the Projects List.

As shown in FIG. 30, the main panel of the Project Details Form: displays the details of an individual project record; allows the user to edit the details of the project record; displays a list of the tasks that are related to the project; allows the user to create additional related tasks for the project; allows the user to navigate to the related tasks. The main panel is presented in two sections. The top section displays the label of the project. The user can click on the label display to edit the project label. The bottom section of the main panel displays a list of the tasks that are related to the project. At the top of the list, the user can click ‘Add Task’ to create a new task that will automatically be related to the project. For each task in the list, the user can click the task date to change the date of the task (using a date-chooser popup element). If the user clicks the label for any task, the system will display the details for that task in the Task Details Form.

In general, when a record details panel displays inset lists of related records (e.g. in the way that the example project details panel illustrated in FIG. 30 displays a list of tasks related to the selected project), the graphical interface may provide a feature whereby the user can collapse or expand the inset list. Such a feature could be provided in the form of a button on the title bar of the list that the user can click to toggle between the expanded and collapsed modes of the list display.

As shown in FIG. 30, the options panel of the Project Details Form: allows the user to click through a list of projects to review the details for each project without leaving the form; provides options for creating new projects and tasks.

As illustrated in FIG. 30, the options panel is divided into two sections. The top section displays a list of projects in a narrowed version of the main panel of the Projects List display. The user can click the label of any project in the list to see the details of that project displayed in the main panel. If the user clicks ‘Return to List’, the system will present the Projects List display. The bottom section of the options panel provides three options. The user can create a new project, the user can create a new task, or the user can create a new related pair, consisting of a new project and a new associated task.

In the organizer application, the Tasks List is the primary personal organizer GUI element for scheduling activities. The Tasks List allows the user to view and manage a list of tasks and events. The Tasks List has two basic views: a list view and a graphical calendar view.

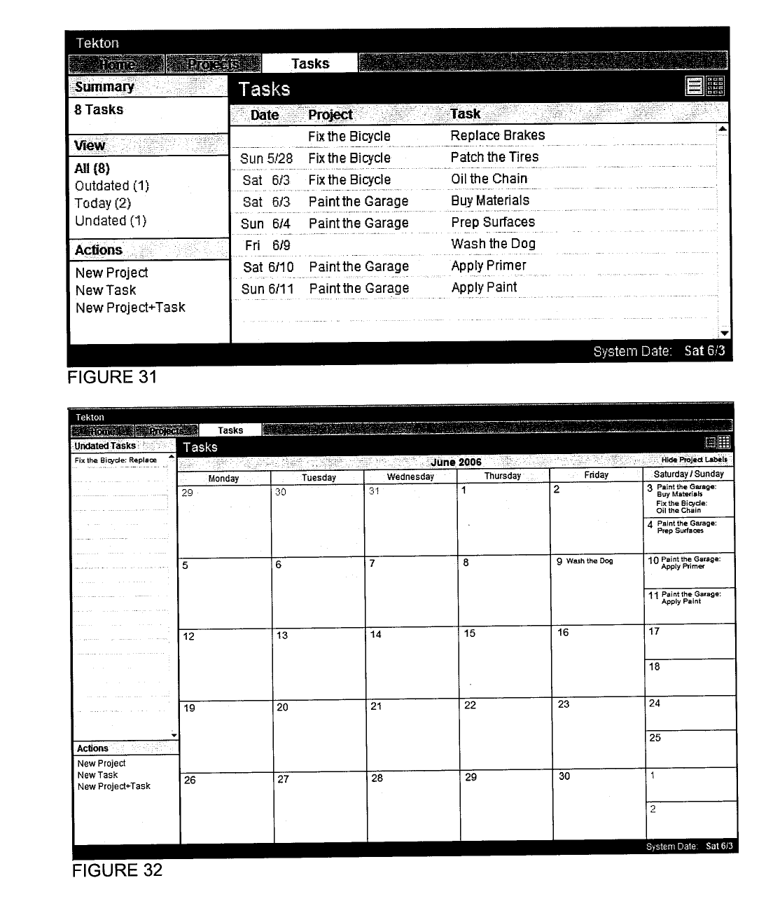

FIG. 31 shows a design for the list view of the Tasks List based on Group 1a design elements. The list view of the Tasks List is divided into a main panel and an options panel.

As shown in FIG. 31, the main panel of the list view displays a list of tasks. The list shows three columns of data: date (the date of the task); project (the label of the project); task (the label of the task). The user can sort the list by any column by clicking the column header. Empty values sort to the top of the list (assuming an ascending sort order). Thus, when the list is sorted by date, any undated tasks sort to the top of the list. When the list is sorted by project, any freestanding tasks-that is, any tasks without associated projects-sort to the top of the list. The user can click on the date field for any task to change the date for that task. When the user clicks on a date, the system presents a date-chooser popup GUI element for easy data entry. If the user clicks on the label for any project, the system will present the details of that project in the Project Details Form. If the user clicks on the label for any task, the system will present the details of that task in the Task Details Form.

As shown in FIG. 31, the options panel of the list view of the Tasks List is divided into three sections. The top section provides a summary of the data displayed on the list-in this case, ‘8 Tasks’. The middle section provides viewing options pertaining to task date values. The use can click ‘All’ to see all tasks on the list. The user can click ‘Outdated’ to filter the list to show only tasks that have task dates earlier than the current system date. The user can click ‘Today’ to filter the list to show only tasks with task dates equal to the current system date. The user can click ‘Undated’ to filter the list to show only tasks with null task date values. The bottom section of the options panel provides options for creating new records.

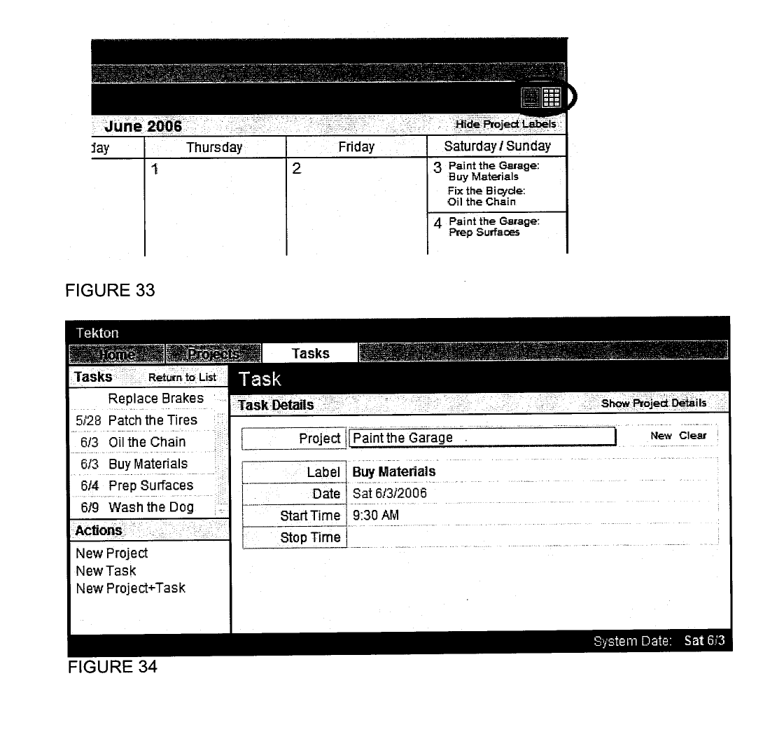

FIG. 32 shows a design for the graphical calendar view of the Tasks List based on Group 1a design elements. As shown in FIG. 32, the graphical calendar view of the Tasks List is divided into a main panel and an options panel. The user accesses the graphical calendar display by clicking a view-selection button in the top-right corner of the main panel of the Tasks List display. The view-selection button is highlighted in FIG. 33. In the area circled in FIG. 33, there are two buttons next to each other. The button on the left, which contains a set of horizontal lines, is used to access the list-style view of the Tasks List. The button on the right, which contains a grid pattern, is used to access the graphical calendar view.

The calendar view can be set to display either: (a) project and task labels together, or (b) only task labels. In FIG. 33, the calendar is showing project and task labels together (e.g. ‘Paint the Garage: Buy Materials’). Below the view-selection button (which is circled in FIG. 33), there is a button labeled ‘Hide Project Labels’. The user can click ‘Hide Project Labels’ to switch the display to show only task labels. The button will then toggle to read ‘Show Project Labels’. The user can then click ‘Show Project Labels’ to switch the display to show project and task labels together. If the user clicks a project label, the details for that project will appear in the Project Details Form. If the user clicks a task label, the details for that task will appear in the Task Details Form. If the user clicks on the day number of a date square or in the empty part of a date square, the system will: create a new task record; enter the date that was clicked as the task date for the new record; display the new task record in the Task Details Form. The user can click-and-drag a task from one date to another to change the task date.

As shown in FIG. 32, the options panel of the graphical calendar view is divided into a top section and a bottom section. The top section of the options panel, labeled ‘Undated Tasks’, displays a list of the undated tasks. As elsewhere, the user can click on a project label or a task label to see the details for that record displayed in the corresponding details form. The user can click on a blank line to create a new undated task. The user can click-and-drag a task from the Undated Tasks list to a date square in the main panel to set the task date for that record to the corresponding date. Likewise, the user can click-and-drag a task from a date square in the main panel to the Undated Tasks list to clear the task date for that record. The bottom section of the options panel, labeled ‘Actions’, provides options for creating new project and task records.

FIG. 34 shows a design for a Task Details Form based on Group 1a design elements. The Task Details Form allows the user to manage the details associated with a single task record. The form also allows the user to perform additional functions related to the Tasks List.

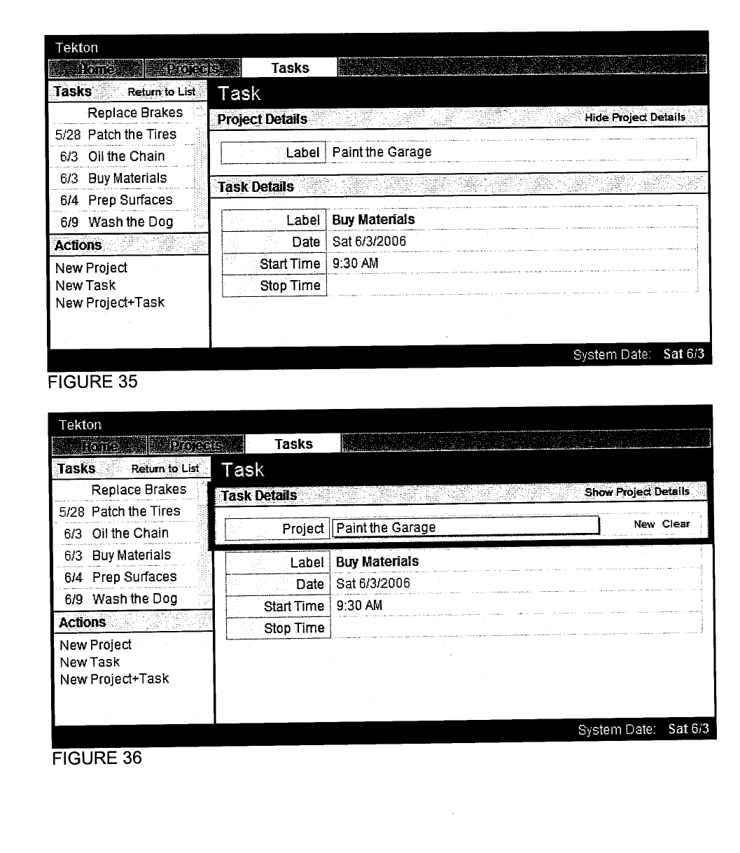

FIG. 35 shows a design for an alternate view of the Task Details Form based on Group 1a design elements. The alternate view of the Task Details Form is produced by expanding the form to include the details of the related project record, if there is one. In the base state of the illustrated design, the Task Details Form allows the user to create or modify a relationship between the selected task record and a project record. In its alternate state, the Task Details Form allows the user to edit the details associated with the related project record, as well as the details associated with the selected task record. That is, the alternate state of the form allows the user to edit the details of the task record and the details of the related project record in one place. The main panel is presented in two sections-a top section and a bottom section. The top section of the main panel changes when the form switches from its base state to its alternate state. The bottom section does not change.

As highlighted in FIG. 36, the top section of the main panel of the base state of the Task Details Form: displays the label of the related project, if there is one; allows the user to manage the association between the task and a project; allows the user to switch to the alternate state of the form to edit the details of the related project, if there is one. In the base state, the top section displays the label of the related project, if there is one. The user can click on the project-label field to select a project from a pull-down menu. The pull-down menu displays all available projects. Selecting a project establishes a relationship between the task and the selected project. That is, selecting a project from the pull-down menu makes the task a part of that project. In its base state, the top section of the main panel also provides a ‘New’ button and a ‘Clear’ button. If the user clicks ‘New’, the system creates a new project, establishes a relationship between the task and the new project, and switches to the alternate view of the Task Details Form, to allow the user to enter a label (and, later, other details) for the new project. If the user clicks ‘Clear’, the system destroys the relationship between the task and its related project by deleting the reference from the task record to the project record. The project-label field becomes blank, and the task becomes freestanding (i.e. unrelated to any project). In its base state, the top section of the main panel also provides a ‘Show Project Details’ button, if a related project has been selected. If the user clicks ‘Show Project Details’, the Task Details Form switches to its alternate state, expanding the top section to include the details of the related project.

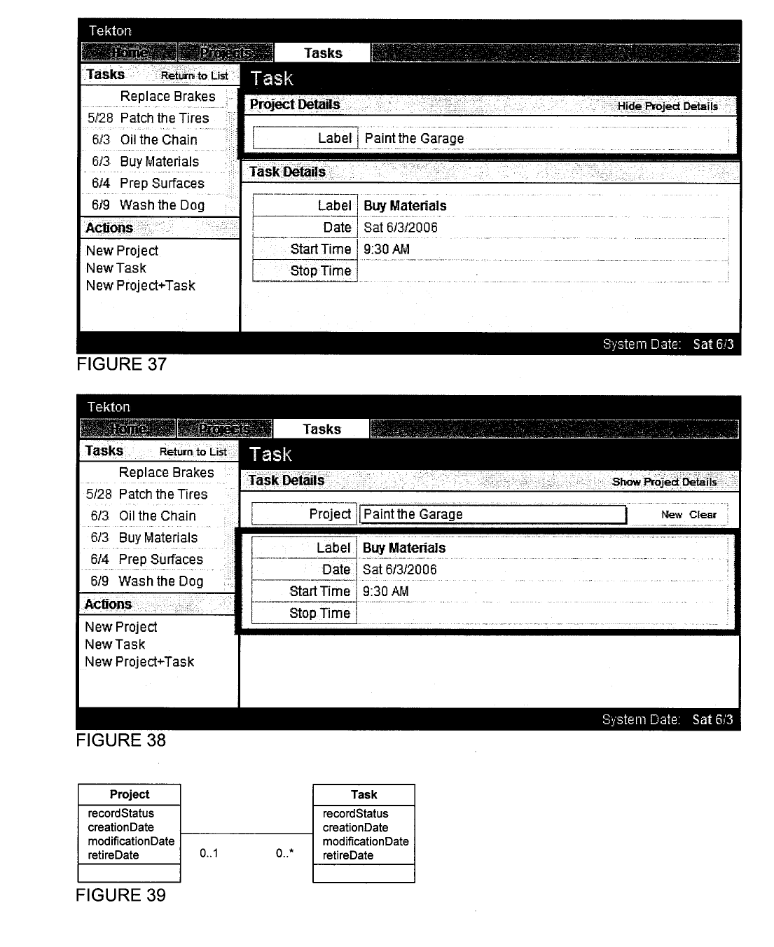

As highlighted in FIG. 37, the top section of the main panel of the alternate state of the Task Details Form: displays all of the details of the related project record, if there is one; allows the user to edit the details of the related project record; allows the user to revert to the base state of the Task Details Form. In its alternate state, the top section displays the details of the related project record. (Here, that only includes the project label. At this point in the solution description (i.e. given only the Group 1a design elements) the Project class has only one attribute and therefore the project record has only one value to display-the project label. Because of this, the base state and the alternate state appear very similar. However, as the model expands and the Project class acquires more attributes, the top section will show more details in its alternate state.) The user can click the project-label field to edit the project label. In its alternate state, the top section of the main panel also provides a ‘Hide Project Details’ button. If the user clicks ‘Hide Project Details’, the Task Details Form reverts to it base state.

As highlighted in FIG. 38, the bottom section of the main panel of the Task Details Form: displays the details of the selected task record; allows the user to edit the details of the selected task record. The user can click any of the four data fields to edit the associated value. Clicking the date field will cause a date-chooser popup element to appear. Clicking either of the time fields will cause a time-chooser popup element to appear. The options panel of the Task Details Form is divided into two sections. The top section displays a list of tasks as set up in the Tasks List. The user can click a task in the list to view the details of that task record in the main panel. The bottom section provides options for creating new records.

Group 1b design elements relate to the management of record status values and record-history dates. Group 1b design elements include four attributes for the Project class and four attributes for the Task class. In each case, the attributes are: recordStatus; creationDate; modificationDate; retireDate.

FIG. 39 presents a UML-style class diagram showing the static structure of the Group 1b design elements. FIG. 39 indicates that project records and task records have status values.

Note: The recordStatus value refers to the record itself, not to the ‘status’ of the project or task in the real world or to the ‘status’ of the user's involvement with the real-world project or task.

Note: recordStatus values for projects and tasks include ‘Pending’, ‘Active’, and ‘Retired’ values, and potentially other values, as well. For use cases related specifically to Group 1 design elements, the values include ‘Active’ and ‘Retired’, and the initial value for each record is ‘Active’.

The record-history attributes allow projects and tasks carry information about: when they were created; when they were modified; when they were retired.

Note: Modification dates may be tracked in a separate modifications table that tracks user modifications. For that purpose, the system may include a Modification class and a dedicated modification-tracking component. The ‘modificationDate’ attribute is used in this description to describe the function generally. Regarded as a single value, the modificationDate indicates the last date on which the record was edited. Likewise, the retireDate value indicates the last date on which the record was retired, in the event that a record is retired more than once (having been reactivated).

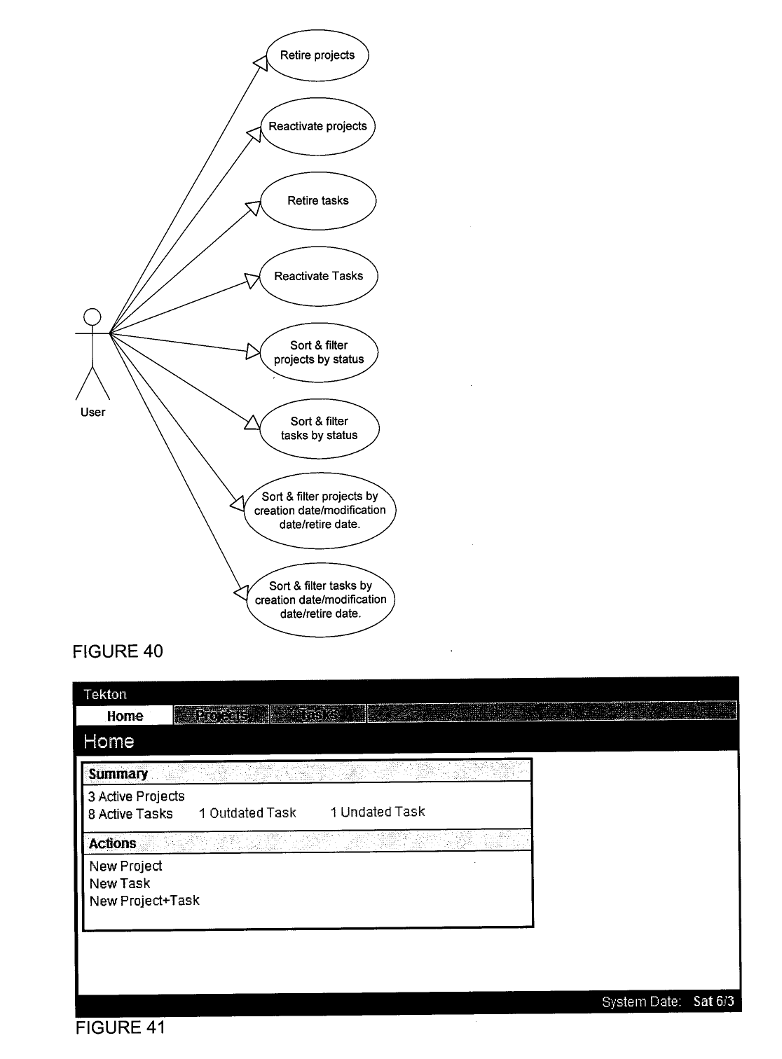

As indicated in FIG. 40, the Group 1b design elements support a number of specific use cases.

FIG. 41 shows a design for the Summary Panel based on the inclusion of Group 1b design elements. With the inclusion of Group 1b design elements, projects and tasks are given status values of either ‘Active’ or ‘Retired’. The Summary Panel indicates the number of active projects and tasks in the system (rather than the overall total numbers). If the user clicks ‘3 Active Projects’, the system will display the Projects List filtered to show only currently-active project records. If the user clicks ‘8 Active Tasks’, the system will display the Tasks List filtered to show only currently-active task records.

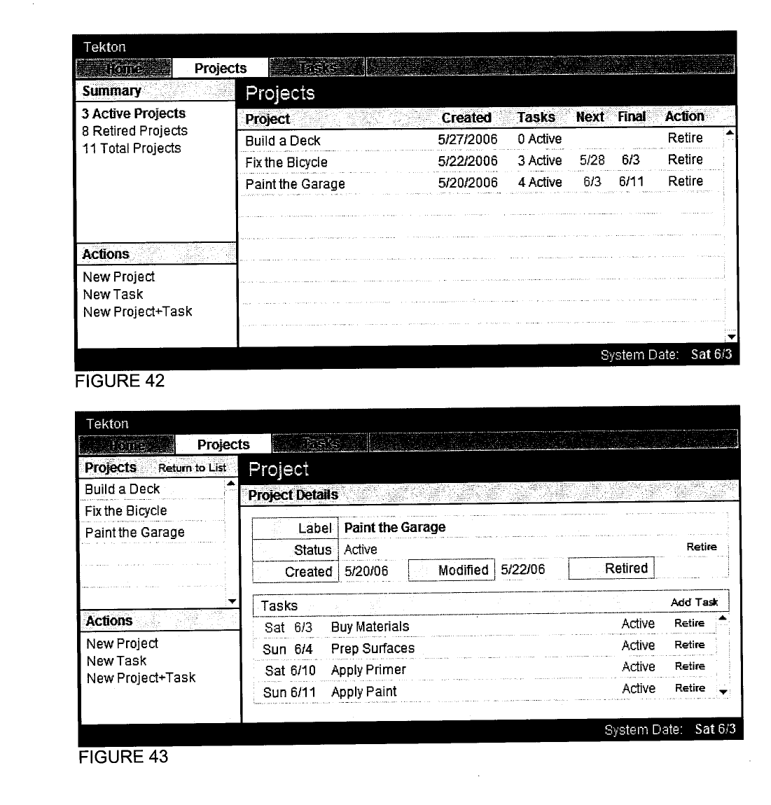

FIG. 42 shows a design for the Projects List based on the inclusion of Group 1b design elements. The list of projects now includes a column showing the creation date of each project. The user can click on the ‘Created’ column-header to sort projects by creation date. Likewise, the list may include a column showing the modification date and/or a column showing the retire date. Those columns will also be selectable for sorting. The list may also include a column showing the status of each project-especially when the list displays a combination of active and retired records. By default, the Projects List will show only active projects. The ‘Tasks’ column can now indicate how many remaining active tasks are associated with each project, rather than only the total number of tasks. The Projects List also now includes an ‘Action’ column. The Action column provides options for managing the status of the listed projects. When a project is active, the Action column will display a ‘Retire’ option. The user can click ‘Retire’ to retire a project.

The ‘retire procedure’ is an important feature of the Tekton solution, and it provides a context for extending the solution. The retire procedure can be configured in many ways. Please see ‘The Retire Procedure’ in the ‘Procedures’ section for an overview of the retire procedure and the ways that it may be extended. When the status of a project is ‘Retired’, the Action column may provide a ‘Reactivate’ option.

As shown in FIG. 42, the options panel of the Projects List now includes three lines in the Summary section. The lines indicate: the number of active projects in the system (‘3 Active Projects’); the number of retired projects in the system (‘8 Retired Projects’); the total number of projects in the system (‘11 Total Projects’). The user can click on any of the three lines to see the Projects List filtered accordingly.

FIG. 43 shows a design for the Project Details Form based on the inclusion of Group 1b design elements. The main panel of the Project Details Form now indicates the status of the selected project record. The form provides a ‘Retire’ button that the user can click to initiate the retire procedure for the selected project. The form also now indicates the creation date, the modification date, and the retire date of the selected project record. In the bottom section of the form, the list of associated tasks indicates the status of each task and provides a ‘Retire’ button for each task.

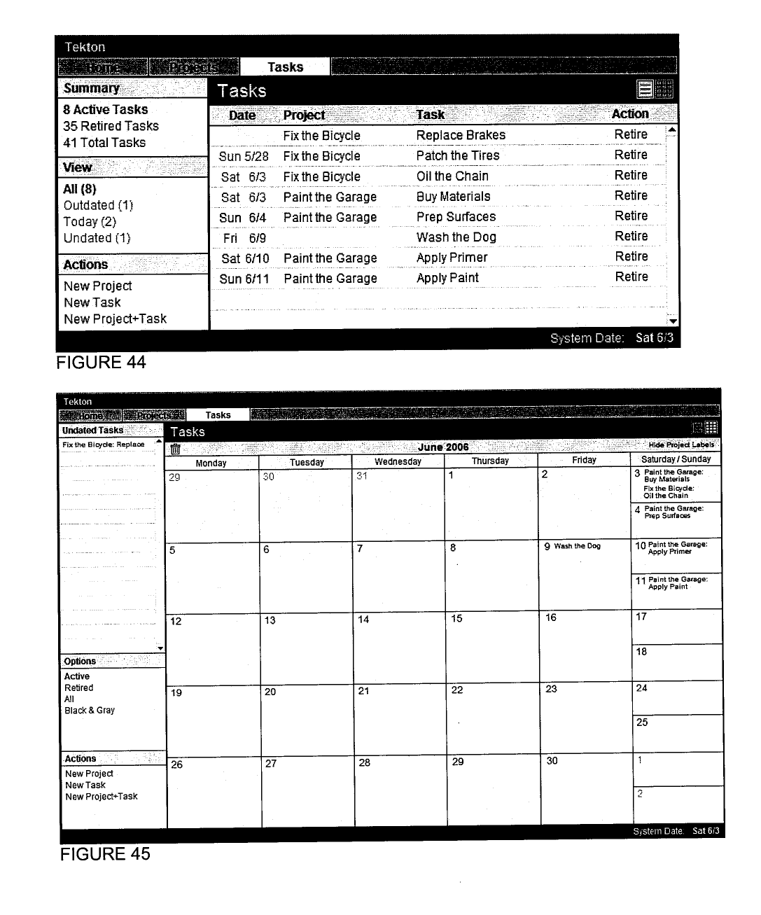

FIG. 44 shows a design for the list view of the Tasks List based on the inclusion of Group 1b design elements. The main panel of the Tasks List now provides an ‘Action’ column that provides options for managing the status of the listed tasks. Although not illustrated here, the list may include a ‘Status’ column to indicate the status of each listed task-especially when a combination of active and retired tasks are displayed. Also, the Tasks List can optionally be configured to display the creation dates, modification dates and retire dates of the listed tasks. If such columns are displayed, the user will be able to click the column headers to sort the list of tasks accordingly.

As shown in FIG. 44, the options panel of the list view now includes three lines in the Summary section. The lines indicate: the number of active tasks in the system (‘8 Active Tasks’); the number of retired tasks in the system (‘35 Retired Tasks’); the total number of tasks in the system (‘41 Total Tasks’); The user can click on any of the three lines to see the Tasks List filtered accordingly.

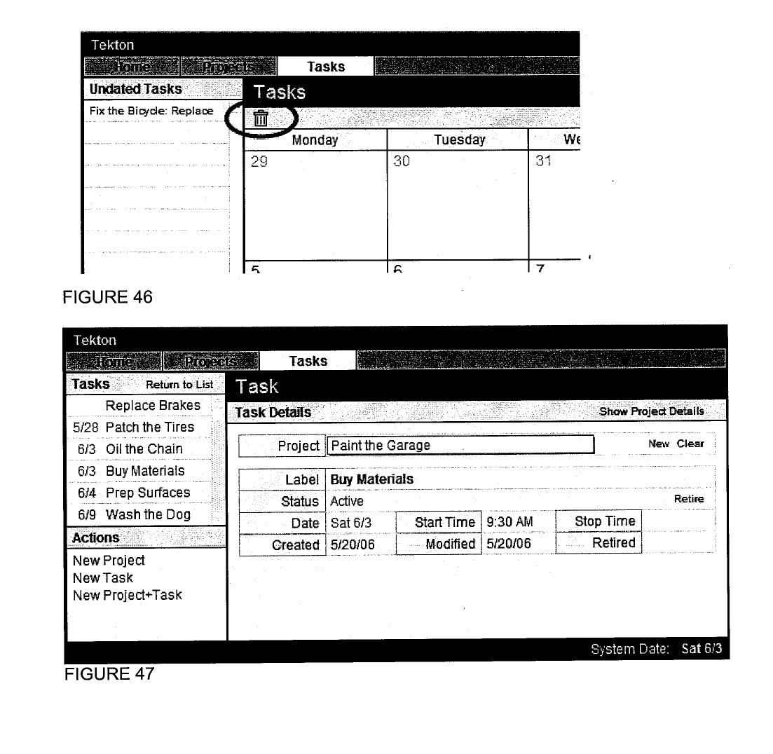

FIG. 45 shows a design for the graphical calendar view of the Tasks List based on the inclusion of Group 1b design elements. As shown in FIG. 46, the main panel of the graphical calendar view includes a trashcan icon. The user can click-and-drag any task (from the calendar or from the Undated Tasks list) onto the trashcan icon to change the status of that task record. If the status of the task record is ‘Active’, dropping the task onto the trashcan will retire the record. If the status of the task record is ‘Retired’, dropping the task onto the trashcan will reactivate the record.

As shown in FIG. 45, the options panel of the calendar view includes an ‘Options’ section. The Options section provides one-click access to filtered views of the Tasks List based on task-record status values. If the user selects ‘Active’, only active task records are displayed. If the user selects ‘Retired’, only retired task records are displayed. If the user selects ‘All’, all task records are displayed. If the user selects ‘Black & Gray’, active task records are displayed in black or normal-colored text, and retired task records are displayed in grayed-out text.

FIG. 47 shows a design for the Task Details Form (base state) based on the inclusion of Group 1b design elements. In its base state, the main panel of the Task Details Form now indicates the status of the selected task record. The form provides a ‘Retire’ button that the user can click to initiate the retire procedure for the selected task. The form also now indicates the creation date, the modification date, and the retire date of the selected task record.

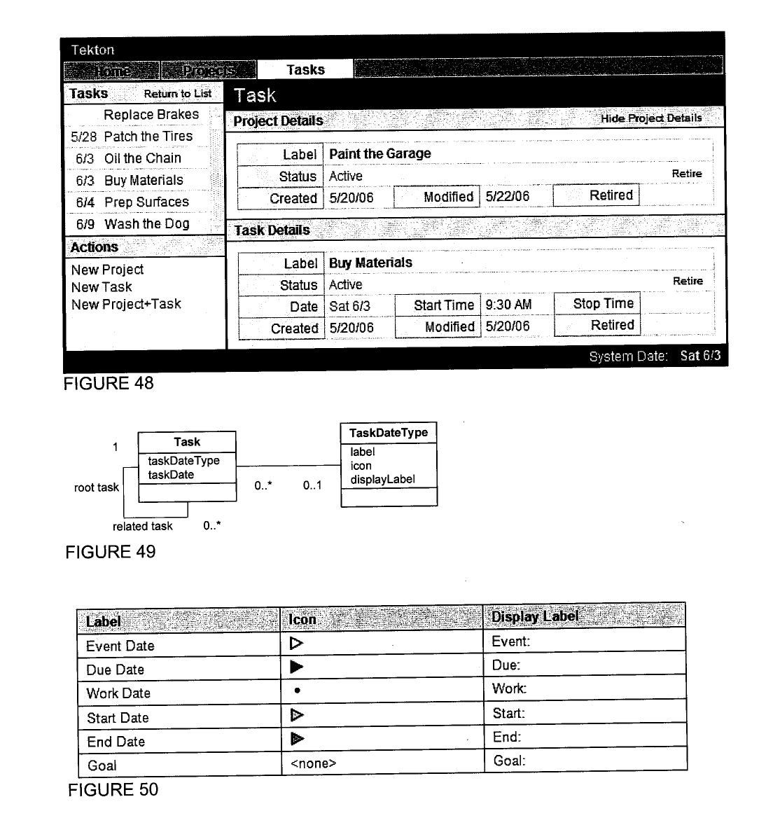

FIG. 48 shows a design for the alternate state of the Task Details Form based on the inclusion of Group 1b design elements. The alternate state of the Task Details Form includes the details of the related project, if the task has one. In FIG. 48, the top section of the main panel now includes the details that are included in the top section of the Project Details Form (shown in FIG. 43). The details include: the status of the related project; a button for changing the status of the related project (shown here as ‘Retire’, although it may read ‘Reactivate’ when the status of the related project is ‘Retired’); the create date, modification date and retire date of the related project.

The Project and Task classes may be extended to support more complex associations among projects and tasks. For instance, adding an association from the Project class to itself will allow Tekton to support nested projects. Similarly, the Task class can be extended to allow Tekton to internally support nested tasks and serialized tasks-i.e. tasks that exhibit dependencies upon other tasks.

The Group 2 design elements relate to task-date features and include: the TaskDateType class; three attributes of the TaskDateType class, including label, icon, and displayLabel; the association between the Task class and the TaskDateType class.

FIG. 49 presents a UML-style class diagram showing the static structure of the Group 2 design elements. FIG. 49 indicates that: each task is associated with up to one task-date type (note: a task may be given a task-date type whether the task is dated or not); each task-date type has a label, an icon, and a display label; each task can carry a reference to another task, and any number of tasks can carry a reference to the same task (note: The reference-bearing task is called the ‘related task’, and the referenced task is called the ‘root task’).

Date types are defined at configuration time. In a typical configuration, the date type definitions may include those illustrated in FIG. 50.

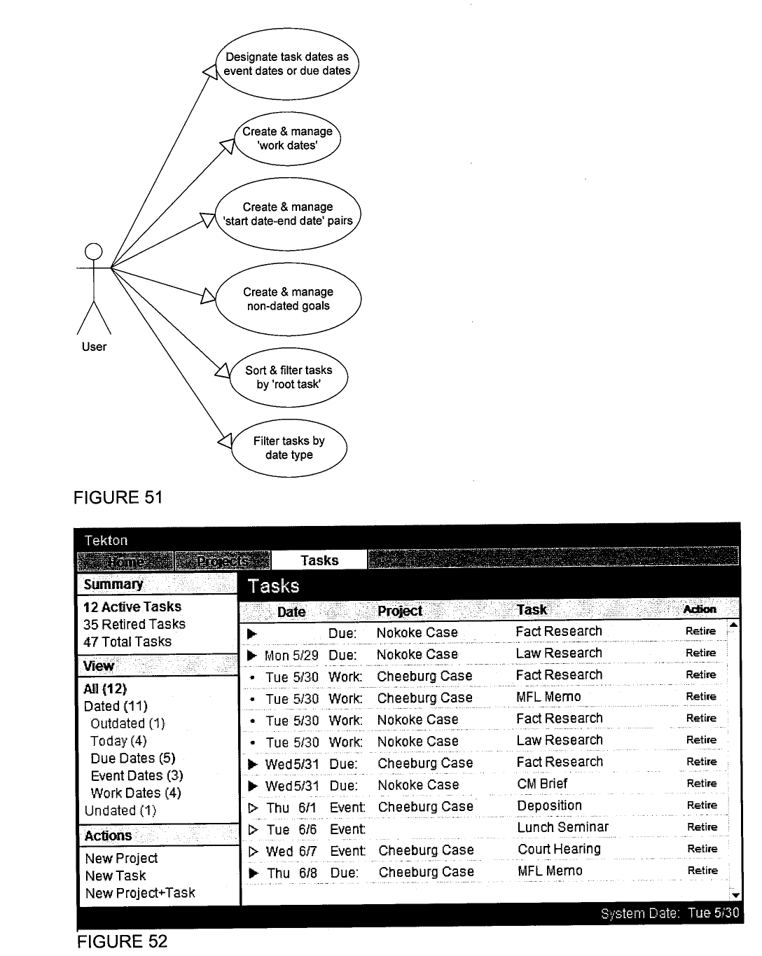

As indicated in FIG. 51, the Group 2 design elements support a number of specific use cases.

FIG. 52 shows a design for the Tasks List based on the inclusion of Group 2 design elements. With the inclusion of Group 2 design elements, each task is given a date type. On the Tasks List, the date type for each task is indicated by an icon to the left of the date column and by a display label to the right of the date column. The Tasks List in FIG. 52 shows three date types: event dates, due dates and work dates. A Tasks List in typical configuration may also show other date types, including start dates, end dates, and goals. In the Tasks List, the user can click on a date icon to create a ‘work date’ task record. (See the Features & Benefits section below for a discussion of the specific date types.) When the user creates a work date, the system will automatically present a date-chooser popup element for easy data entry.

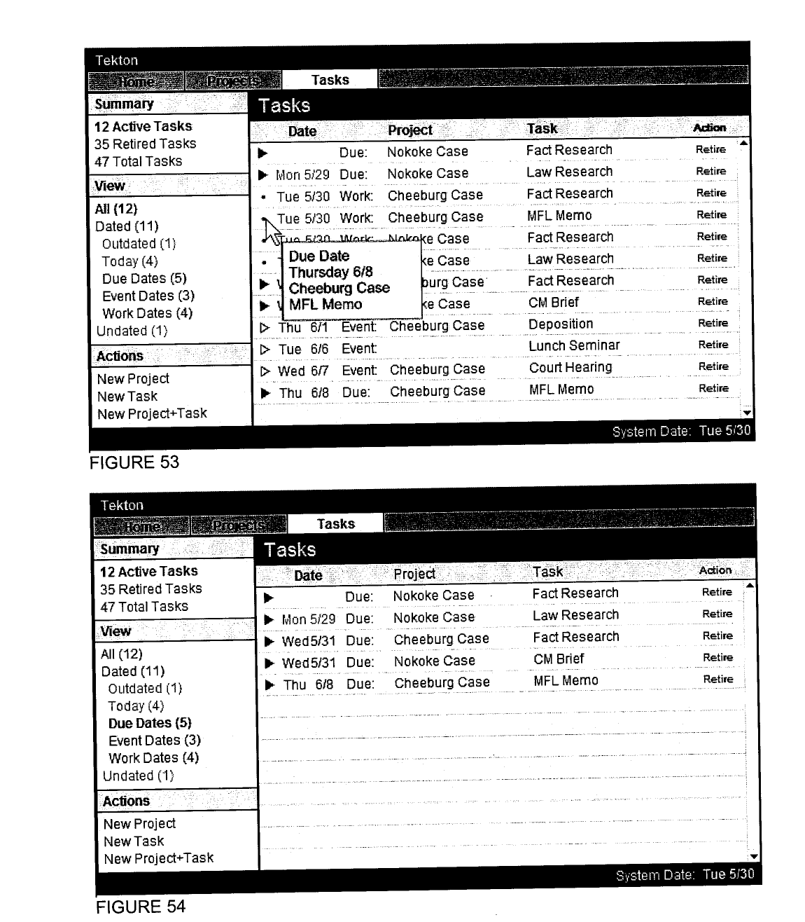

As shown in FIG. 53, the user can hover the cursor over the date type icon of a work date to see information about the root task for the work-date task record.

As shown in FIG. 54, the options panel provides one-click options for filtering the Tasks List to include only tasks with the selected date type. The user can click on ‘Due Dates (5)’, ‘Event Dates (3)’ or ‘Work Dates (4)’. The current selection is ‘Due Dates (5)’; the list shows only the five corresponding task records.

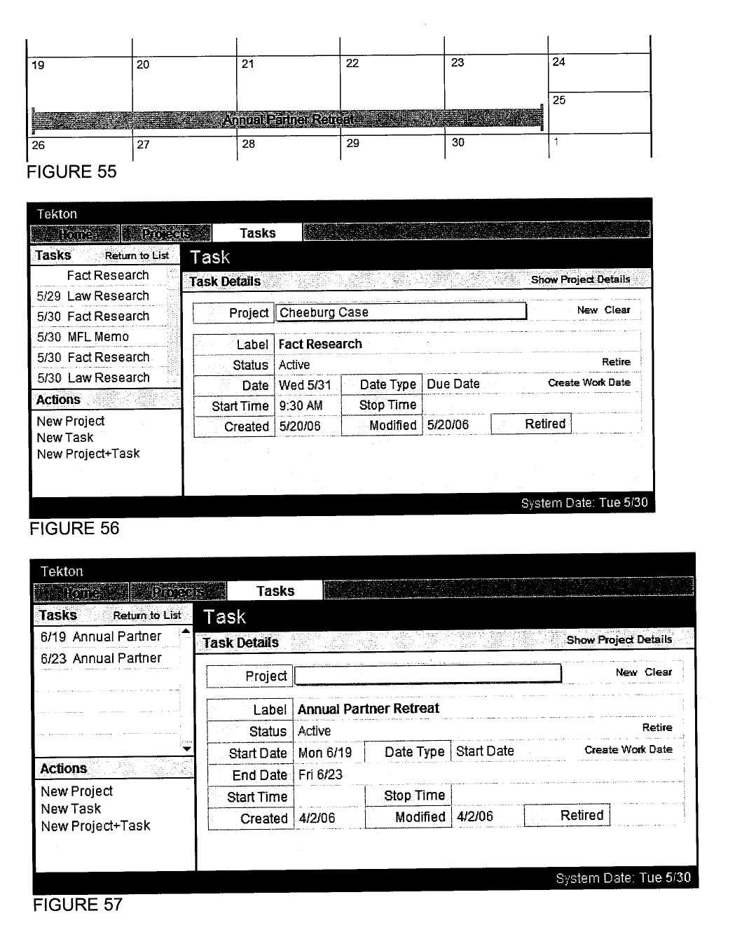

Date types can be indicated in a number of ways on the graphical calendar view. Options include showing the date type icons and using conditional text formatting, such as displaying due dates in boldface. In the graphical calendar view of the Tasks List, if the user holds down the ‘shift’ or ‘ctrl’ key while clicking-and-dragging a task to a date on the calendar, the system will create a work date for that date. On the calendar view, a task with both a start date and an end date can be optionally displayed with a graphical element (such as a colored line) that visually connects the start date and end date (see FIG. 55).

FIG. 56 shows a design for the Task Details Form based on the inclusion of Group 2 design elements. With the inclusion of Group 2 design elements, the main panel of the Task Details Form provides a Date Type data-entry field and a button labeled ‘Create Work Date’. The user can click on the date type data field to select a date type for the task. Some date types may not be directly user-selectable; that is, they may only be able to be created through a controlled procedure started elsewhere. Also, for some task records, such as work dates, the date type may not be user-editable. The user can click the ‘Create Work Date’ button to create a related work-date record.

Date types provide the user with additional ways to organize tasks (including goal-oriented tasks, one-time events, extended events with separate start and end dates, and non-dated goals). Date types allow the user to view and track activities in useful ways, and-as with work dates-date types provide increased efficiency by allowing users to reuse data.

Date types allow the user to indicate which task records correspond to due dates for projects (i.e. important deadlines) and which task records correspond to scheduled events. With a single click, the user can then ‘pull out’ a list of important due dates from among an entire list of calendar items by filtering the list to show only due dates. (See about the Options Panel section and FIG. 54 above.)

In the organizer, a ‘work date’ is a scheduled time for a person to work toward an upcoming due date or event date. When a task record has the date type of ‘Work Date’, it is called a work-date task record. A work-date task record is a ‘tethered clone’ of another task record. The user can create a work-date task record by either: (a) clicking on the date type icon of a task in the Tasks List, or (b) clicking a ‘Create Work Date’ button on the Task Details Form.

To create the work-date task record, the system: duplicates the original task record; sets the date type of the duplicate to ‘Work Date’; gives the duplicate record a reference to the original task record. After creating the work-date task record, the system automatically displays the new task record in the Task Details Form and presents a graphical date-chooser popup element for setting the task date. The original record is called the ‘root task’. The work-date record is a ‘related task’.

A user can create a work date by clicking on the date type icon of another work date. In that case, the new work date will be assigned a reference to the same root task as the existing work date task record. Note: When the root task is duplicated, the duplication does not apply to all attributes; the system duplicates the data in the user-data fields, such as the label, the date, and other user-entered information. The work-task does, however, have independent creation, modification and retire dates, as well as its own record status.

The ‘Work Date’ date type supports the following scenario. The user is assigned a task by her team leader to perform fact research for a new project called ‘Project Z’. The fact research is due on March 28th. The user: clicks ‘Tasks’ on the main navigation bar to view the Tasks List; clicks ‘New Project+Task’ in the options panel, causing the system to (1) create a new project record, (2) create a related task record, and (3) display the details for both records in the alternate view of the Task Details Form; clicks the project label field and types ‘Project Z’; clicks the task label field and types ‘Fact Research’; clicks the date field and clicks 3/28 in the date-chooser popup clicks the date type field and selects ‘Due Date’ (unless the default date type is set to Due Date, in which case this step is unnecessary). Later, as part of preparing the fact research, the user wants to schedule a phone call for March 15th at 10:30 am to discuss Project Z with an expert named Anderson. The user: clicks ‘Tasks’ on the main navigation bar to view the Tasks List; clicks the Due Date icon (a solid black flag) next to the date of the fact research task record, causing the system to (1) create a related work-date task record, (2) display the new work-date task record in the Task Details Form, and (3) display the date-chooser popup; clicks 3/15 in the date-chooser popup; clicks on the task label field and types the words ‘Call Anderson’, amending the label to read ‘Fact Research-Call Anderson’; clicks the start time field and clicks 10:30 am in the time-chooser popup. The user now has one project record and two task records related to the project record. One of the task records indicates the due date for the task, and the other task record is a related work-date record. The user can continue to create work dates for the task by reusing the data in the original task record, while leaving the due date itself set to the correct date. The due date record and related work date records can all be rescheduled, edited and tracked independently, yet they remain related to one another in the database. The user can find the due date for a task easily by: (a) filtering the Tasks List to show only due dates, (b) hovering the cursor over the date type icon of any related work-date record on the Tasks List, or (c) clicking the label of the related project to view the details of the project with its list of related tasks. The relationships among the project and task records also support a number of more sophisticated features that become possible as the solution is extended with the addition of more design elements.

Given the design elements introduced thus far, the Task class has a single date attribute. However, using this model, the organizer can still support the organization of ‘tasks’ (such as week-long seminars) that have separate start dates and end dates. Tekton can support these kinds of tasks by creating related pairs of task records and displaying them to the user as a single item.

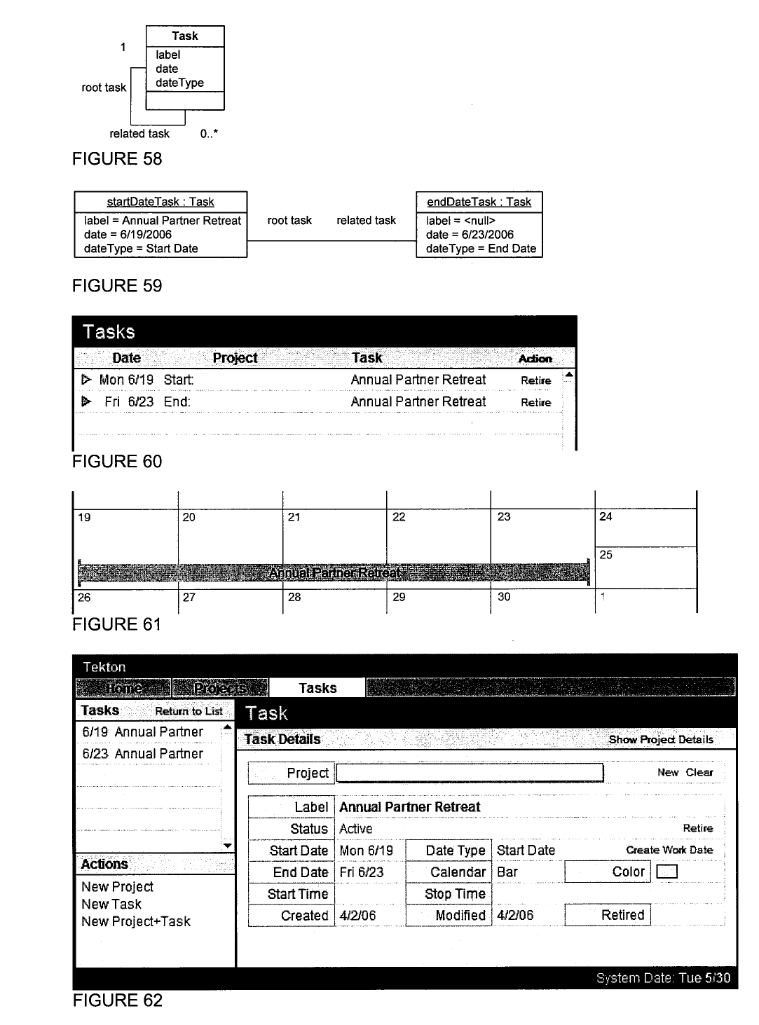

The ‘Start Date’ and ‘End Date’ date types can support the following scenario in the following way. The user decides to attend an annual partner retreat, which is scheduled to begin on June 19th and end on June 23rd. The user: clicks ‘Tasks’ on the main navigation bar to view the Tasks List; clicks ‘New Task’ in the options panel, causing the system to (1) create a new task record, and (2) display the new task in the Task Details Form; clicks the task label field and types ‘Annual Partner Retreat’; clicks the date type field and selects ‘Start Date’, causing the system to (1) create a related end-date task record, (2) expand the Task Details Form to include a second task date field, and (3) set the labels of the task date fields to read ‘Start Date’ and ‘End Date’, as in FIG. 57; clicks the Start Date field and clicks 6/19 in the date-chooser popup; clicks the End Date field and clicks 6/23 in the date-chooser popup. The system manages and displays the new pair of records as a single item. The two task records are related using the root task-related task association. The start-date task record is the root task, and the end-date task is the related task. The attributes of the start-date record are populated and managed normally. The end-date record only contains a task date value and a reference to the start-date record. FIG. 58 shows a diagram of the Task class as described here. (Note that the association between the Task class and the DateType class is represented here in a shorthand way through the use of a dateType attribute.) FIG. 59 shows an object diagram (based on FIG. 58) illustrating the related ‘Annual Partner Retreat’ task records.

In the Tasks List, as seen in FIG. 60, both records appear, but the end-date record is displayed using label of the start date record. As mentioned earlier, in the graphical calendar view of the Tasks List, the start-date and end-date task records can optionally appear together as a single bar graphic as in FIG. 61.

FIG. 62 illustrates a means for giving the user control over the appearance of the related tasks on the graphical calendar view. Note the addition of the ‘Calendar’ and ‘Color’ fields. These fields imply the addition of two attributes to the Task class: a calendarDisplayStyle attribute and a calendarBarColor attribute. The Calendar field corresponds to the calendarDisplayStyle attribute, and the Color field corresponds to the calendarBarColor attribute. The Calendar and Color fields are only displayed when the Task Details Form also displays Start Date and End Date fields.

The Calendar field offers two values: ‘Bar’ and ‘Text’. The Color field presents a color-picker GUI element populated with a variety of light colors. If the user selects ‘Bar’ in the Calendar field, the graphical calendar view will display the start-date and end-date tasks as a single bar graphic using the color selected in the ‘Color’ field (as in FIG. 61). If the user selects ‘Text’ in the Calendar field, the start-date and end-date tasks will appear as separate text entries in their respective date squares.

Tekton can also be configured to manage start dates and end dates by adding a second date attribute—‘date2’—to the Task class. In this case, the ‘date2’ attribute will only manifest in the GUI when a task is given a date type of ‘Start Date’. Such a record would be created as follows:

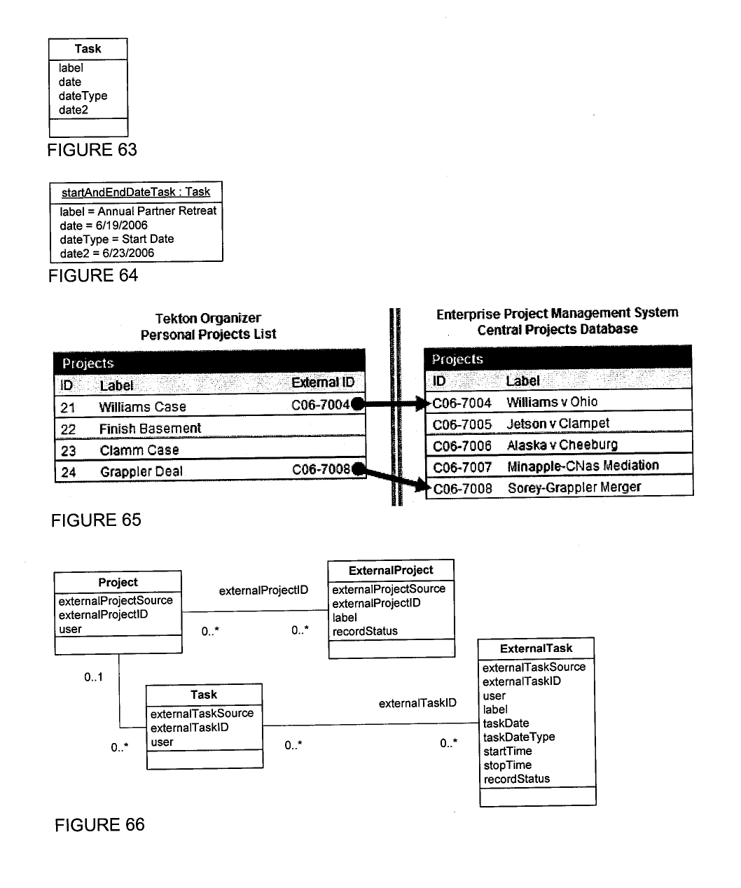

The user clicks ‘New Task’, causing the system to: (a) create a new task record, and (b) display the new task record in the Task Details Form. The user clicks the date type field and selects ‘Start Date’, causing the system to: (a) expand the form to include a second task date field, and (b) set the label of the first task date field to read ‘Start Date’ and the label of the second date field to read ‘End Date’. In this case, the Task class will be structured as in FIG. 63 and the task record will take the form of the object shown in FIG. 64. Regardless of whether a related pair of single-date tasks or a single two-date task is used to support start dates and end dates, the user experience is the same. The Tasks List and the Task Details Form still appear as illustrated above in FIG. 57, FIG. 60, FIG. 61, and FIG. 62.

The ‘Goal’ date type allows the user to create a distinct set of task records for the purpose of establishing and managing goals without using a separate list. A task with the ‘Goal’ date type is simply called a ‘goal’. As with tasks that have other date types, goals can be dated or undated. The task date for a goal is called the ‘target date’. The ‘Goal’ date type allows a user to manage a set of goals within the Tasks List by filtering the Tasks List to display only goals. Also, when viewing the Tasks List, the user can choose to show goals along with the other tasks on the list, or the user can choose to hide the goals.

In Tekton, task-date types may be assigned in various ways, including: user selection, default settings, work-date creation, remotely-initiated record-creation, task-category selection, and assignment by activity type.

Users can select date types when creating or editing task records in the Task Details Form.

When a task record is created, the date type is set automatically to a default initial value. Tekton can be configured to use any date type as the default date type. Generally, the default date type will be either ‘Due Date’ or ‘Event Date’. When a task record is created, it will automatically be assigned the default date type. In most cases, the user will then be able to change the date type.

The ‘Work Date’ type is assigned by the system automatically when the user creates a work-date task record.

Date types may be assigned automatically when task records are created in response to signals from external sources. For instance, Tekton may be configured to accept data from a project management system. Tasks created this way may be assigned date types according to data in the project management system. If a person is assigned a task with a specified due date in the project management system, Tekton may create a corresponding record with the date type set to ‘Due Date’. Similarly, a meeting scheduled in another external system may prompt Tekton to assign the ‘Event Date’ date type when creating a corresponding record.

Categories

A task-date type may be assigned automatically when the user selects a category for a task record. In this case, the category definition would prompt the change. (See the ‘Categories’ section for an explanation.)

Date types may be set according to Activity Type. Activity Types may have their own default values which would override the general date type default value. In this case, when the user creates a certain type of task, the date type would be set automatically in a corresponding way.

The following description describes features related to inter-application record-linking, describes one possible implementation of the Updater Component, and further discusses the features and benefits related to the Organizer Zone-Enterprise Zone architecture of the system.

The system is designed to communicate with centralized enterprise systems that manage data on behalf of the enterprise as a whole. In such systems, the objects, indexes, procedures and GUI elements are ‘owned’ by the enterprise-that is, they are designed to serve the functions of the enterprise as a whole. For example, in a firm with a centralized project management system, each project that the firm undertakes will have one corresponding record in the project management system. That record will carry information about the project from the perspective of the enterprise as a whole-e.g. the dates when the firm officially started and completed work on the project, the name of the person designated as the project team leader, the ID and official name of the client, etc.

In the organizer, by contrast, project and task records are ‘owned’ by the individual user. The user has complete control over the life-cycle and contents of the records that appear in his or her organizer. Whereas the centralized project management system will have one record for each project, if five people are working on that project, then Organizer Zone of the system will contain five records corresponding to that project. Each record describes the project from the individual's point of view. A user can create a record for the project when that user begins organizing time around that project, and the user can retire that project record when the user stops working on the project, regardless of whether or not other people in the firm are still working on the project and whether or not the firm's central record of the project remains officially active.

In order to interact with centralized systems, the projects and tasks in the organizer are able to carry references to corresponding records in the centralized systems. By doing so, organizer project and task records have the ability to serve as ‘aliases’ for projects and tasks in the centralized systems. While using such a structure might seem to multiply the need for data input, the benefits of the system far outweigh the increased systemic complexity-especially since the organizer and the centralized systems can cooperate in automatically creating records for individual users and in automatically managing the references needed to support such an arrangement. For the user, the processes of record creation and reference management are largely transparent, and the flexibility and power that the system brings are significant.

FIG. 65 illustrates the relationship between organizer record and enterprise records. The user has defined four organizer projects. Two of the projects (the first and last) correspond to client projects that are also defined in the firm's central database. Associations are set up through the use of ‘external ID’ values-indexed identifiers that serve as references. The user can use the project records in the organizer for personal organization, and by virtue of the centralized references (identifiers), the user can also ‘plug into’ team views of the project. The team views can show data from all users working on the same project; the data shown can come from within the system itself or from external systems that also share use of the common identifiers.

The layer of abstraction between the personal organizer and the Enterprise Zone provides both freedom and flexibility. Users can assign their own labels to projects. The user can define a client project and use that project record for personal organization, despite the fact that no record of the client project yet exists in the firm's central database (the ‘Clamm Case’). Also, the user can define personal projects (like ‘Finish Basement’) that have no place in the centralized systems. The Tekton Data Model-based on ‘personal objects’ that can be given references to ‘centralized objects’-makes the organizer highly flexible and accommodating.

In contrast to the Enterprise Zone which includes an enterprise's collection of centralized systems, the organizer is designed to create and maintain what can be called a personalized zone of data and functionality-the Organizer Zone. The centralized zone consists of systems that collect, organize and manage data on behalf of the enterprise as a whole. In centralized-zone systems, the databases, indexes, graphical user interfaces, and procedures are ‘owned by the enterprise’-that is, they are designed to perform functions on behalf of the enterprise as a whole, and they store and present data in a corresponding fashion. In such systems, objects are defined from the perspective of the enterprise, and graphical user interfaces tend to be complex and demanding. In the Organizer Zone, however, objects are defined from the perspective of the individual, and GUI elements are intuitive and accommodating. In the personal organizer, the databases, indexes, graphical user interfaces, and procedures are ‘owned by the individual’-that is, they are designed to conform to the needs, tendencies and preferences of the individual using the system. The Organizer is an intuitive and accommodating personal tool that allows a user to see information from the centralized zone from the user's own perspective.

To facilitate communication and synchronization between external systems and the internal system, the system maintains internal lists that contain information from external, related systems. The lists include index values (external IDs) and other useful pieces of data that are copied from records in the other systems. Two of these lists are the External Projects List and the External Tasks List. The lists are an internal part of Tekton; they are called ‘external records lists’ because they describe external records-that is, they are internal lists of external data. The External Projects List and External Tasks List serve as bridges between the personal organizer and external systems.

A firm's centralized list of projects may reside in an external project management system or in an external time-billing/accounting system. A firm may have more than one centralized list of tasks. One such list may be in an external project management system that records which team members are performing which tasks for a given project. Because the system regards all events as tasks, centralized task lists may also include shared calendars that are used by different groups throughout an organization.

In the following description of the “External Data Component”, the term “external” is used in relation to the organizer, as opposed to the entire system.

The system includes a configurable component called the External Data Component that communicates with the centralized systems to keep the External Projects List and the External Tasks List synchronized with those external sources. In some cases, the lists are synchronized in real-time (through the transmission of change-event messages), and in some cases, the lists are synchronized through periodic (e.g. daily) updates.

In some situations, the organizer may also be configured to communicate directly with external databases, with or without the use of intermediate lists and automated synchronizing procedures.

The organizer can manage information from enterprise systems, external systems, and other remote data sources to allow the user to organize views of the associated information as that information pertains to the user's own timeline of activities. For instance, the organizer allows a user to use information from a project management system to organize the user's work on various projects, and the organizer can also allow the user to view other information that pertains to any given project, including a list of relevant documents from the document management system, a list of resources that have been dedicated to the project, and a list of current billing totals for the project. The organizer can thus allow a user to see integrated views of data from numerous centralized computer systems within the context of the user's own activities.

Group 3 design elements include some of the features involved in supporting record-linking between the organizer and remote data sources (possibly including other instances of the organizer itself).

Group 3 design elements include: three attributes of the Project class, externalProjectSource, externalProjectID, user; three attributes of the Task class, externalTaskSource, externalTaskID, user; two classes, an ExternalProject class, and an ExternalTask class; attributes of the ExternalProject class, including externalProjectSource, externalProjectID and label; attributes of the ExternalTask class, including externalTaskSource, externalTaskID, label, user, taskDate, taskDateType, startTime, stopTime, recordStatus; the association between the Project class and the ExternalProject class; the association between the Task class and the ExternalTask class.

As described above, the External Projects List and the External Tasks List reside within the (internal) system; the corresponding ExternalProject and ExternalTask classes also belong to the (internal) system.

In addition to the attributes listed above, the ExternalProject and ExternalTask classes may be extended to include additional attributes to support additional useful information from the external systems. For instance, if the source for an external list of projects is a law firm's time-billing system, the ExternalProject class may be extended to include a practiceGroup attribute that would support data about which practice group within the firm is associated with each client matter on the list.

FIG. 66 shows a UML-style class diagram showing the static structure of the Group 3 design elements. FIG. 66 indicates that each project record can optionally be associated with one or more external project records. Conversely, each external project record can optionally be associated with one or more (internal) project records. The association is based upon a shared identifier, here called externalProjectID.

Note: Usually, an internal project record will be associated with at most one external project record. An external project record might be associated with any number of internal project records, but there will be at most one such link for each user for any given external project record. That is, if there are five people working on a given project, there will be five internal project records-one for each user-linked to one external project record.

Each task record can optionally be associated with one or more external task records. Conversely, each external task record can optionally be associated with one or more (internal) task records. The association is based upon a shared identifier called externalTaskID.

Note: Usually, an internal task record will be associated with at most one external task record. If an external task is associated with a specific user, then the external task record will be associated with at most one internal task record. (This will occur when the external task is a task in a project-management system that has been assigned to a specific person.) Otherwise, an external task record might be associated with any number of internal task records. (This will occur when the external task is a group event scheduled on a shared calendar, and many people put the event into their own list of (internal) tasks.)

When the system is configured to offer multiple sources of external project records, a given project record can indicate which external source is being referenced by a particular link. The external source for the given link is indicated by externalProjectSource. When the system uses only one source of external project records, externalprojectSource is not used.

When the system is configured to offer multiple sources of external task records, a given task record can indicate which external source is being referenced by a particular link. The external source for the given link is indicated by externalTaskSource. When the system uses only one source of external task records, externalTaskSource is not used.

When multiple external sources are available, the user will be able to choose which source is to be referenced. The user will then select an index number from the corresponding list. In such arrangements, the different external sources may be reflected within Tekton in one of three ways:

Index values and supporting data may be copied from multiple external databases into one list in organizer, with each record indicating its external source. The externalProjectSource and externalTaskSource values would then be used to filter the ‘External Projects List’ and ‘External Tasks List’.

Index values and supporting data may be copied from each external database into a separate corresponding list in the system. The externalProjectSource and externalTaskSource values would then be used to the system to identify the corresponding list. In this case the ExternalProject class and the ExternalTask classes would actually be ‘superclasses’, each being extended to provide the multiple subclasses corresponding to the multiple lists.

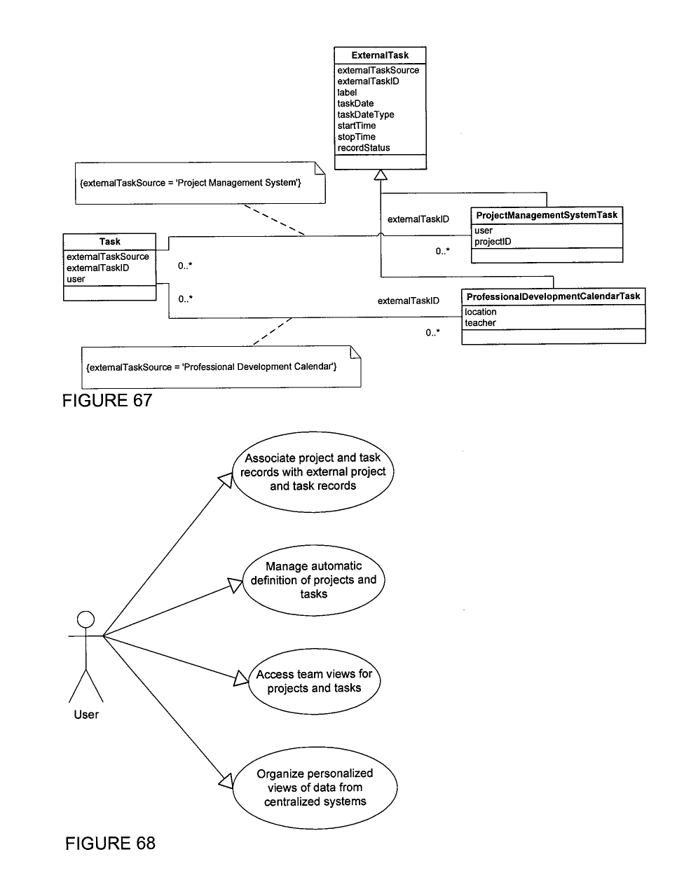

A combination of both preceeding strategies could be used. Thee second strategy could be useful because, in many cases, different external sources will offer different types of useful data, and the external record lists will be configured to handle such data. For instance, one source of external tasks may be a project management system that stores the project ID number with each task. Another source of external tasks may be a professional development calendar that lists available training courses, including the location and teacher's name for each course. In this case, the data from each source could be stored in a separate list that has been extended with appropriate columns. Thus, the ExternalTask class becomes a superclass that is extended as in FIG. 67.

When the user creates a task that is linked to the project management system, the Task Details Form will-in addition to the normal task record fields-display the project ID value from the project management system and, optionally, additional related data from the project management system, such as the name of the project supervisor. When the user creates a task that is linked to the professional development calendar, the Task Details Form will display ‘Location’ and ‘Teacher’ fields.

Not all of the values in the External Projects List and External Tasks List must come from the external sources. For instance, the project management system might not have its own taskDateType value, but the data-link component of Tekton can supply that value according to specified rules. For instance, if a task record in the project management system is labeled ‘Kick-off meeting’, Tekton can set the task-date type of the imported record to ‘Event Date’; if the task label is ‘Prepare research’, Tekton could assign a date-type value of ‘Due Date’. One value or another could be used for unrecognized task labels. Alternatively, the external system would be expanded to include date-type values, or the user could be prompted to supply one when creating or accepting the task record.

FIG. 68 presents a UML-style use case diagram that shows some of the use cases related to the Group 3 design elements.

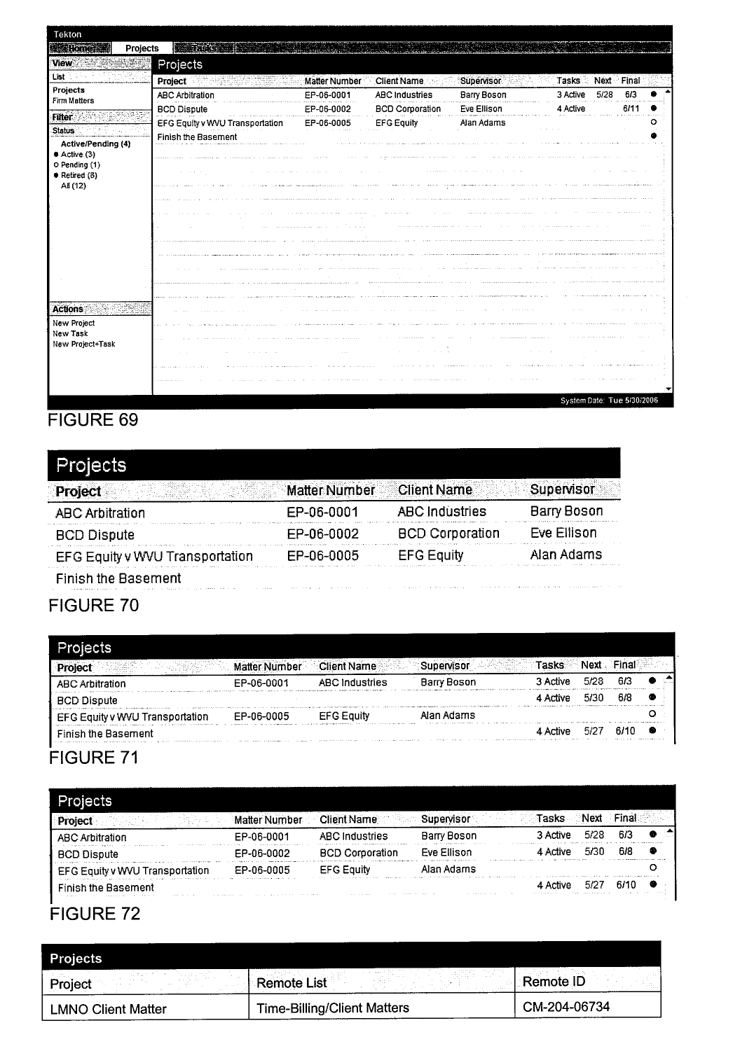

FIG. 69 shows a design for the Projects List based on the inclusion of Group 3 design elements. The illustration shows the Projects List as it might appear for a lawyer working in a law firm. In this example, the system has been configured to allow users to associate organizer project records with records in the firm's time-billing system. The time-billing system maintains the central list of all matters (projects) for the firm. The time-billing system provides a unique identifier (index value or ‘ID’)-called the Matter Number-for each matter in the system. The time-billing system identifies the client and supervisor for each matter and manages data about (a) which members of the firm have performed billable work toward the matter, (b) what type of billable work was performed, (c) how many hours of billable work were performed in each instance, and (d) what the billable rates are for each type of work performed. Note: In some configurations, some of this related data may be pulled into the time-billing system from yet other sources. For instance, the time-billing system may simply hold index numbers for each client and supervisor (i.e. a Client ID and a Worker ID) and retrieve the actual client name and supervisor name from related systems. In such a situation, Tekton may retrieve such related data either through the time-billing system, or it may pull only the index values (IDs) from the time-billing system and retrieve the related values (names) directly from the other related systems. For simplicity, this illustration assumes that all of the imported data comes from the time-billing system.

As shown in FIG. 69, the main panel of the Projects List displays eight columns. The first column is labeled ‘Projects’ and displays the label that the user has given to each project record.

The second column is labeled ‘Matter Number’ and displays the firm's index value for a related record in the time-billing system, if the user has chosen one. The third column is labeled ‘Client Name’ and displays the name of the client associated with the related matter record in the time-billing system, if the user has associated the given project with a Matter Number. The fourth column is labeled ‘Supervisor’ and displays the name of the firm's supervisor for the matter, if the user has associated the given project with a Matter Number. The fifth, sixth, and seventh columns display summary data about the tasks that are associated with each listed project. The eighth column indicates the status of each project record. (Status is now indicated by a colored-circle icon. Green indicates ‘Active’, yellow indicates ‘Pending’, and red indicates ‘Retired’. The function of the ‘Pending’ status value is described below.)

FIG. 70 shows a detailed view of the first four columns of the Projects List shown in FIG. 69.

The fourth record shown in FIG. 70-labeled ‘Finish the Basement’-is not associated with a central time-billing record, because no such record exists; it is a personal project. This example illustrates the flexible and accommodating nature of the Tekton's data model. The layer of abstraction between the organizer and the centralized time-billing system allows the user to manage a combination of enterprise data and personal data in a single list. The term ‘layer of abstraction’ is used here to refer to a situation where one set of records is used to represent another set of records that reside elsewhere; the ‘representation’ is achieved through the use of reference values. The layer of abstraction between the personal organizer and the centralized systems creates the ‘personalized zone’ in which the user has personal control over the records that are created. The terms ‘layer of abstraction’ and ‘personalized zone’ may seem academic or theoretical, but the structures themselves are in no way mere curiosities; they have real practical value.

As demonstrated in FIG. 70, the system allows a user to organize all of his or her activities in one place-including professional activities and personal activities. Note the inclusion of a personal (non-professional) project labeled ‘Finish the Basement’. Such a record has no place in a firm's centralized systems, but a personal organizer has only limited value unless it can accommodate information about all activities in the user's life. The personalized zone created by the layer of abstraction (with regard to centralized systems) allows a user to create a single list of projects that can reflect every area of the user's life. In other words, project records and task records can be related to centralized systems, but they don't have to be. This allows a user to keep track of all of his or her projects and tasks in one place, regardless of whether they relate to data in the firm's centralized systems or not. Personal projects and tasks are simply left without references to centralized records. However, wherever the user's projects and tasks do relate to data in the firm's centralized systems, the user can establish relationships to the relevant centralized records and access whatever related data is available.

The layer of abstraction between the organizer and the centralized systems also makes the organizer more accommodating in the way that it handles enterprise-related data. For instance, the system allows a user to create a record for a client project without first having to find the official index value (matter number or project ID) in the firm's central database. In fact, a lawyer can create a project record, give it a shorthand name, and use that record in the personal organizer, even if the project is in fact a client project but has not yet been defined in the centralized project management system. FIG. 71 illustrates such a record.

In FIG. 71, the user has created a project, labeled it ‘BCD Dispute’, and created four task records for the project. The ‘BCD Dispute’ is a client matter that the user will bill hours toward, but the time-billing system does not yet contain a record of the matter. The user simply leaves the Matter Number field blank until such a record is created in the time-billing system.

Later, when a corresponding record has been created in the firm's time-billing system, the user can go back to the record and create the reference by entering the firm's official matter number. In FIG. 72, the user has edited the ‘BCD Dispute’ project record, and the Projects List now shows the firm's central matter number for the project (‘EP-06-0002’) as well as pieces of related data from the time-billing system, including the official client name and the official supervisor for the project.

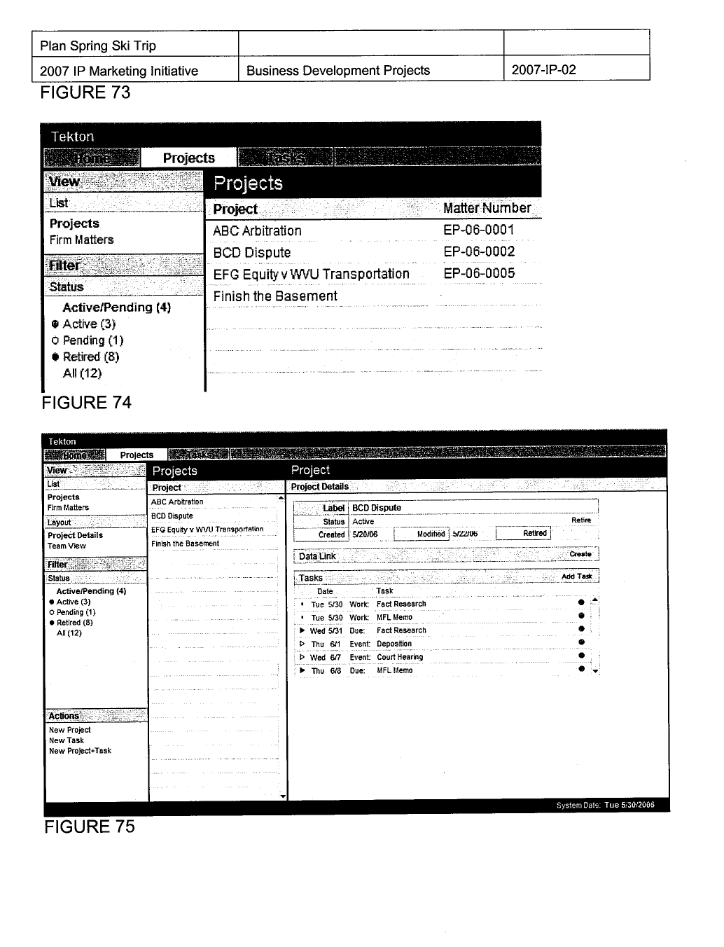

The system's data model also allows the user to organize data from more than one centralized system in one place. For instance, a firm might have a time-billing system that provides official definitions for all of the firm's client matters and a separate system that tracks all of the firm's business development projects. The present system's data model allows the user to view projects from both systems in the same Projects List. In this case, the ‘externalprojectSource’ value is used to indicate which external database is being referenced by the index value (the ‘externalProjectID’ value). FIG. 73 illustrates such a situation.

As shown in FIG. 73, the user has created three project records. The first project is a billable client matter labeled ‘LMNO Client Matter’; it corresponds to Matter Number CM-204-06734 in the firm's time-billing system. The second project is a personal project labeled ‘Plan Spring Ski Trip’; it does not correspond to any record in the firm's centralized systems. The third record is a business development project labeled ‘2007 IP Marketing Initiative’; it corresponds to Project Number 2007-IP-02 in the firm's central database of business development projects.

As shown in FIG. 74, the options panel of the Projects List includes a section labeled ‘View’ and a section labeled ‘Filter’. The View section has a single subsection labeled ‘List’. In FIG. 74, the List subsection presents two options: ‘Projects’ and ‘Firm Matters’; the Projects option is selected (as indicated by the boldface font) and the main panel shows the Projects List. The user can click ‘Firm Matters’ to see the External Projects List-in this case, called ‘Firm Matters’. Generally, when the organizer is configured to use external lists, the user is given the option to view the external lists that relate to the currently-selected organizer section (such as Projects or Tasks). In the View/List section of the options panel, the first option will be the internal organizer list (i.e. Projects), and the subsequent options will include the available external lists (i.e. Firm Matters). If the Projects List is configured to offer more than one external list, the View/List section of the options panel will list each available option. For example, in the configuration illustrated by FIG. 73, the user can choose to relate an internal project record to an external record in either one of two external lists: a Firm Matters list or a Business Development Projects list. In that situation, the View/List section of the options panel would include three options: Projects, Firm Matters, and Business Development Projects. As shown in FIG. 74, the Filter section of the options panel now offers options labeled ‘Active/Pending’ (which is the default option) and ‘Pending’. The ‘Pending’ record status value is described below.

FIG. 75 shows a design for the Project Details Form based on the inclusion of Group 3 design elements. In this design, the GUI is laid out differently than in earlier designs. The display is now divided into three areas instead of two. In this design, when the user clicks a project label in the Projects List, the Projects List does not move into the options panel. Instead, the Projects List simply narrows to make room for the Project Details Form. From left to right, the three panels are called the Options Panel, the List Panel, and the Form Panel.

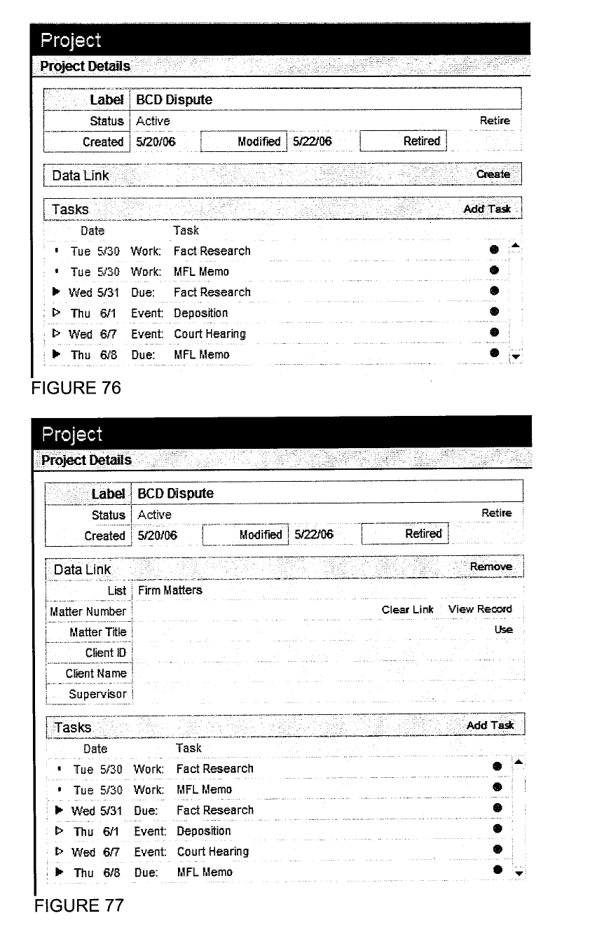

FIG. 76 shows a detailed view of the Form Panel. As shown in FIG. 76, the Project Details Form now includes a section labeled ‘Data Link’. The Data Link section allows the user to create and manage a link between the selected record and an external project record. In FIG. 76, the Project Details Form displays the details of a project record labeled ‘BCD Dispute’. The Data Link section is collapsed, because no Data Link exists. If the user clicks ‘Create’ in the title bar of the Data Link section, the Data Link section expands to reveal a number of fields, as shown in FIG. 77.

In FIG. 77, the user has expanded the Data Link section of the Project Details Form. The absence of an index value (in this case, a Matter Number) indicates that no link has been established. Although no link has been established, the List field displays ‘Firm Matters’ because the Firm Matters list is the only list currently available for use in establishing links to external project records. If more than one list were available, the user would be prompted to select an external list before selecting an external record.

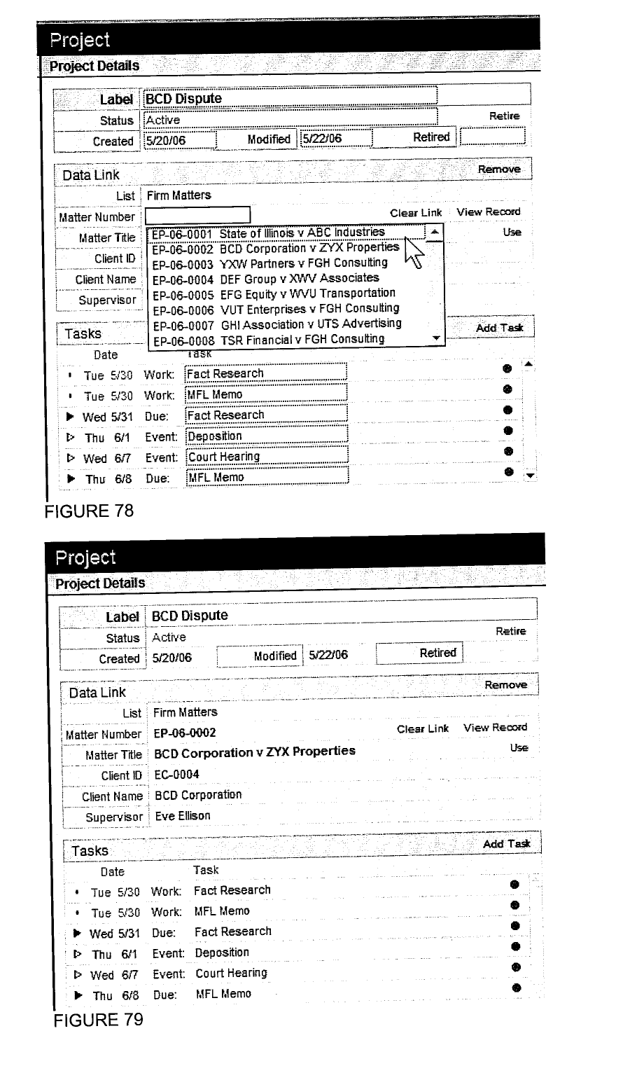

In FIG. 78, the user has clicked on the Matter Number field, causing the system to present a drop-down list of available records from the external Firm Matters list. The drop-down list is used to select only an index value (a Matter Number). However, the list additionally displays the title of each matter to assist the user in finding the desired record. When the user clicks on a line in the drop-down list, the corresponding Matter Number is recorded in the externalProjectID field of the user's internal project record. Optionally, the user can type an index value directly into the Matter Number field.

As shown in FIG. 79, the user has selected ‘EP-06-0002’ in the Matter Number field. The user has thus established a link between the internal project record labeled ‘BCD Dispute’ and the external project record labeled ‘BCD Corporation v ZYX Properties’. The user can click the Matter Number field to select a different external index value to link the displayed internal project record to a different external project record. If the user clicks ‘Remove’, the system will erase the externalProjectID value in the displayed internal project record (thus destroying the link) and close the Data Link section of the Project Details Form. If the user clicks ‘Clear Link’, the system will erase the externalProjectID value in the displayed internal project record (thus destroying the link) and leave the Data Link section open so the user can create a new link, if desired. The user can click ‘View Record’ to view the details of the linked external record in the External Project Details Form. Alternatively, the system may be configured so that clicking the ‘View Record’ button causes the GUI of the external related system to appear and display the details of the external record in its own details form. The fields labeled ‘Matter Title’, ‘Client ID’, ‘Client Name’, and ‘Supervisor’ display data from the linked external record. If the user clicks ‘Use’ next to the Matter Title field, the system will copy the text label from the external Matter Title field into the label field of the internal project record. That is, the user can click the ‘Use’ button to use the external project label as the user's own label.

Creating data links to external records can allow a user to access team views related to internal records. Because the external lists are based on centralized (shared) indexes, the index values of the external records can be used as common identifiers for creating associations between otherwise unrelated internal records that have been created by different users. That is, if five users create internal project records and create links from each internal project record to the same external project record, then Tekton ‘knows’ that the five internal project records are related to one another.

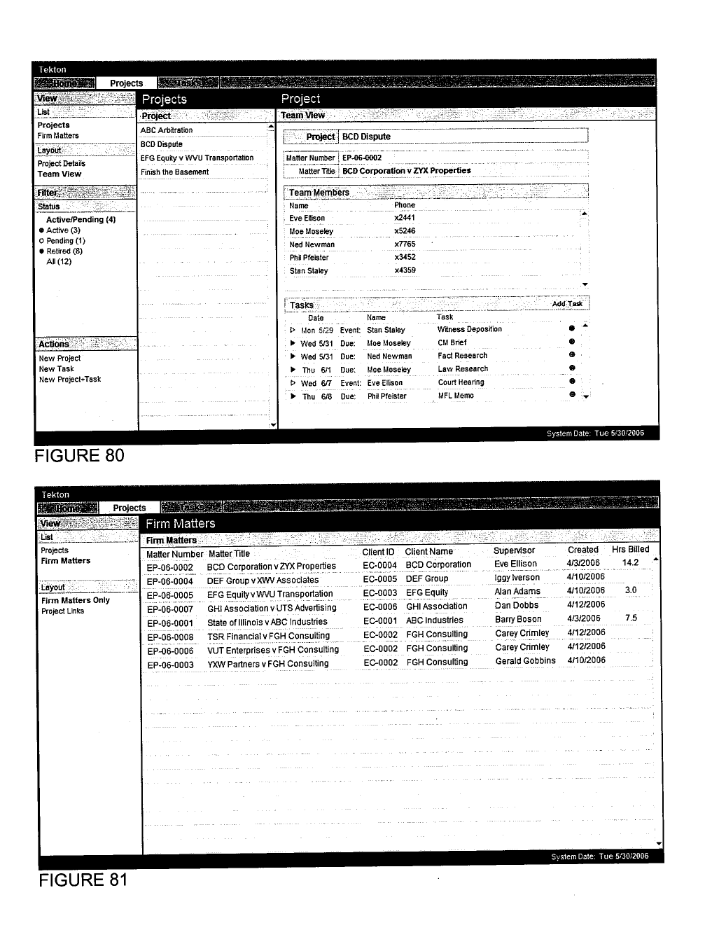

In FIG. 80, the user has accessed a team view for Matter Number EP-06-0002. Including the current user, five users have created internal project records and linked those records to the same record in the Firm Matters list.

The team view displays the name and phone number of each person that has created a link to Matter Number EP-06-0002 and also displays a combined list of all tasks that each user has associated with the project in question. The Tasks section displays the date, user name, label, and status value associated with each listed task. The Tasks section also provides a button labeled ‘Add Task’ that the user can click to create a new related task for the project.

As mentioned above, the organizer allows the user to view any external lists that are available for creating references between personal-organizer records and centralized records. The organizer can be configured to offer more than one External Projects List. Each External Projects List will be given a more specific label that describes the source and/or contents of the list-for instance, ‘Firm Matters’ or ‘Business Development Projects’.

Each External Projects List allows the user to view the external list items and also to manage any links between records in the internal Projects List and the given External Projects List. In some cases, the user may also be given options for managing preferences regarding automatic record-creation procedures and automatic synchronization procedures that pertain to the external list.

Automatic record-creation and automatic data-synchronization are two primary functions of the Updater Component.

Automatic record-creation occurs when the system automatically creates an organizer record (such as a Project record) in response to a change in the external lists. For instance, if a user starts to bill hours against a new Firm Matter record in the time-billing system and the user has not yet defined a corresponding project in the organizer (i.e. created an internal project record that contains a reference to the aforementioned external record in the time-billing system), the system can offer to create such a record automatically.

Automatic data-synchronization occurs when (a) a relationship has been established between an internal organizer record and an external list record, (b) one of the records is changed, and (c) the system executes an automatic procedure to maintain proper correspondence between the two records. If the external record of a related pair is changed, the system may update the internal record accordingly and notify the user of the change, or the system may inform the user of the change in the external record and offer relevant options to the user. For instance, if the user has created an organizer task record that corresponds to a dated event on an external calendar and the event date is changed on the external calendar, the system may update the internal record accordingly and notify the user that the date of the event has been changed. The notification may occur in one or more ways: the user might see an alert on the Summary Panel on the user's home page, the date of the event might be highlighted on the Tasks List, or the user might receive an automatic e-mail from the system describing the changed data.

FIG. 81 shows a design for one layout of an External Projects List labeled ‘Firm Matters’. As indicated under the ‘Layout’ section of the options panel, the layout shown in FIG. 81 is labeled ‘Firm Matters Only’. The Firm Matters list displays records from the firm's time-billing system. As seen in FIG. 81, the Firm Matters Only layout of the Firm Matters list displays seven columns. The ‘Matter Number’ column displays the index value for each record in the list. The index value is a unique identifier that is used to establish an unambiguous link between a personal-organizer record and an external list record. The ‘Matter Title’ column displays the official label given to each firm matter record. The ‘Client ID’ column displays the centralized index value for the client associated with each firm matter record. The ‘Client Name’ column displays the official name for the client associated with each firm matter record. The ‘Supervisor’ column displays the name of the supervising attorney for each firm matter listed. The ‘Created’ column displays the official inception date for each firm matter listed. The ‘Hrs Billed’ column displays the number of hours that the user has billed to each firm matter listed. Note that this last column differs from the others in that it displays data that is unique to the user accessing the system.

The Firm Matters Only layout displays data from the external list only. An analogous view (labeled ‘[External Records] Only’) will be available for any external records list. As in FIG. 81, the first two columns of such a layout will generally display (1) the index value for each item listed and (2) the main label (name or title) given to each item. The remaining columns may display any other type of useful information from the external source.

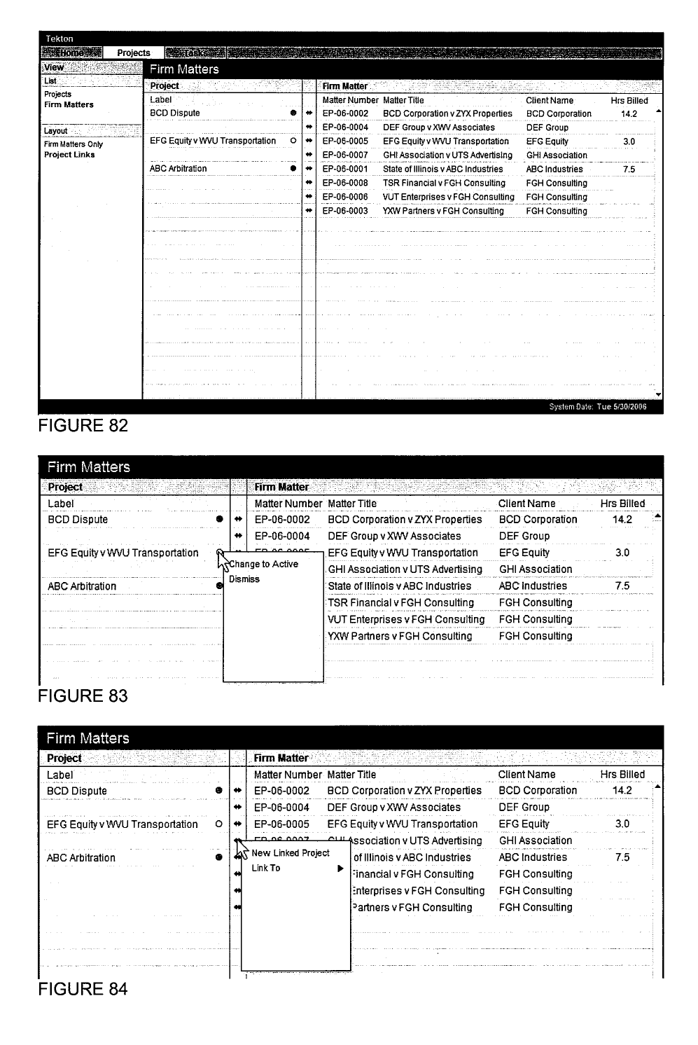

FIG. 82 shows a design for a layout of the Firm Matters list that is labeled ‘Project Links’, as indicated in Layout section of the options panel. The Project Links layout (a) displays the external list, (b) indicates which record in the internal list (if any) is linked to each record in the external list, and (c) provides options for managing links between the internal list and the external list. The main panel of the Project Links layout is divided into three sections. The right-side section displays the External Projects List-in this case, the Firm Matters list. The first column in the right-side section shows the index value for the external record (the Matter Number), and the second column shows the main label for the record (the Matter Title). The right-side section also includes additional columns of useful information from the external list. The user can click on any external project record to see the details of the record displayed in an External Project Details Form. The left-side section displays data from the internal Projects List. If a link has been established from an internal project record to external project record that is shown on a given line, the left-side section shows the label and status icon of the linked internal project record. If no such link has been established, the line is blank in left-side section. The user can click on the label of any project record to see the details of that record displayed in the Project Details Form. The user can manage the status of any internal project record by clicking the Record Status Icon for that record. When the user clicks the Record Status Icon, a contextual popup menu called the Contextual Record Status Menu appears and provides a list of options. FIG. 83 illustrates the Contextual Record Status Menu.

In FIG. 83, the user has clicked the Record Status Icon for an internal project record with a record status value of ‘Pending’. In this case, the record status value is ‘Pending’ because the record was automatically created by the system. The record was automatically created by the system because the user has billed 3.0 hours against the external project record in the time-billing system (note the 3.0 value in the ‘Hrs Billed’ column), and the user had no internal project record linked to that external project record. That is, the user has billed 3 hours of time to the firm matter labeled ‘EFG Equity v WVU Transportation’ in the firm's time-billing system, and the user had not yet created a link to the central project record using the firm's official Matter Number.

Because the record status value for the internal project record is ‘Pending’, the Contextual Record Status Menu includes the options ‘Change to Active’ and ‘Dismiss’. If the user clicks ‘Change to Active’, the record status value for the internal project record will be set to ‘Active’. If the user clicks ‘Dismiss’, the record status value will be changed to ‘Dismissed’, and the record will disappear from the list. The user may want to dismiss the auto-created record if the user had already created an internal project record for the project but had not yet established a link to the central project record using the firm's official Matter Number. The user may have created such a record and left it unlinked either because the project had not yet been defined in the central time-billing system, or because the user did not want to spend time searching for the official Matter Number. The middle section of the Project Links layout (see FIG. 82) consists of a single narrow column that displays a Link Icon on every line that contains an external project record. The Link Icon is a double-headed arrow that points to the left and right. The user can click on the Link Icon to manage a link to the corresponding external project record. When the user clicks on the Link Icon, a contextual popup menu called the Contextual Link Menu appears and provides a list of options.

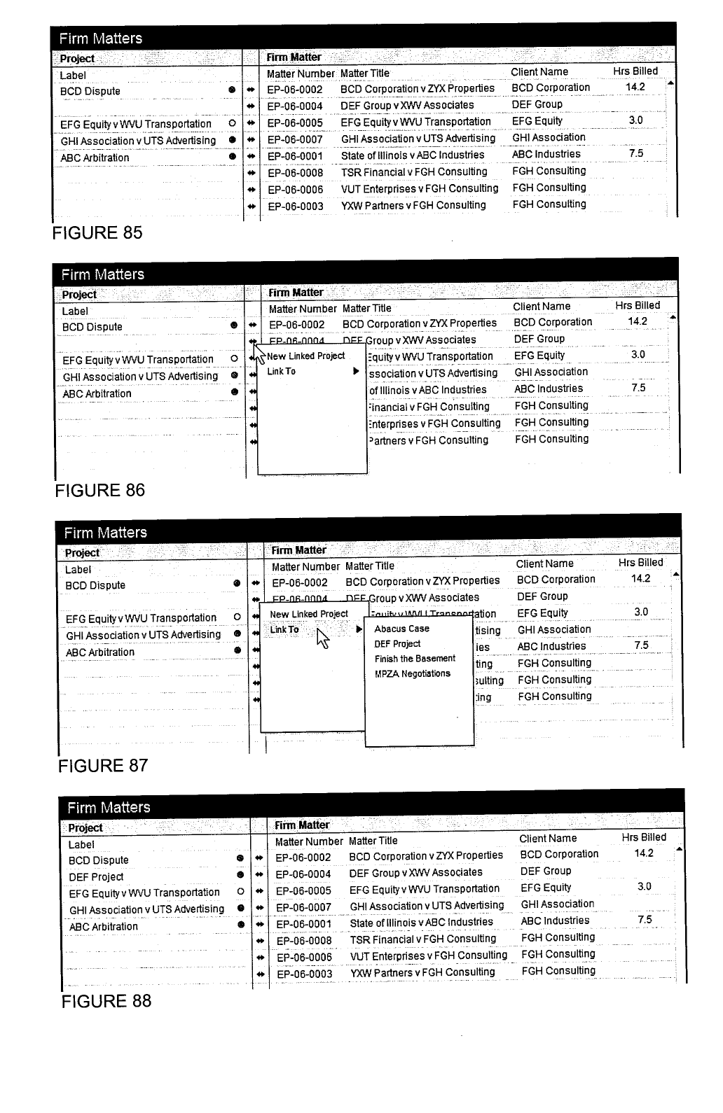

FIG. 84 illustrates the Contextual Link Menu. In the example shown in FIG. 84, the user has clicked the Link Icon on a line that displays an external project record to which the user has established no link from an internal project record. (That is, the user has not established a link from any internal project record to the external project record shown on that line; thus, the line to the left of the clicked icon is blank.) If the user clicks ‘New Linked Project’, the system will: create a new internal project record; give the new internal record the same label as the external record; set the externalProjectID value of the new internal project record equal to the index value-in this case, the Matter Number-of the external project record, thus establishing a link between the new internal project record and the external project record The list shown in FIG. 84 will now display the new linked record, as shown in FIG. 85. (The new record is labeled ‘GHI Association v UTS Advertising’.)

In FIG. 86, the user has clicked on the Link Icon next to another unlinked external project, revealing the same Contextual Link Menu. In the example shown in FIG. 86, if the user moves the cursor down to the ‘Link To’ option, the Contextual Link Menu displays a second panel showing the labels of all existing internal projects that are currently active and unlinked. The second panel is illustrated in FIG. 87.

As illustrated in FIG. 87, the list of internal projects currently contains four projects that are active and unlinked. The user has created each record manually and entered a label by typing it into the Project Details Form. The second project on the contextual menu panel is labeled ‘DEF Project’. The user created this record to schedule a number of tasks associated with the project. However, when the user began scheduling tasks for the project, a record of the project had not yet been created in the central time-billing system, so the user gave the project record a shorthand label (‘DEF Project’, based on the client name) and left the record unlinked to the external list. A record of the project has since been created in the time-billing system, and the user wishes to link the internal project record to the corresponding centralized record. If the user clicks ‘DEF Project’ on the second panel of the Contextual Link Menu, the system will create a link by setting the externalProjectID value of the ‘DEF Project’ record to ‘EP-06-0004’, the Matter Number (index value) of the corresponding external project record. As a result, the Firm Matters list will appear as in FIG. 88.

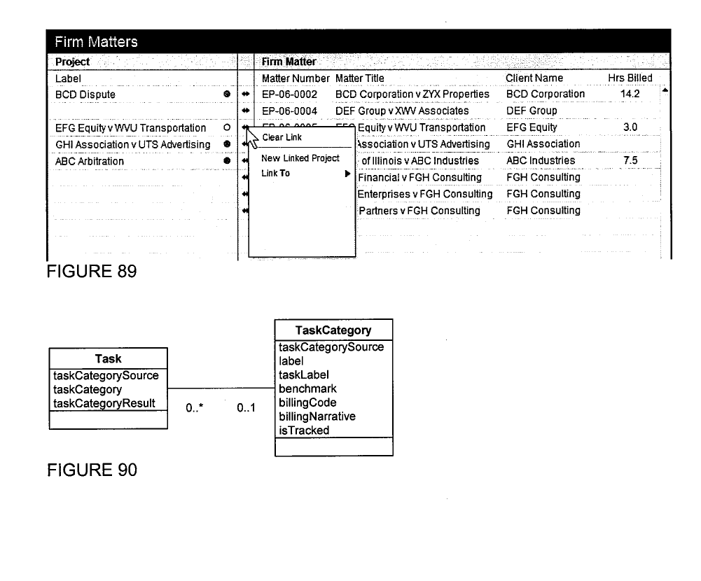

FIG. 89 illustrates the Contextual Link Menu as it appears when the user clicks the Link Icon on a line in which a link has already been established between an internal project record and an external project record. In addition to the options described above, the menu includes an option labeled ‘Clear Link’. If the user clicks ‘Clear Link’, the system will erase the externalProjectID value in the internal project record. The data link will thus be destroyed and the internal project record listed on the left will disappear from the list. In the example shown in FIG. 89, clicking the ‘Clear Link’ option will cause the system to automatically dismiss the pending internal project record labeled ‘EFG Equity v XVU Transportation’ by changing its status to ‘Dismissed’. The pending record was created by the system automatically to help the user establish such a link, and since the user has not changed the status of the record to ‘Active’, clearing the link indicates that the user does not want to use the record. If the internal project record was not a pending record, the system would clear the link but leave the status of the internal project record unchanged. In FIG. 89, if the user selects ‘New Linked Project’ or selects a project label under the ‘Link To’ option, the system will clear the current link before establishing the new one. In this case, when clearing the link, the system will also automatically dismiss the pending internal project record.

The External Project Details Form shows the available details from a single external project record. The appearance of the External Project Details Form is similar to the appearance of the internal Project Details Form.

In the same way that internal project records can carry references to external project records, internal task records can carry references to external task records using index values taken from the external lists. The corresponding structures, methods, and GUI elements are almost identical and include: the ExternalTask class, automatic record-creation features, automatic synchronization features, an External Tasks List (including an ‘External Records Only’ view and a ‘Task Links’ view), and an External Tasks Form. Similarly to the Project class, the Task class includes an externalTaskSource attribute that supports configurations in which multiple external sources are available. The use of links between internal task records and external task records allows the user to manage data from external calendars and from other external scheduling and management systems-in addition to personal tasks-in a single list within the organizer itself. For instance, a lawyer's view of the Tasks List could contain: tasks that have been assigned for client matters in the firm's central project management system; dated events from a number of shared calendars throughout the firm; meeting dates from group scheduling resources; key dates from an external CLE-tracking system; personal tasks and events; and other useful information.

By supporting and utilizing external links in this way, the system provides the user with a single place to manage all of the dated and undated activities in his or her life, including all tasks, events, and goals.

The GUI elements that support external task links are very similar to the analogous GUI elements that support external project links. Specifically: the Tasks List includes columns that display the index values of linked external task records and other external data related to the external linked task records; the Task Details Form includes features for creating, changing, and clearing links to external task records; the system includes an External Tasks List with two layouts—one layout shows the external list only and the other layout displays the links between internal records and internal records and provides features for managing the links; and the system includes an External Task Form that allows the user to view the available details associated with a selected external task record.

In addition to supporting record-links to records in remote lists, the organizer can support record-links among records within the organizer itself (i.e. within the same instance and/or user setup).

The organizer can support record-links among records from different modules and/or lists-i.e. among different kinds of records, such as among project records and task records-for the purpose of providing the benefits of relational data management, including the ability to see relational views of information.

The organizer can also generally support record-links among records from the same list for the purpose of “nesting” records-e.g. to represent a “master project/subproject” relationship between two records.

The system allows organizer task records to be associated with centralized category definitions. Such category definitions will typically be managed in lists on enterprise-oriented applications, although they may be managed elsewhere. In a typical configuration, each task record can be associated with one category. Although it is possible to configure the organizer to allow each task to be associated with more than one category, the following description assumes that any given task will be associated with no category or with one category. Also, although categories may be used in association with tasks, the system can be configured to support the association of projects with categories, as well. Such categories are referred to as project categories. Furthermore, similar features for associating organizer records with centralized lists of categories may be provided in other modules, as well-e.g. for categorizing folders, files, e-mail items, contact records, and other types of records according to centralized category definitions.

On the collaborative level, activity categories are primarily used to track the activities of users according to shared sets of standards-i.e. centralized lists of categories. A common example is the use of standardized benchmarks to track associate activities throughout a firm. In this case, the use of categories can build a detailed, indexed work history for every associate throughout a firm.

The use of categories in the system is, in many ways, similar to the use of links to external project and task records. In fact, categories may be regarded another source of external links, albeit of a somewhat different sort. Like external projects and external tasks, categories are managed on shared lists that are ‘external’ from the perspective of the personal organizer application. Standardized category lists exist in the ‘centralized zone’ along with all other centralized enterprise data, such as centralized project databases and centralized task/event calendars. Task-category lists are generally maintained by one or more dedicated components that service the TaskCategory class. A single user may connect multiple tasks to a single category.

A category may be assigned automatically in certain situations, such as when a task is automatically created in a user's personal organizer in response to changes on an external calendar. For instance, if a task is delegated to a user in a centralized project management system, Tekton can automatically create a corresponding task record in the user's personal organizer, and a category can be automatically assigned depending upon the nature of the task that has been assigned.

Centralized categories are generally managed in centralized systems (i.e. enterprise systems or other shared systems). However, the system can be configured to allow individual users to add their own categories to centralized lists. The organizer can also be configured to use personal category lists that are managed entirely by the individual user who uses the categories.

Centralized lists of categories may be populated manually by a user who acts as a coordinator on behalf of the user's enterprise, or lists of categories may be imported from external sources such as external content-delivery systems.

In addition to standardized activity tracking, categories can be used for other purposes, as well. For instance, categories can be used to offer data-entry shortcuts in the form of predefined text labels and billing narratives.

Categories can be used to perform rule-based activity tracking that utilizes exception reporting. For example, the system can be configured with rules that state ‘each associate must perform an activity in category X every 90 days’. Each associate can then be required to do the following at least once every 90 days: create a task record and select category X, perform the task, and retire the task and confirm that the task was performed successfully. Then, the system can perform exception reporting and alert a coordinator when any associate does not act accordingly.

The system can be configured to require users to confirm the completion of some or all categorized activities when retiring corresponding task records. That is, when an uncategorized task is retired, the task may simply disappear from the user's list of active tasks immediately; however, if a task has been associated with a tracked category, when the user retires the task record, the system can prompt the user to indicate whether or not the task was actually completed successfully. Prompting for results-confirmation in this way protects the validity of the activity-tracking data by not assuming that every scheduled activity is indeed performed and completed.

Categories can be configured to ‘deliver’ related sets of data, as well. For instance, if a user creates a new task and selects a category labeled ‘Brief Preparation (Unassisted)’, the selection of the category may also associate the task record with: a related benchmark definition labeled ‘Unassisted Preparation of a Legal Brief’; a task label consisting of the single word ‘Brief’ that the user can use, if desired; a specific date type—in this case, ‘Due Date’, since the task date will presumably indicate when the legal brief is due; and/or a billing code accompanied by an editable billing narrative that can be forwarded from the organizer with other time-billing information.

Group 4 design elements relate to features for managing and using task categories. Analogous design elements may be implemented in other organizer modules and in other applications, as well.

Group 4 design elements include: three attributes of the Task class, including taskCategorySource, taskCategory, and taskCategoryResult; a TaskCategory class; seven attributes of the TaskCategory class, including taskCategorySource, label, taskLabel, benchmark, billingCode, billingNarrative, and isTracked; the association between the Task class and the TaskCategory class. Static Structure

FIG. 90 shows a use case diagram indicating the static structure of the Group 4 design elements. FIG. 90 indicates that each task record can be associated with up to one task category (although the system can also be extended to support multiple categories per task); each task category can be associated with any number of task records; and each task record can indicate the source of the associated task category.

The taskCategorySource value indicates a specific collection of task category records. Such collections may be implemented in various ways. For instance, a given ‘source list’ may consist of a subset of a larger list (a category of category records on a single master list of category records), or it may consist of a separate list of category records (the specific list of categories being the product of a subclass of the TaskCategory class). Each task category is given a label and may be associated with other pieces of information. For instance, a given task category may be associated with a task label, a benchmark, a billing code, and a billing narrative. Each task may also be designated as ‘tracked’ or ‘not tracked’, and the task record may carry information about the results of the activity for tracking purposes. The taskCategorySource attribute will only be used when more than one source of task categories is available for any given task record. Likewise, the taskLabel, benchmark, billingCode, and billingNarrative attributes will only be used in appropriate situations. (The system can be configured to exclude their use depending upon the needs of the users.) Furthermore, if the benchmark attribute is used, then the TaskCategory will probably be associated with a Benchmark class. See the section on the Benchmarks Component below for a description of the structure and use of the Benchmark class and its associations.

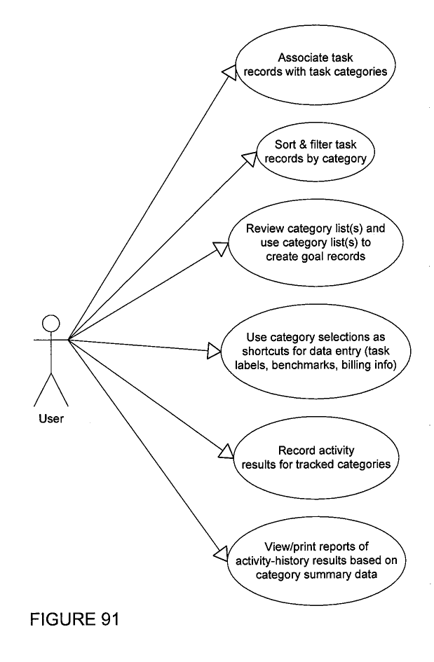

FIG. 91 presents a UML-style use case diagram that indicates the use cases associated with Group 4 design elements.

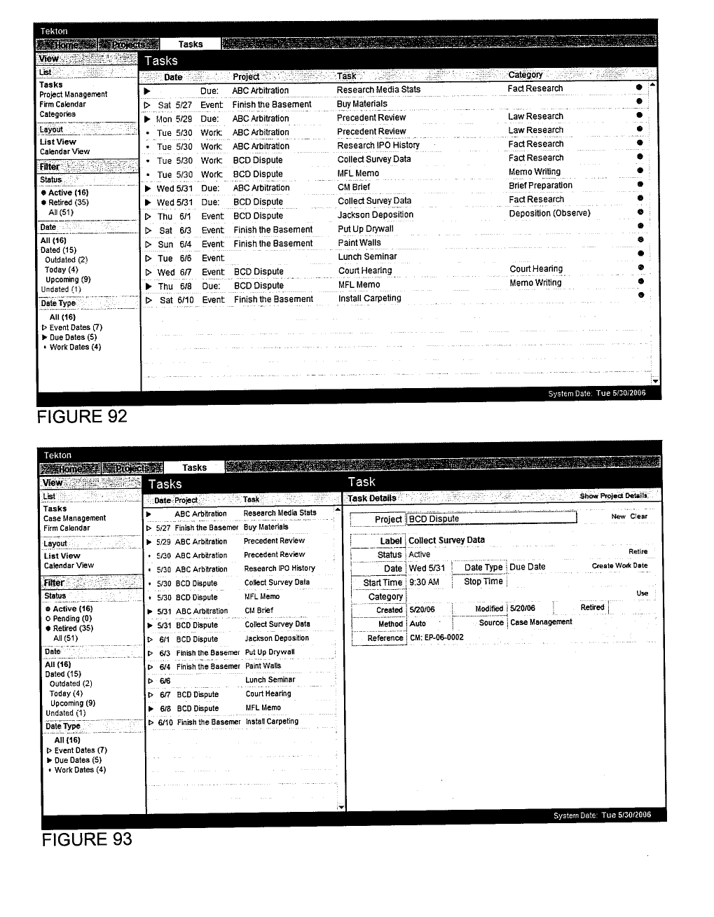

FIG. 92 shows a design for the Tasks List based on the inclusion of Group 4 design elements.

As shown in FIG. 92, the Tasks List includes a column labeled ‘Category’, which displays the category label for the category record (if any) that is associated with each task record.

FIG. 93 shows a design for the Task Details Form based on the inclusion of Group 4 design elements.

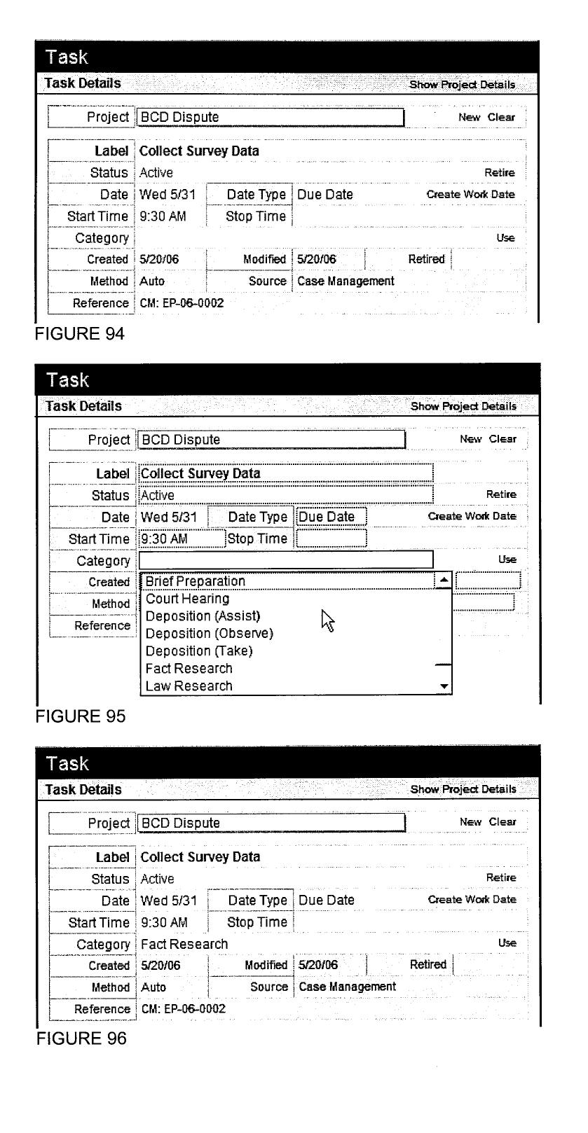

FIG. 94 shows a detail of the Task Details Form shown in FIG. 93. As shown in FIG. 94, the Task Details Form includes a field labeled ‘Category’. When the user clicks the Category field, a pull-down list of choices appears, as shown in FIG. 95. As shown in FIG. 95, the pull-down list presents the categories available from the centralized Task Categories list. The user can scroll through the list and click on any category to select it.

When the system is configured with more than one collection of categories to choose from, the Task Details Form will also include a ‘Category Source’ field. The value selected in the Category Source field will determine the options available in the Category pull-down list. The present example illustrates the Task Details Form in a configuration that includes only one centralized source list for categories; hence, no Category Source field is shown.

FIG. 96 illustrates a situation in which the user has selected a category labeled ‘Fact Research’. In FIG. 96, if the user clicks ‘Use’ (to the right of the Category field), the text from the Category field will be copied to the task label field (which has already been populated with the text ‘Collect Survey Data’). The ability to copy text from category labels to task labels allows categories to be used as a shortcut for data entry. For instance, if the task label field in FIG. 96 was still blank (because the user had just created the record), then the user could use the ‘Use’ button to populate the task label field with the words ‘Fact Research’ instead of typing the words. The task label field would still remain a user-editable text field, so the user could then edit the words ‘Fact Research’ if desired, perhaps adding a more specific descriptive phrase.

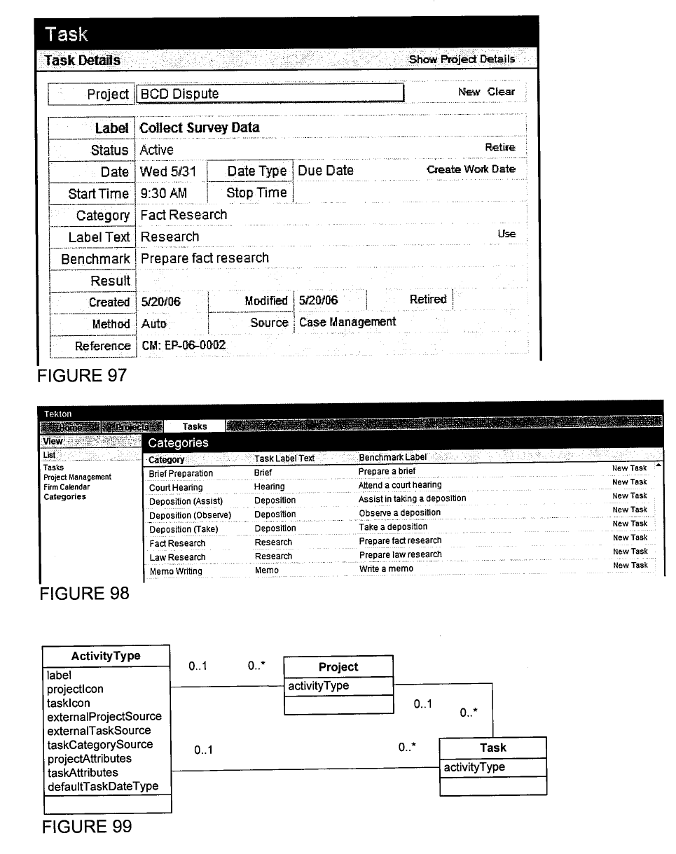

FIG. 97 shows a design for the Task Details Form based on the inclusion of the ‘extending attributes’ called taskLabel, benchmark, and isTracked. In FIG. 97, selecting the category labeled ‘Fact Research’ has caused the system to return related values for the ‘Label Text’ field (which corresponds to the taskLabel attribute) and the ‘Benchmark’ field (which corresponds to the benchmark field). That is, in the centralized Task Categories List, the category record labeled ‘Fact Research’ has been given a taskLabel value of ‘Research’ and a benchmark label of ‘Prepare fact research’. When the user selects the category labeled ‘Fact Research’, the associated values appear in the other corresponding fields. In FIG. 97, the ‘Use’ button (for copying a text value to the task label field) now appears next to the ‘Label Text’ field. As mentioned above, one of the benefits associated with categories is the ability to use categories as short-cuts for text data entry. However, the label of a task category record may not be a suitable choice for a task label. The taskLabel attribute allows the coordinator to provide an alternate snippet of text to present next to the ‘Use’ button. In FIG. 97, selecting the ‘Fact Research’ category has caused the Benchmark field to be populated with the text ‘Prepare fact research’, which is the label for a formal benchmark definition in yet another list-the Benchmarks List in the Benchmarks Component. (The Benchmarks Component is described in a later section.) The use of the Benchmarks Component does not necessarily require a separate Benchmark field, however. The Benchmarks List may itself be used as a source of task categories; in such a configuration, the ‘Category’ field is equivalent to the ‘Benchmark’ field-the categories are themselves benchmarks.

FIG. 98 shows a design for the Task Categories List, which the user can view by clicking ‘Categories’ in the options panel. The Task Categories List is analogous to the External Projects List and the External Tasks List in that it contains centralized data. The Task Categories List is managed by a coordinator. The Task Categories List provides a centralized index of values to which users can link organizer task records. As with other external lists, the user can view the list of available options. The Task Categories List displays the available categories as well as related information. In FIG. 98, the user can click ‘New Task’ on the right end of any line in the list to create a task record that will automatically be given the corresponding category. That is, if the user clicks ‘New Task’ on the top line of the illustrated list, the system will create a new task record and automatically assign to it the category labeled ‘Brief Preparation’.

Although not illustrated here, the Task Categories List can also contain columns that show summary data for the individual user that is viewing the list. For instance, the Categories List can include columns indicating: how many tasks the user currently has scheduled in each category; how many tasks the user has successfully completed in each category; the last date on which the user recorded the successful completion of a task in each category; and other information.

If the category for a given task record is defined as a ‘tracked’ category (e.g. if the Boolean is Tracked attribute value is set to 1 or ‘yes’), then the user may be required to indicate whether or not the activity was successfully completed when the user retires the record. That is, if the user creates a task record and selects a category that is tracked-perhaps a benchmarking category that is tracked for professional development purposes-then when the user retires the record, the system will require the user to indicate whether or not the task was completed successfully. The user is required to indicate the results of the activity because, otherwise, the system would simply assume that all scheduled activities were completed successfully; such an assumption would inevitably produce useless (garbage) tracking data.

Activity types are used to organize the system's functionality, simplify the GUI, and keep the system intuitive. Activity types are not necessary for the organizer to deliver its primary functionality, but they can help to manage the complexity of the system from the user's point of view.

When an ActivityType is not specified, the project record or task record may be left un-typed (activityType=<null>) or the record may be given a type labeled ‘Generic’.

The Group 5 design elements relate to the features associated with activity types.

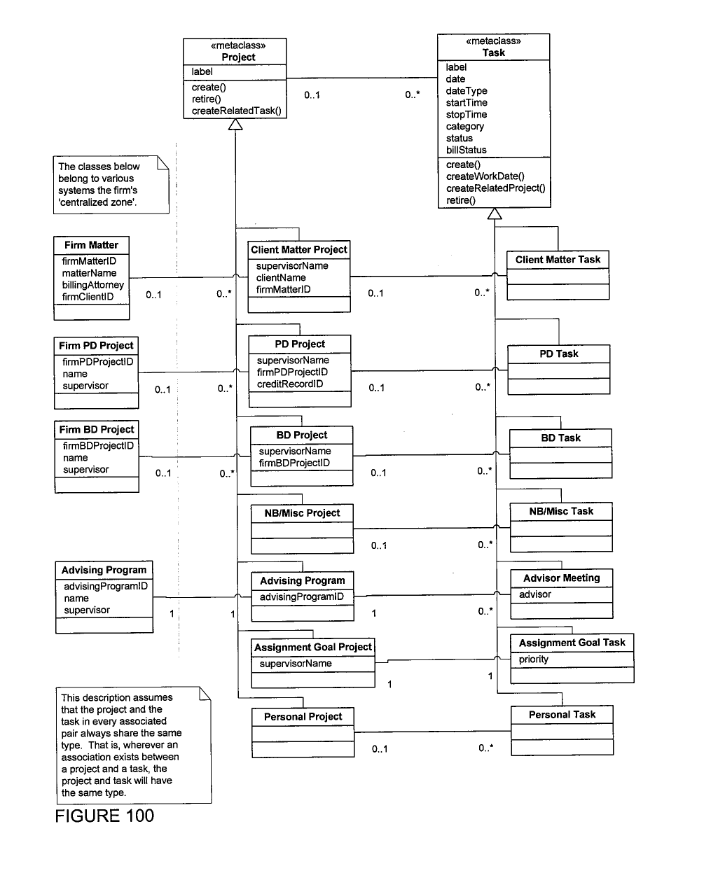

FIG. 99 and FIG. 100 present UML-style class diagrams illustrating the static structure of the Group 5 design elements.

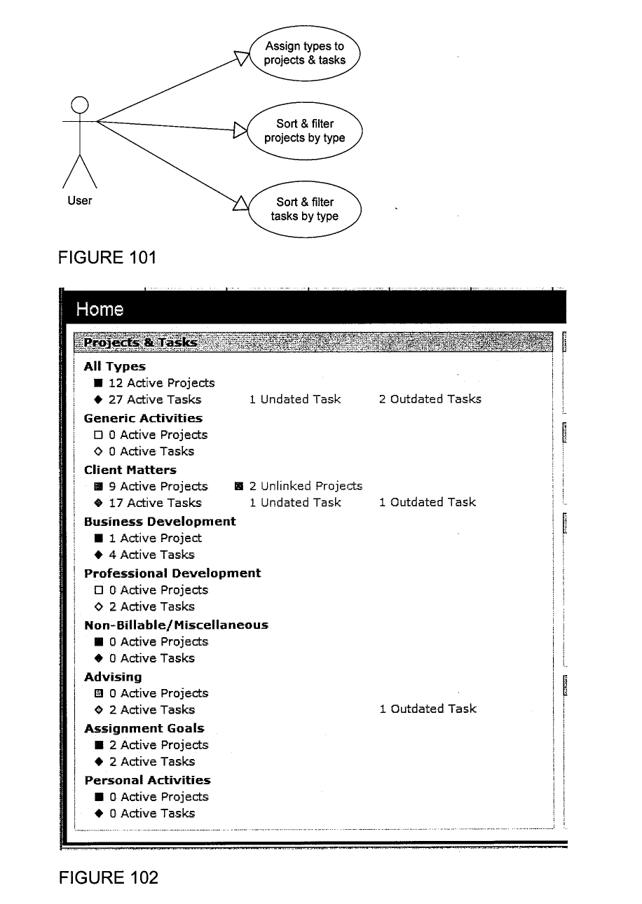

FIG. 101 indicates some of the use cases generally associated with activity types.

FIG. 102 shows a design for a summary panel that displays information about activities (projects and tasks) according to designated activity types.

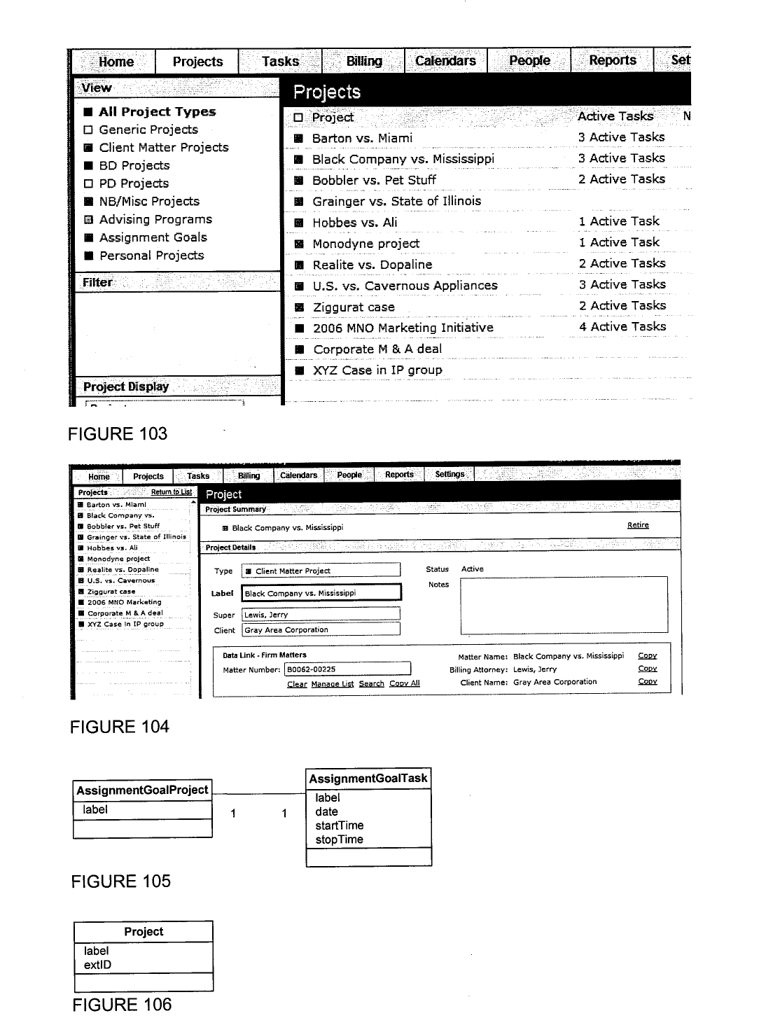

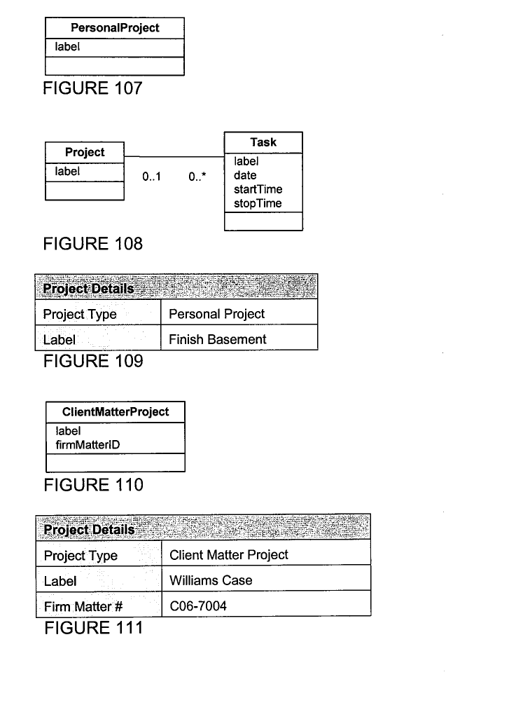

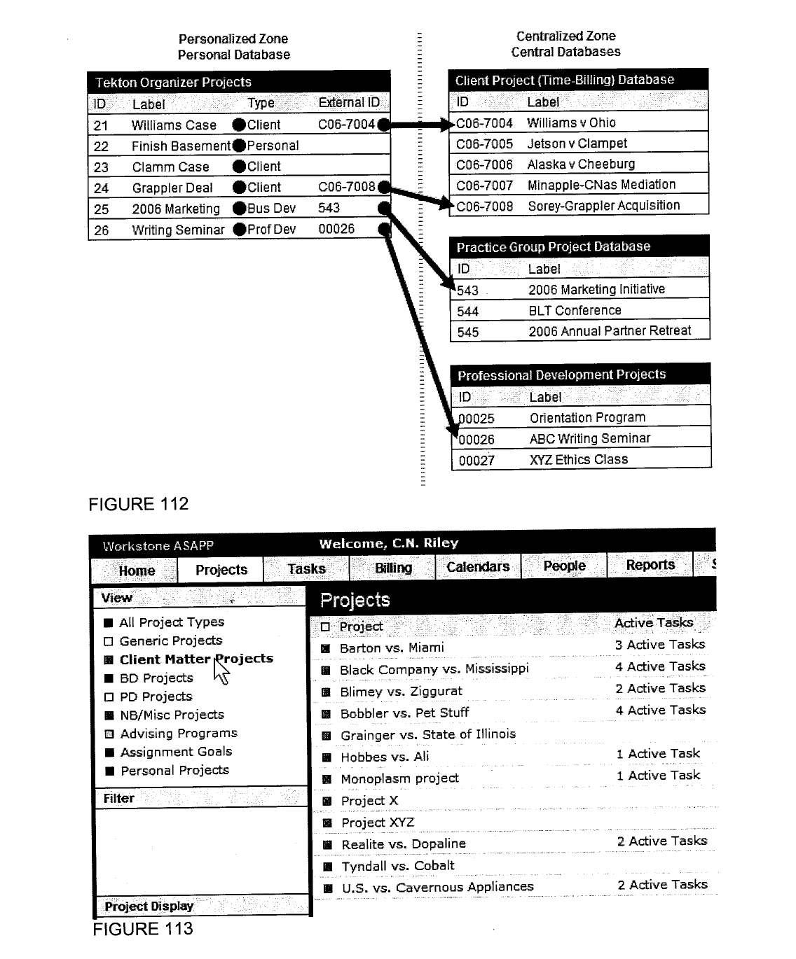

FIG. 103 shows a design for a Projects List (including an options panel and list panel) based on the inclusion of Group 5 design elements.

FIG. 104 shows a design for a Project Details Form based on the inclusion of Group 5 design elements. FIG. 104 illustrates the display of the details for a project that has been assigned an activity type called “Client Matter Project”. In the illustration, project records with the “Client Matter Project” type are extended to include information about: the supervisor assigned to the project; the name of the client associated with the project; and an index value in the form of a matter number that links the displayed organizer project record to a record in an enterprise system. The index value is used to retrieve additional information related to the project from the enterprise system, including the enterprise's official name for the matter, the billing attorney associated with the matter, and the firm's official name for the associated client.

The following section provides more information about the features and benefits associated with the use of activity types in a typical configuration of the system.

The Activities module group of the organizer generally allows the user to define and manage projects and tasks. Projects may given labels and are generally used to group tasks together. Tasks may be given labels, dates and times. In certain cases, other kinds of information can be attached to project and task records, as well.

In a system configured to use activity types, each activity type may be an instantiated object of the ActivityType class. Types are generally defined at configuration time. The ActivityType class is one of the features that make the system “gracefully extensible”.

Type definitions can be used to extend and modify the functionality of system in a number of areas, including: record creation processes; record retirement processes; attribute profiles; record-linking (including the use of categories); activity tracking; rule-based data sharing; and others. This is true of the use of item types by the system more generally, as well. Activity types are one type of item type that may be used in the system. That is: the Activities module group typically includes the Projects module and the Tasks module; when the Activities module group is configured to use item types, the item types are referred to more specifically as “activity types”. Item types are generally configured either at the module-group level or at the module level; item types may be configured for various combinations of modules. Activity types are generally configured at the “module-group level”, because the organization of projects and tasks is generally well-served by sharing a single list of types among project records and task records-that is, it may be deemed easier and more useful to manage projects and tasks according to a single set of activity types. In contrast, in the Content module group it may be preferable to configure item types for individual modules or for pairs of modules, but not for the entire module-group-e.g. one set of item types may be shared by the Folders module and the Files modules, while another set of item types may be configured for the E-mail module.

For the Activities module-group, type definitions are typically stored in an Activity Types Table. One column in the Activity Types table generally contains the name of the type-the label that the user sees on the screen. In a typical configuration for a law firm, the names of the types might include: Client Matter; Professional Development; Business Development; Non-Billable/Miscellaneous; Advising; Assignment Goals; and Personal.

Other columns in the Activity Types Table may include references to icons, ‘attribute profiles’, and code objects. The contents of the Activity Types Table are used to determine the specific attributes, methods and GUI elements associated with each activity type.

The ActivityType class is used to extend the Project and Task base classes (superclasses) to produce the project and task types (typed records) with which the user interacts. Project and task types are subclasses of the Project and Task base classes (superclasses). The subclasses are configured by modifying the contents of the Activity Types table. The project and task types are generally defined at configuration time by modifying the contents of the Activity Types Table and/or by modifying any objects to which the Activity Types Table may refer.

In practice, activity-type definitions can influence or determine, in whole or in part: how projects and tasks are created (possibly including the assignment of default values, the triggering of associated processes or events, etc.); how projects and tasks of the same type relate to one another; how projects and tasks are retired; to which system a given external ID refers; how projects and tasks can be tracked (including through exception reporting); how project and task data is shared (who can see what); how projects and tasks are displayed; and other factors.

Note: Item types configured for other modules are generally used in analogous ways to the use of activity types in the Projects and Tasks modules. That is, item types are generally used to extend the base classes of one or more modules. The extension of the base classes generally involves the creation of subclasses that possess more specialized features, such as special attributes and/or behavior. For instance, item types may be configured for the Folders module to allow the user to designate some folders as Shared Folders and some folders as Private Folders, where Shared Folders would be visible to coworkers and Private Folders would not.

In cases where item types are shared by two or more modules, the record-creation and/or record-linking procedures can generally be modified by type definitions in such a way that the association between the respective classes is effectively altered. For instance, an activity type can be configured in such a way that all projects and tasks of that type are automatically created in permanently linked, exclusive pairs. While projects and tasks more generally support both unlinked items and one-to-many relationships, in certain cases, it may be useful to restrict those options. FIG. 105 illustrates such an arrangement. The ‘locked-pair’ situation is achieved as follows: an Assignment Goal activity type is configured such that when the user creates an Assignment Goal-type project, an Assignment Goal-type task record is created automatically, and the association is created automatically. The activity type definition also modifies the GUI presentation of the records such that user is not given an opportunity to modify the relationship between the pair. Furthermore, the project and task records are retired simultaneously.

In the same way that an item type can be configured to modify a standard record-creation procedure, an item type can also be configured to modify a standard record-retirement procedure.

Retiring a record generally causes the record status to change from ‘Active’ to ‘Retired’. Also, the ‘retire date’ is generally recorded. In many cases, additional functions may be performed as well.

For instance, when an associate in a law firm retires an ‘Advisor Meeting’-type task, before retiring the record, the system may ask the associate if the scheduled meeting did in fact occur. The associate can click ‘Yes’, ‘No’ or ‘Cancel’. If the associate clicks ‘Yes’ or ‘No’, the answer is recorded and the record is retired. If the associate clicks, ‘Cancel’, nothing happens, and the record remains active.

Item types can be configured to change the sets of attributes that are possessed by the associated records. As a result, different types of projects and tasks may have different sets of attributes. The different types are produced by extending the Project and Task base classes to include specialized sets of attributes. A variety of ‘attribute profiles’ (sets of attributes) can be produced using permutations of a small number of base attributes that can be handled in different ways.

Activity types can also be used to support and simplify record-linking features. An activity type definition can determine whether or not the associated project and task records will support record-links to remote databases; if the project and/or task records do support record-linking to remote databases, the activity type definition may include information about the remote data source, such as the network address and “friendly name” of the data source.

The use of item types in conjunction with record-linking makes it possible for individual organizer lists to support references to multiple remote systems and yet be simple to use and easy to navigate.

FIG. 2 illustrates the use of activity types in conjunction with inter-application record-linking. In FIG. 2, projects 21, 23 and 24 are ‘Client’-type projects; the values in the External ID fields are understood as referring to records in the firm's Client Project Database (which may be a time-billing system, a project management system, or elsewhere). Note that the reference (external ID value) is optional, however; project 23 has no such reference. Project 25 is a business development project, and since (in this example) business development projects are defined at the practice group level, the external ID number ‘543’ is used to point to the Practice Group Project Database. Project 26 corresponds to a project that is centrally defined in the Professional Development Projects database. Project 22, as a ‘Personal’-type project, will not correspond to any record in any of the firm's central databases; thus the user will not be presented with GUI features for creating such a reference. That is, on the ‘Project Details’ form for a personal project, the user will not see a field for selecting an external ID.

As with projects, tasks can be linked to centralized tasks and events in external project management systems and external calendars. Tasks can be given categories; the category lists can be set up centrally and thus standardized for tracking throughout the firm. Structurally, the relationship between Tekton tasks and centralized categories is almost identical to the (Internal)Project-ExternalProject relationship and the (Internal)Task-ExternalTask relationship as describe in the External Links section above.

Item types may be used in conjunction with business rules for tracking activities and for producing exception reports against indicated requirements. For instance, an ‘Advisor Meeting’ activity type may allow coordinators to “passively” monitor the meeting activities of associates and advisors in a managed advising program. In such a program, associates may be required to meet with advisors once a month. Each associate who is required to have meetings may have a flag (checked box) in his or her user profile labeled ‘Required to have advisor meetings’. Elsewhere, in a ‘control settings’ panel, a coordinator can indicate that: ‘Required advisor meetings should occur every [30] days’. (The [30] represents a parameter that coordinators can change at runtime through the user interface.) The system can then periodically check to see if each associate that requires advisor meetings has a meeting scheduled sometime in the next 30 days. If not, the system may send an automatic e-mail to the associate reminding the associate to schedule an advisor meeting. Also, the associate's name may appear on an exception report that is viewed by the program's coordinator.

Activity Types can be used in conjunction with user roles, user relationships, and other data elements to support controlled data-sharing.

In the system, each user may be assigned one or more roles. Also, the system may support information about relationships between individual users. For instance, a user might be a Partner, and that Partner might be designated as the Advisor for a particular Associate. Roles and relationships help determine access rights for different kinds of data. For instance, the Practice Group Leader in a law firm might be able to see details about the business development activities of Partners and Associates in the same practice group but not be able to see similar data for Partners and Associates in other practice groups. To support this, the firm's system will be configured with an ActivityType called ‘Business Development Activities’. Users will be able to create BusinessDevelopmentProject records and BusinessDevelopmentTask records. The Practice Group Leader will have access to details of those records for users in the same practice group.

The Group 6 design elements support the use of user roles and user relationships in the system.

FIG. 125 illustrates the static structure of the Group 6 design elements.

Note: The system may require an ExternalUserID class to translate user IDs between Tekton and external systems. GUI Elements

User roles and user relationships are used to support the controlled sharing of information between users. User roles are also used within the context of general system security.

Some system resources and/or information may only be available to users with certain roles. For instance, in a law firm, some reports and/or document libraries may only be available to Partners.

Access to some system resources and information may be controlled by relationships between users. For instance, in a law firm, a partner may be able to see the comprehensive, detailed work history of an associate only if the partner is indicated as the associate's Advisor.

Role and relationship definitions may be managed centrally in a server-based application and/or be managed in a distributed “ad hoc” manner by individual instances of the personal organizer application.

The Group 7 design elements relate to features that support time-reporting from the organizer application.

FIG. 118 illustrates the static structure of the Group 7 design elements.

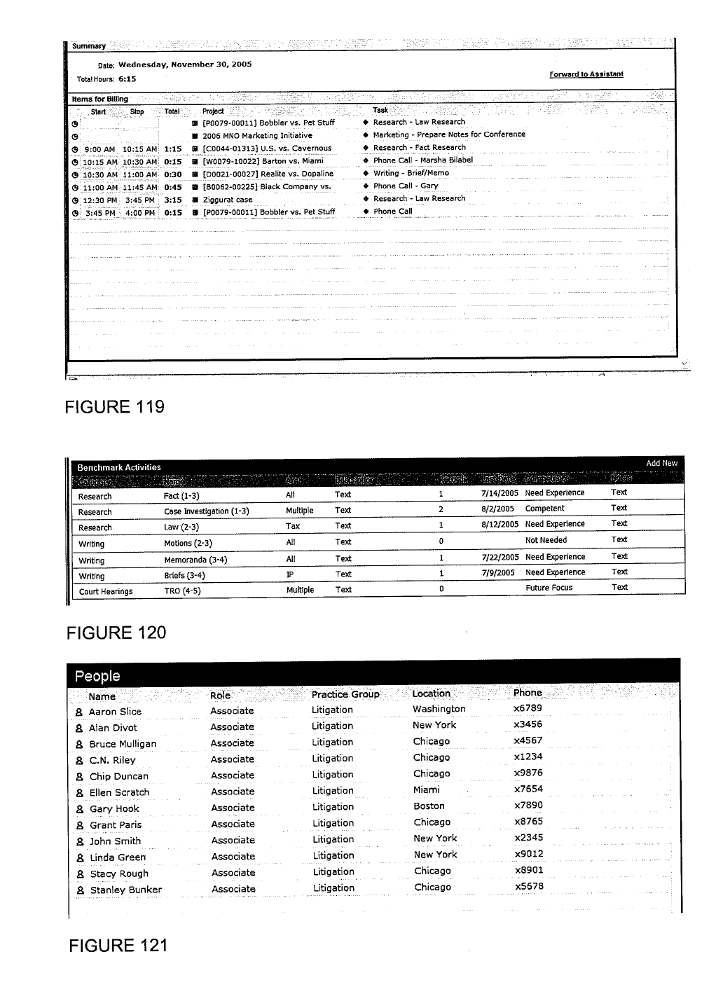

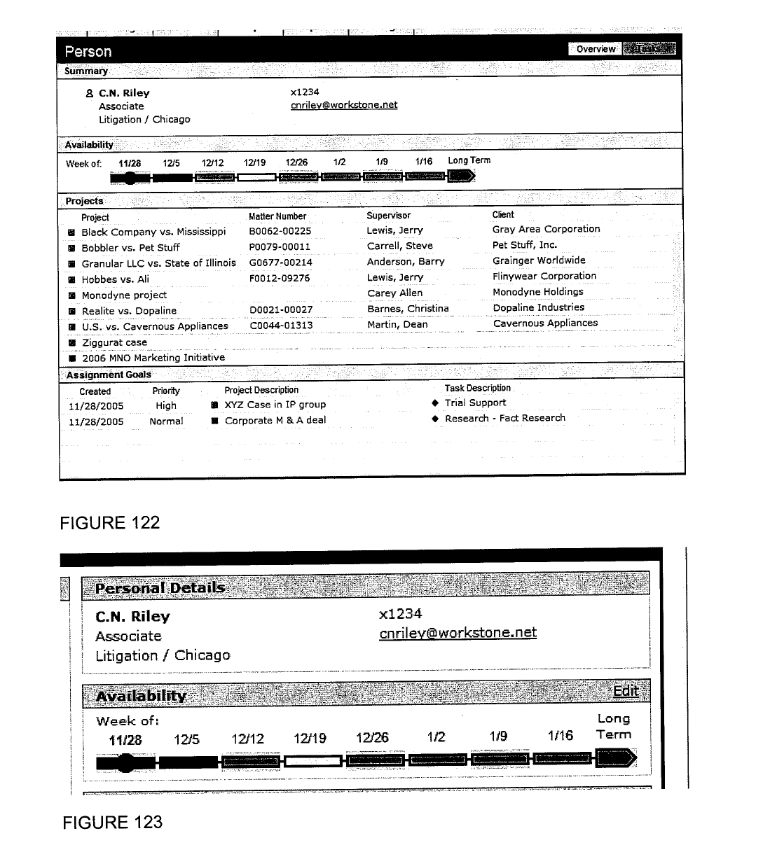

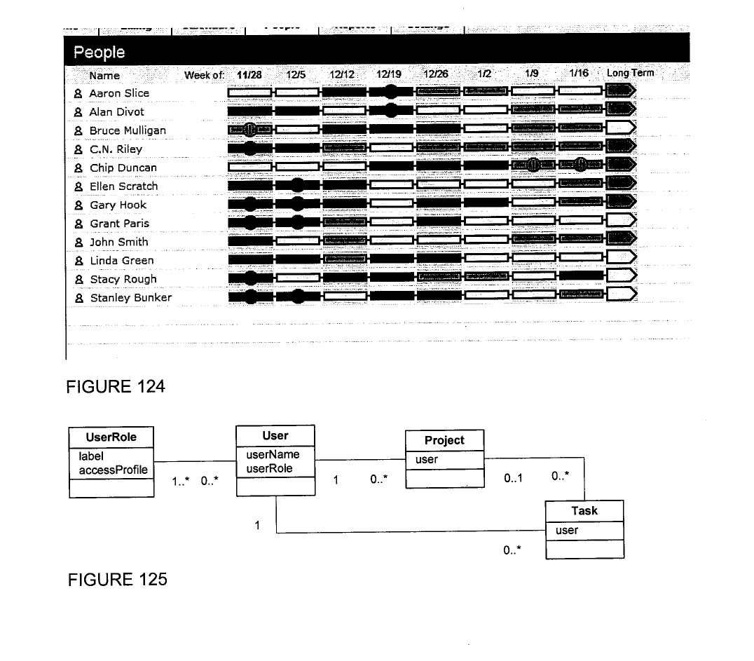

FIG. 119 illustrates a design for a graphical interface to support time-reporting from the organizer.

The organizer supports a two-step process of time-reporting that supports the actual workflow in many professional firms and allows professionals and their assistants to collaborate more effectively to bill clients in an effective and accurate manner. The interface illustrated in FIG. 119 is designed to allow users to use information from the organizer (including the tasks list, the projects list, and the clients list) to construct a “good-enough” record of their work activities and forward the information to an assistant, who can complete and correct the information before sending it to the central time-billing system. The graphical interface provides the user with convenient tools for inputting and editing data.

The system may provide other features similar to the time-reporting features for various types of activity-reporting. Such features would allow the user to prepare and submit activity reports for: clients; firm or company management (utilization reports); professional development directors; professional accreditation bodies; marketing departments (press-release material); etc.

The Group 8 design elements relate to task-delegation features.

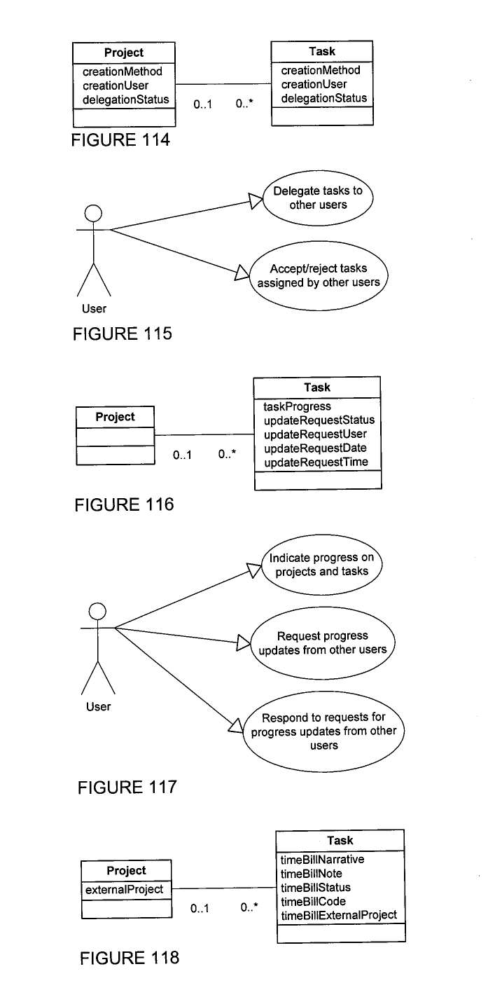

FIG. 114 illustrates the static structure of the Group 8 design elements.

FIG. 115 indicates some of the use cases associated with the Group 8 design elements.

The Group 9 design elements relate to features that allow users to send “progress-update requests” to coworkers and respond to such requests.

FIG. 116 illustrates the static structure of the Group 9 design elements.

FIG. 117 indicates some of the use cases associated with the Group 9 design elements.

The organizer may support the tracking of professional-development “benchmarks” through features that are integrated with the Projects and Tasks modules (including the tasks list and calendar). The tracking of benchmarks may be accomplished by relating organizer task records to centralized benchmark definitions.

FIG. 120 illustrates a design for a graphical interface that allows a professional development manager to manage a list of benchmark definitions. The Benchmarks List is stored at the enterprise level and functions as a standard list of categories that serve as record-link targets for personal organizer records.

A related GUI feature includes a pull-down menu in the Task Details Form of the organizer that serves as a shortcut for task labeling that simultaneously ‘tags’ tasks according to a centralized list.

The benchmark-tracking features support the tracking of professional-development-related activities from within associates’ calendars. The benefits include streamlined professional-development tracking and enhanced professional development planning.

The Parties Module Group

In a typical configuration, the organizer will include a Parties module group. The Parties module group will generally include a Companies module and a People module, and it may include other modules. The Companies module may alternatively be called Organizations.

The Companies module generally provides features for managing information about companies and other organizations. A typical Company record may include: the name of a company; the location of the company; phone numbers for the company; the primary website address for the company; and other such information.

The People module generally provides features for managing information about people. People records may also be called “contact records”. A typical Person record may include: the name of a person; street addresses of the person; phone numbers for the person; e-mail addresses for the person; and other such information.

Company and Person records will generally support both intra-application record-linking (linking organizer records to other organizer records) and inter-application record-linking (linking organizer records to corresponding records in remote data sources). Any such linking will generally not be required unless the system is configured to provide specialized functionality.

The Companies module and the People module will generally support configurations based on item-type features. That is, the organizer can generally be configured such that Companies and People are managed according to party types. In the Companies module, configured party types are generally regarded as company types. In the People module, configured party types are generally regarded as person types. In general, party types configured in the Parties module group will provide features and benefits analogous to those provided by the configuration of activity types in the Activities module group. A typical configuration of the system may include company types and/or person types called “Clients”, “Vendors”, “Prospects”, “Competitors”, “Others”, and “Personal”. Company types are generally used to extend a Company base class; such extensions (subclasses) may possess specialized attributes, methods, and GUI features, and some or all of them may support record-linking to one or more remote systems. For instance, a Company record of the company type “Client” may include a record-link to a corresponding record in an enterprise time-billing system, allowing the user to view current billing information for a selected client within the personal organizer. Similarly, Person types will generally be used to extend a Person base class; such extensions (subclasses) may possess specialized attributes, methods, and GUI features, and some or all of the subclasses may support record-linking to one or more remote systems.

The Content Module Group

In a typical configuration, the organizer will include a Content module group. The Content module group will generally include a Folders module, a Files module, an E-mail module, and a Web Content module, and it may include other modules.

The Content module group generally provides features for managing electronic content (such as documents and media files) and metadata related to that content.

The Folders module generally provides features for managing folders of documents and other content in local and remote locations.

Folder records will generally support both intra-application record-linking (linking organizer records to other organizer records) and inter-application record-linking (linking organizer records to corresponding records in remote data sources). Record-links to remote data sources will generally support automatic synchronization between organizer records and remote records. Any such linking will generally not be required unless the system is configured to provide specialized functionality.

The Folders module will generally support configurations based on item-type features. That is, the organizer can generally be configured such that Folder records are managed according to folder types. In general, folder types configured in the Folders module will provide features and benefits more or less analogous to those provided by the configuration of activity types in the Activities module group. A typical configuration of the system may include folder types such as “Shared” and “Personal”. Folder types are generally used to extend a Folder base class; such extensions (subclasses) may possess specialized attributes, methods, and GUI features, and some or all of the subclasses may support record-linking to one or more remote systems.

In a typical configuration of the system, the Folders module may provide features such as: linking folders of files to project records and/or task records; sharing folders among groups of users; adding metadata to folders, such as categories, project references, keywords, and text descriptions of the contained material; and convenient access to local and remote folders.

The Files module generally provides features for managing documents and other files stored in local and remote locations, as well as related metadata.

File records will generally support both intra-application record-linking (linking organizer records to other organizer records) and inter-application record-linking (linking organizer records to corresponding records in remote data sources). Record-links to remote data sources will generally support automatic synchronization between organizer records and remote records. Any such linking will generally not be required unless the system is configured to provide specialized functionality.

The Files module will generally support configurations based on item-type features. That is, the organizer can generally be configured such that Folder records are managed according to folder types. In general, folder types configured in the Folders module will provide features and benefits more or less analogous to those provided by the configuration of activity types in the Activities module group. A typical configuration of the system may include file types such as “Shared” and “Personal”. File types are generally used to extend a File base class; such extensions (subclasses) may possess specialized attributes, methods, and GUI features, and some or all of the subclasses may support record-linking to one or more remote systems.

In a typical configuration of the system, the Files module may provide features such as: linking files to project records and/or task records; sharing files among groups of users; adding metadata to files, such as categories, project references, keywords, and text descriptions of the files; and convenient access to local and remote files.

The E-mail module generally provides features for managing e-mail items, e-mail attachments, and related metadata.

E-mail records will generally support both intra-application record-linking (linking organizer records to other organizer records) and inter-application record-linking (linking organizer records to corresponding records in remote data sources). Record-links to remote data sources will generally support automatic synchronization between organizer records and remote records. Any such linking will generally not be required unless the system is configured to provide specialized functionality.

The E-mail module will generally support configurations based on item-type features. That is, the organizer can generally be configured such that E-mail records are managed according to e-mail item types. In general, e-mail item types configured in the E-mail module will provide features and benefits more or less analogous to those provided by the configuration of activity types in the Activities module group. A typical configuration of the system may include e-mail types such as “Business” and “Personal”. E-mail item types are generally used to extend an e-mail item base class; such extensions (subclasses) may possess specialized attributes, methods, and GUI features, and some or all of the subclasses may support record-linking to one or more remote systems.

In a typical configuration of the system, the E-mail module may provide features such as: linking e-mail items to project records and/or task records; sharing saved e-mails among groups of users; adding metadata to e-mail, such as categories, project references, keywords, and text descriptions of the e-mail items; and convenient features for managing e-mail attachments and archiving e-mail items. The organizer may provide a feature whereby e-mail items and attachments are interpreted according to content and metadata and are automatically linked to relevant organizer records, such as person records, company records, project records, task records, and other e-mail records.

The Web Content module generally provides features for managing web-based content, including URL's (hyperlinks), downloaded web content (such as saved web pages, saved “web clippings”, and saved media files) and related metadata.

Web Content records will generally support both intra-application record-linking (linking organizer records to other organizer records) and inter-application record-linking (linking organizer records to corresponding records in remote data sources). Record-links to remote data sources will generally support automatic synchronization between organizer records and remote records. Any such linking will generally not be required unless the system is configured to provide specialized functionality.

The Web Content module will generally support configurations based on item-type features. That is, the organizer can generally be configured such that Web Content records are managed according to web content types. In general, web content types configured in the Web Content module will provide features and benefits more or less analogous to those provided by the configuration of activity types in the Activities module group. A typical configuration of the system may include web content types such as “Visited Locations”, “Saved Hyperlinks”, “Web Pages”, “Web Clippings”, and “Media Files”. Web content types are generally used to extend a web content base class; such extensions (subclasses) may possess specialized attributes, methods, and GUI features, and some or all of the subclasses may support record-linking to one or more remote systems.

In a typical configuration of the system, the Web Content module may provide features such as: linking web content to project records and/or task records; sharing downloaded content among groups of users; adding metadata to web content, such as categories, project references, keywords, citations, and notes about the web content; and convenient features for managing hyperlinks and downloaded web content. One such feature may allow the user to visually drag-and-drop web content from a web browser to the organizer in order to save the content and link the content to other information in the organizer; for instance, dropping the web content onto a project record may cause the organizer to store the content and create a link between the target project record and the corresponding web content record. The system may also provide web-browser add-ons that add features to the user's web browser for capturing web content and transferring that content to the organizer.

The Facilities Module Group

In a typical configuration, the organizer will include a Facilities module group. The Facilities module group will generally include a Locations module, an Equipment module, and a Materials module, and it may include other modules.

The Facilities module group generally provides features for managing information about physical places and objects, such as business locations, specific rooms within buildings, equipment, and stores of raw materials and finished products.

The Business Processes Module Group

In a typical configuration, the organizer will include a Business Processes module group. The Business Processes module group will typically include modules that support accessing and managing information from remote data sources, such as specialized enterprise systems, that does not correspond to modules in other modules groups. For instance, the Business Processes module group may include a Billing module that allows the organizer to interact with an enterprise time-billing system.

General Organizer Application Features

In general, the organizer may support the creation of record links by allowing the user to drag-and-drop a visual representation of one record onto another, the system responding by adding a reference in the first record to the second record. The system may also provide other such user-interface features for creating record links. The user may generally be able to use any or all of those methods with a visual representation of a record anywhere that the visual representation of the record appears, such as: in inset lists on record-details forms; in places where the record is visually represented as part of the metadata related to a piece of content; and in places where a “tagged” or “recognized” reference to the record appears within documents and other data. In other words, the system may allow the user to create a link from one record to another by interacting with the visual representation anywhere that it appears.

In some cases, one or more modules may be configured to allow the user to create custom types for the user's personal use. The system may support custom item types by allowing the user to extend the base class of the module in such a way that the records associated with the custom type are structurally and behaviorally identical to the base class (i.e. they possess the same basic internal structure and the same basic functional behavior) but are identified as belonging to a separate type with a unique name, thus enabling the user to manage the associated records as a distinct subset of all records in the module. An example such a use of custom types in an example configuration of the system would be: the user's People module is configured to use item types that are more specifically “people types”; the people types configured for the system include Business Contacts and Personal Contacts; the Personal Contacts type extends the base Person class to produce the Personal Contact subclass in such a way that no special attributes or methods are added to the base class; rather, the person type definition simply allows the user to manage Personal Contacts as a subset of all of the user's People records; the user wishes to divide the records associated with the Personal Contacts type into three distinct groups, the groups including family, friends, and all other people; the user uses a graphical interface element to create two new custom person types named Family Members and Friends; the user can now edit the records containing information about the user's family members so that those records become associated with the Family Members type rather than the Personal Contacts type; likewise, the user can now edit the records containing information about the user's friends so that those records become associated with the Friends type rather than the Personal Contacts type; the user leaves the remaining records associated with the Personal Contacts type as they are; the user can then manage his or her personal contacts as three distinct sets using three person type designations—Family Member, Friend, and other Personal Contact—although the records belonging to all three of those types will otherwise be composed identically—i.e. they will be structured in the same way and will behave in the same ways.

The system may provide features that allow users to create and manage records in “batches”. Generally, the system will create batches of records by creating multiple records in which: one or more fields are assigned the same value in all batch-member records; one or more fields are given values that are varied according to one or more specified patterns or calculations; and all of the records are designated as belonging to the given batch. Record-batch features may be available for managing records belonging to any or all modules. For example, the system may allow the user to create and manage batches of task records to keep track of recurring events; the user may create a batch of records by first clicking a button labeled “Create a·batch of tasks”; the system would then display a “batch” variation of the input form used to create single (“one time”) task records; the task-batch-creation form allows the user to enter a text description of the recurring task (for instance, “Monthly board meeting”) and indicate the way in which the dates for the batch-member records should be calculate (for instance, telling the system, in effect, that the task records should “start on April 15th and recur once a month and end on June 15th”); the user may then click a button labeled “Create batch”, causing the system to create the corresponding task records (in the given example, three task records, each with the text description “Monthly board meeting”, with one dated April 15th, one dated May 15th, and one dated June 15th, and with each the same batch number). Creating records in batches allows the batch-member records to be edited both individually and collectively. For instance, in the case of the “Monthly board meeting” records, the user can reschedule the May 15th meeting to May 18th without affecting the other dates, because each of the three records is an individual task record; however, because the three records are identified as belonging to the same batch, they may also be edited collectively by “re-creating” some or all of the batch records; for instance, the user may click an “Edit batch” button next to any of the three “Monthly board meeting” task records; the system will then respond by opening the batch-definition form; the user can change the settings for creating the batch (for instance, to say now, in effect, “start on April 15th and recur once a month and end on September 15th”); the user may be given additional options, for instance allowing some records to remain unedited (for instance, allowing the user to indicate, in effect, “do not change the May 18th record”); the system then re-creates the batch accordingly; in the example given, the user would end up with six “Monthly board meeting” task records, each on the 15th of the month starting in April and ending in September, with the exception that the May meeting date would remain as the 18th. The benefits of the record-batch features generally relate to the ability to create groups of related personal organizer records that can subsequently be edited either individually or collectively. Record-batch features may also be provided elsewhere in the system, such as in the enterprise applications.

The system typically includes a set of components that allow the organizer to function as a web services consumer in such a way that information from web services and organizer information can be managed by the organizer in a fully-integrated manner; such information management features may include record-linking as well automatic mono-directional and/or bi-directional synchronization.

For deployments involving the use of desktop-client-based organizers (as opposed to web-based organizers), the system may provide “remote access” features for accessing the organizer from a remote computer.

In a typical configuration, the system may include “proxy access” features that allow the executive assistant of a user to access the user's organizer to help the user manage organizer information. When accessing the organizer via proxy access, the organizer may hide information designated as private.

In a typical configuration, the system may support integration with a corporate intranet and/or web-based collaboration systems.

The system typically includes a set of components that allow the system to provide information from the system (such as organizer data and enterprise data) to individuals and/or systems external to the enterprise in a controlled and secure manner, such as by means of a corporate extranet or an outgoing web service. For instance, a company using the system may provide its clients with user names and passwords that will allow the client to log on to a secure website over the Internet that will provide the client with controlled views of data from the company's system. In addition, a company's system may be configured such that the system will provide information directly to computer systems used by other companies (either another instance of the same system or different systems entirely) in a controlled and secure manner.

The Enterprise Server Application

The system will typically include a server application that will: communicate with instances of the organizer application; communicate with enterprise systems, web services and other data sources; support the controlled and secure sharing of data among users and related systems; provide system security features; manage user roles and relationships; and perform other functions.

Enterprise Applications

In a typical configuration, the system may include enterprise applications designed to function as fully-integrated parts of the system. Such applications may include: an enterprise project management application, an enterprise document management application, and other applications comparable to common types of enterprise systems.

Such systems will provide features designed to utilize the organizer's record-linking and data-synchronization capabilities in ways that will provide users with benefits such as increased productivity, improved communication, and enhanced decision-making.

An example of an enterprise application designed for use as part of the system is an enterprise project management application that allows a user such as an executive assistant to create project records at the enterprise level. In this example, the executive assistant can: create an enterprise project record; add team members to the project; assign roles to team members; create related task records to assign specific tasks to team members; link the project record to a record in an external time-billing system; link the project record to a folder in a document management system; populate the related folder with relevant documents; estimate and track budgeted resources related to the project; and perform other project-management activities. The system will deliver the project-related information to team member's organizers and keep the team members updated automatically. The system can also support communication and collaboration among the team members throughout the course of the project.

Developer Tools

The system provides a set of standardized interfaces that support dynamic communication with external, third-party systems. The standardized interfaces allow for the development of add-on components that can modify and extend the organizer's features (such as data structures, user interface elements, event handlers, and data-processing functions, among others) and allow the organizer to interact dynamically with external systems.

The system also includes an application programming interface (API) and a related software development kit (SDK) that enable developers to rapidly develop and/or adapt software solutions to take advantage of: the organizer's extensible architecture; the organizer's extensive record-linking capabilities; the organizer's ability to communicate with remote systems; and the organizer's automatic data-synchronization features.

The software solutions developed and/or adapted in conjunction with the system's API and SDK may include desktop applications, web-based applications, web services, and other kinds of software solutions.

In summary, persons of ordinary skill in the art will readily appreciate that methods and apparatus to combine data from multiple computer systems for display in a computerized organizer have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention not be limited by this detailed description of examples.

The invention is claimed as follows:

1. A method of maintaining a computerized organizer, the method comprising:
entering first organizer information into the computerized organizer;
entering first metadata into the computerized organizer, the first metadata indicating that the first organizer information is business type information;
storing the first organizer information in a first enterprise system because the first metadata indicates that the first organizer information is business type information;
entering second organizer information into the computerized organizer;
entering second metadata into the computerized organizer, the second metadata indicating that the second organizer information is personal type information;
storing the second organizer information in a non-enterprise system because the second metadata indicates that the second organizer information is personal type information;
entering third organizer information into the first enterprise system;
transmitting the third organizer information from the first enterprise system to the computerized organizer;
entering fourth organizer information into a second different enterprise system;
transmitting the fourth organizer information from the second enterprise system to the computerized organizer; and
displaying the first organizer information, the second organizer information, the third organizer information, and the fourth organizer information via the computerized organizer.

2. The method of claim 1, wherein the first organizer information is contact information including a name, an address, a phone number, and an e-mail address.

3. The method of claim 2, wherein the second organizer information is task information including a task description and a due date.

4. The method of claim 2, wherein the second organizer information is appointment information including an appointment description, a time, and a date.

5. The method of claim 1, wherein the first organizer information is task information including a task description and a due date.

6. The method of claim 5, wherein the second organizer information is appointment information including an appointment description, a time, and a date.

7. The method of claim 1, wherein the first organizer information is appointment information including an appointment description, a time, and a date.

8. The method of claim 1, wherein the first enterprise system is a customer relationship management system and the second enterprise system is a time-billing system.

9. The method of claim 1, wherein the first enterprise system is a document management system and the second enterprise system is a time-billing system.

10. The method of claim 1, wherein the first enterprise system is a web services based system.

11. The method of claim 1, wherein the computerized organizer is web based.

12. An apparatus for maintaining a computerized organizer, the apparatus comprising:
a processor;
a memory device operatively coupled to the processor;
a user input device operatively coupled to the processor;
a network device operatively coupled to the processor; and
a display device operatively coupled to the processor; wherein the memory device stores a software program to cause the processor to:
receive first organizer information into the computerized organizer;
receive first metadata into the computerized organizer, the first metadata indicating that the first organizer information is business type information;
store the first organizer information in a first enterprise system because the first metadata indicates that the first organizer information is business type information;
receive second organizer information into the computerized organizer;
receive second metadata into the computerized organizer, the second metadata indicating that the second organizer information is personal type information;
store the second organizer information in a non-enterprise system because the second metadata indicates that the second organizer information is personal type information;
receive third organizer information into the first enterprise system;
transmit the third organizer information from the first enterprise system to the computerized organizer;
receive fourth organizer information into a second different enterprise system;
transmit the fourth organizer information from the second enterprise system to the computerized organizer; and
display the first organizer information, the second organizer information, the third organizer information, and the fourth organizer information via the computerized organizer.

13. The apparatus of claim 12, wherein the first enterprise system is a document management system and the second enterprise system is a time-billing system.

14. The apparatus of claim 13, wherein the document management system is a first web services based system.

15. The apparatus of claim 14, wherein the time-billing system is a second different web services based system.

16. The apparatus of claim 1, wherein the computerized organizer is web based.

17. A computer readable medium storing a software program to cause a computing device executing a computerized organizer to:
receive first organizer information into the computerized organizer;
receive first metadata into the computerized organizer, the first metadata indicating that the first organizer information is business type information;
store the first organizer information in a first enterprise system because the first metadata indicates that the first organizer information is business type information;
receive second organizer information into the computerized organizer;
receive second metadata into the computerized organizer, the second metadata indicating that the second organizer information is personal type information;
store the second organizer information in a non-enterprise system because the second metadata indicates that the second organizer information is personal type information;
receive third organizer information into the first enterprise system;
transmit the third organizer information from the first enterprise system to the computerized organizer;
receive fourth organizer information into a second different enterprise system;
transmit the fourth organizer information from the second enterprise system to the computerized organizer; and
display the first organizer information, the second organizer information, the third organizer information, and the fourth organizer information via the computerized organizer.

18. The computer readable medium of claim 17, wherein the first enterprise system is a document management system and the second enterprise system is a time-billing system.

19. The apparatus of claim 18, wherein the document management system is a first web services based system.

20. The apparatus of claim 19, wherein the time-billing system is a second different web services based system.

21. The apparatus of claim 17, wherein the computerized organizer is web based.
